(19) United States
(12) Patent Application Publication
(10) Pub. No.: US 2022/0377792 A1
(43) Pub. Date: Nov. 24, 2022

(54) COMMUNICATION DEVICE AND COMMUNICATION METHOD

(71) Applicant: Panasonic Intellectual Property Corporation of America, Torrance, CA (US)

(72) Inventor: Yutaka MURAKAMI, Kanagawa (JP)

(21) Appl. No.: 17/771,789

(22) PCT Filed: Aug. 31, 2020
(86) PCT No.: PCT/JP2020/032873

§ 371 Date: Apr. 25, 2022

(30) Foreign Application Priority Data
Oct. 30, 2019 (JP) 2019-197463

(51) Int. Cl. H04W 74/08

(52) U.S. Cl. CPC H04W 74/0808

(57) ABSTRACT

This communication device has: a reception unit that receives a beacon signal through a first channel; a control unit that generates a sensing signal on the basis of information included in an extended area of the beacon signal; and a transmission unit that transmits the sensing signal through a second channel.

### TECHNICAL FIELD

The present disclosure relates to a communication apparatus and a communication method.

### BACKGROUND ART

Non-Patent Literatures (hereinafter, each referred to as “NPL”) 1 and 2 disclose that a pulse signal is used for sensing of an object. NPL 3 discloses sensing of an object based on a frequency modulated continuous wave (FMCW) scheme and a phase modulated continuous wave (PMCW) scheme. Further, NPL 4 discloses that an orthogonal frequency division multiplexing (OFDM) signal is used for sensing of an object.

### CITATION LIST

### Non-Patent Literature

NPL 1
S. Schuster, S. Scheiblhofer, R. Feger, and A. Stelzer, “Signal model and statistical analysis for the sequential sampling pulse radar technique,” in Proc. IEEE Radar Conf, 2008. pp. 1-6, 2008
NPL 2
D. Cao, T. Li. P. Kang, H. Liu, S. Zhou, H. Su, “Single-Pulse Multi-Beams Operation of Phased Array Radar”, 2016 CIE International Conference on Radar (RADAR), pp. 1-4,
NPL 3
A. Bourdoux, K. Parashar, and M. Bauduin, “Phenomenology of mutual interference of FMCW and PMCW automotive radars,” in 2017 IEEE Radar Conference (Radar Conf.), pp. 1709-1714, 2017
NPL 4
J. Fink, F. K. Jondral, “Comparison of OFDM radar and chirp sequence radar.” in 2015 16th International Radar Symposium (IRS), pp. 315-320, 2015

### SUMMARY OF INVENTION

### Technical Problem

The Institute of Electrical and Electronics Engineers (IEEE) has been discussing sensing of an object in a wireless local area network (LAN).

However, no specific specifications for performing sensing of an object have been developed.

One non-limiting and exemplary embodiment facilitates providing a communication apparatus and a communication method each capable of performing sensing of an object

### Solution to Problem

A communication apparatus according to an exemplary embodiment of the present disclosure includes: a receiver that receives a beacon signal through a first channel; a controller that generates a sensing signal based on information included in an extended area of the beacon signal; and a transmitter that transmits the sensing signal through a second channel.

A communication apparatus according to an exemplary embodiment of the present disclosure includes: a controller that configures information on sensing in an extended area of a beacon signal, where the sensing uses a first channel; and a transmitter that transmits the beacon signal through a second channel.

A communication method according to an exemplary embodiment of the present disclosure includes: receiving, by a communication apparatus, a beacon signal through a first channel, generating, by the communication apparatus, a sensing signal based on information included in an extended area of the beacon signal; and transmitting, by the communication apparatus, the sensing signal through a second channel.

A communication method according to an exemplary embodiment of the present disclosure includes: configuring, by a communication apparatus, information on sensing in an extended area of a beacon signal, where the sensing uses a first channel; and transmitting, by the communication apparatus, the beacon signal through a second channel.

It should be noted that general or specific embodiments may be implemented as a system, a method, an integrated circuit, a computer program, a storage medium, or any selective combination thereof.

### Advantageous Effects of Invention

According to an exemplary embodiment of the present disclosure, the communication apparatus is capable of performing sensing of an object.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of a configuration of an apparatus according to Embodiment 1;

FIG. 2 illustrates another example of the configuration of the apparatus according to Embodiment 1;

FIG. 3 illustrates still another example of the configuration of the apparatus according to Embodiment 1;

FIG. 4 illustrates an example of a communication system according to Embodiment 1;

FIG. 5 illustrates a configuration example of a frame for data transmission;

FIG. 6A illustrates a configuration example of a frame for sensing;

FIG. 6B illustrates a configuration example of a frame for sensing;

FIG. 7 illustrates an example of a frame state in a time axis of a certain frequency band;

FIG. 8 illustrates another example of a frame state in a time axis of a certain frequency band;

FIG. 9 illustrates an example of a use state of time and frequency in a wireless LAN system;

FIG. 10 illustrates an example of a use state of time and frequency in a wireless LAN system;

FIG. 11 illustrates an example of a use state of time and frequency in a wireless LAN system;

FIG. 12 illustrates an example of a use state of time and frequency in a wireless LAN system;

FIG. 13 illustrates an example of a use state of time and frequency in a wireless LAN system;

FIG. 14 illustrates an example of a use state of time and frequency in a wireless LAN system;

FIG. 15 illustrates an example of a use state of time and frequency in a wireless LAN system;

FIG. 16 illustrates an example of a configuration of a beacon;

FIG. 17 illustrates an example of a configuration of a frame in channel aggregation;

FIG. 18 illustrates an example of a configuration of a frame in channel aggregation;

FIG. 19 illustrates an example of a configuration of a frame in channel aggregation;

FIG. 20 illustrates an example of a configuration of a frame in channel aggregation;

FIG. 21 illustrates an example of a configuration of a frame in channel aggregation;

FIG. 22 illustrates an example of a configuration of a frame in channel aggregation;

FIG. 23 illustrates an example of a configuration of a frame in channel aggregation;

FIG. 24 illustrates an example of a configuration of a frame in channel aggregation;

FIG. 25 illustrates an example of a configuration of a frame in channel bonding;

FIG. 26 illustrates an example of a configuration of a frame in channel bonding;

FIG. 27 illustrates an example of a configuration of a frame in channel bonding;

FIG. 28 illustrates an example of a configuration of a frame in channel bonding;

FIG. 29 illustrates an example of a configuration of a frame in channel bonding;

FIG. 30 illustrates an example of a configuration of a frame in channel bonding;

FIG. 31 illustrates an example of a configuration of a frame according to Embodiment 2;

FIG. 32 illustrates an example of a configuration of a frame according to Embodiment 2;

FIG. 33 illustrates an example of a configuration of a frame according to Embodiment 2;

FIG. 34 illustrates an example of a configuration of a frame according to Embodiment 2;

FIG. 35 illustrates an example of a configuration of a frame according to Embodiment 2;

FIG. 36 illustrates an example of a configuration of a frame according to Embodiment 2;

FIG. 37 illustrates an example of a configuration of a frame according to Embodiment 2;

FIG. 38 illustrates an example of a configuration of a frame according to Embodiment 2;

FIG. 39 illustrates an example of a configuration of a frame according to Embodiment 2;

FIG. 40 illustrates an example of a configuration of a frame according to Embodiment 2;

FIG. 41 illustrates an example of a configuration of a frame according to Embodiment 2;

FIG. 42 illustrates an example of a configuration of a frame according to Embodiment 2;

FIG. 43 illustrates an example of a configuration of a frame according to Embodiment 2;

FIG. 44 illustrates an example of a configuration of a frame according to Embodiment 2;

FIG. 45 illustrates an example of a configuration of a frame according to Embodiment 2;

FIG. 46 illustrates an example of a configuration of a frame according to Embodiment 2;

FIG. 47 illustrates an example of a configuration of a frame according to Embodiment 2;

FIG. 48 illustrates an example of a configuration of a frame according to Embodiment 2;

FIG. 49 illustrates an example of a configuration of a frame according to Embodiment 2;

FIG. 50 illustrates an example of a configuration of a frame according to Embodiment 2;

FIG. 51 illustrates an example of a configuration of a frame according to Embodiment 2;

FIG. 52 illustrates an example of a configuration of a frame according to Embodiment 2;

FIG. 53 illustrates an example of a configuration of a frame according to Embodiment 2;

FIG. 54 illustrates an example of a configuration of a frame according to Embodiment 2;

FIG. 55 illustrates an example of a configuration of a frame according to Embodiment 2;

FIG. 56 illustrates an example of a configuration of a frame according to Embodiment 2;

FIG. 57 illustrates an example of a configuration of a frame according to Embodiment 2;

FIG. 58 illustrates an example of a configuration of a frame according to Embodiment 2;

FIG. 59 illustrates an example of a configuration of a communication system according to Embodiment 3;

FIG. 60 is a diagram provided for describing an operation example of the communication system in FIG. 59;

FIG. 61 is a diagram provided for describing an operation example of the communication system in FIG. 59;

FIG. 62A is a diagram provided for describing an operation example of the communication system in FIG. 59;

FIG. 62B is a diagram provided for describing an operation example of the communication system in FIG. 59;

FIG. 63A is a sequence diagram illustrating an operation example of terminals and an AP in FIG. 62A;

FIG. 63B is a sequence diagram illustrating an operation example of terminals and an AP in FIG. 62B;

FIG. 64 is a diagram provided for describing another operation example of the communication system in FIG. 59;

FIG. 65 is a diagram provided for describing still another operation example of the communication system in FIG. 59;

FIG. 66A is a diagram provided for describing yet another operation example of the communication system of FIG. 59;

FIG. 66B is a diagram provided for describing a further operation example of the communication system of FIG. 59;

FIG. 67A illustrates an example of a configuration of a communication system according to Embodiment 4;

FIG. 67B illustrates an example of resource allocation of a signal transmitted by a terminal in time-frequency axes;

FIG. 68 illustrates an example of sensing;

FIG. 69 illustrates an example of a configuration of an apparatus having a communication function and a sensing function according to Embodiment 5;

FIG. 70 illustrates an example of a transmission situation of a terminal and a transmission situation of an AP;

FIG. 71 illustrates an example of an apparatus including an antenna for both transmission and reception;

FIG. 72A illustrates an example of a configuration of a frame in which a mid-amble is mapped; and

FIG. 72B illustrates an example of a configuration of a frame in which a mid-amble is mapped.

### DESCRIPTION OF EMBODIMENTS

Hereinafter, embodiments of the present disclosure will be described in detail with reference to the accompanying drawings. However, a detailed description more than necessary may be omitted, such as a detailed description of an already well-known matter and a duplicate description for a substantially identical configuration, to avoid unnecessary redundancy of the following description and to facilitate understanding by the person skilled in the art.

Note that, the accompanying drawings and the following description are provided for the person skilled in the art to sufficiently understand the present disclosure, and are not intended to limit the subject matter described in the claims.

Hereinafter, sensing may include estimation of the position of an object, detection of an object, grasping the outer shape of an object, estimation of movement of an object, and estimation of a gesture of an object. An object to be subjected to sensing may also be referred to as a target object. Further, living things such as humans and animals also become objects to be subjected to sensing. As a matter of course, objects to be subjected to sensing may not be living things.

The main purpose of estimation of the position of an object is to estimate a position of an object. Estimation of the position of an object may include estimating both detection of an object and movement of the object. The position of an object may be estimated by means of triangulation using a radio wave, light, an ultrasound wave, or the like. Movement of an object may be detected by using a Doppler frequency. Further, estimation of a gesture of an object may also be performed. Note that, the above description is an example, and the present disclosure is not limited thereto.

The main purpose of detection of an object is to detect an object. Detection of an object may include specifying an object. An object may be detected by using detection of reflection of a radio wave, light, an ultrasound wave, or the like, and/or detection of a reflected wave. Detection of an object may or may not include estimation of the position of an object. Note that, the above description is an example, and the present disclosure is not limited thereto.

The main purpose of grasping the outer shape of an object is to detect the outer shape of an object. Grasping the outer shape of an object may include, for example, specifying an object. Further, grasping the outer shape of an object may also include, for example, a change or movement of the outer shape of an object. The outer shape of an object may be grasped by using a pulsed spread spectrum signal, and/or a signal with a certain band. Grasping the outer shape of an object may or may not include estimation of the position of an object. Further, estimation of a gesture of an object may also be performed. Note that, the above description is an example, and the present disclosure is not limited thereto.

In the present disclosure, coexistence of an AP (access point) and at least two terminals that belong to a terminal having a communication function, a terminal having a function of sensing of an object, or a terminal having a communication function and a function of sensing of an object is realized. The AP may or may not have a function of sensing of an object. The AP has at least a function of communicating with the terminals. The terminal may also be referred to as apparatus or a communication apparatus.

### Embodiment 1

First, configurations of an apparatus that performs sensing, and an apparatus that performs communication and sensing, or the like will be described. Note that, the sensing method in an apparatus having a sensing function, such as an apparatus that perform sensing and an apparatus that performs communication and sensing, may be any one of methods described herein, for example.

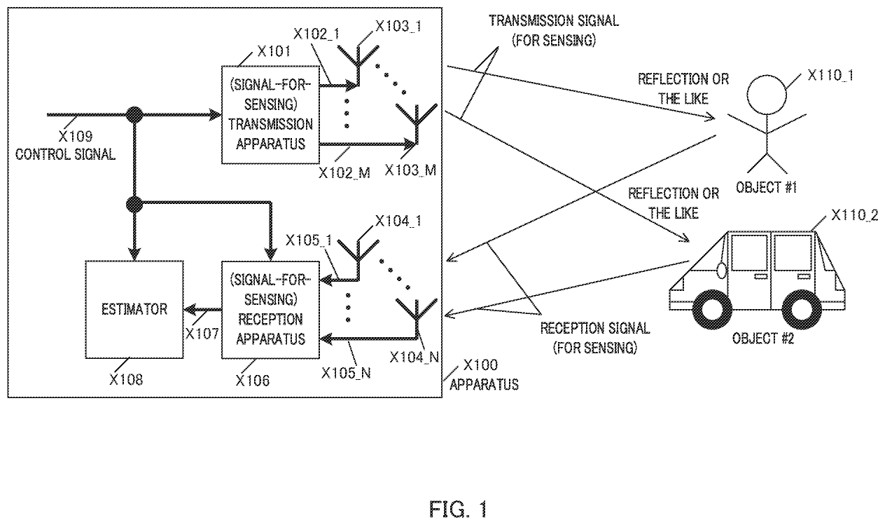

FIG. 1 illustrates an example of a configuration of apparatus X100 that performs sensing by transmitting a signal for sensing and receiving the signal for sensing that has reflected off an object around apparatus X100 and has returned. Apparatus X100 performs sensing of an object by transmitting a signal for sensing and receiving the signal for sensing that has reflected off an object around apparatus X100 and has returned.

Transmission apparatus X101 generates transmission signals X102_1 to X102_M. Transmission signals X102_1 to X102_M are signals for sensing. Transmission apparatus X101 transmits transmission signals X102_1 to X102_M, which have been generated, from antennas X103_1 to X103_M, respectively. Here, the number of antennas used for transmission is M, where M is an integer larger than or equal to 1 or an integer larger than or equal to 2.

For example, transmission apparatus X101 may generate transmission signals X102_1 to X102_M by multiplying the same sensing signal by coefficients determined for each antenna, and transmit transmission signals X102_1 to X102_M from antennas X103_1 to X103_M to perform directionality control for the sensing signal. Further, for example, transmission apparatus X101 may generate transmission signals X102_1 to X102_M by multiplying a plurality of sensing signals by coefficients determined for each sensing signal and each antenna, respectively, and combining the resulting plurality of sensing signals, and transmit transmission signals X102_1 to X102_M from antennas X103_1 to X103_M. Thus, it is possible to perform directionality control for each sensing signal.

The coefficients determined for each antenna or the coefficients determined for each sensing signal and each antenna are expressed as complex numbers or integers. The amplitudes and/or phases of sensing signals transmitted from each antenna vary depending on the values of the coefficients. However, the coefficients may be one. In this case, a sensing signal generated by transmission apparatus X101 is transmitted as it is from an antenna for which the coefficient value is one.

Note that, transmission apparatus X101 may also transmit a transmission signal without performing directionality control. For example, transmission apparatus X101 may output a plurality of sensing signals as they are as transmission signals from the corresponding antennas, respectively, and transmit the plurality of sensing signals from antennas X103_1 to X103_M.

Although a case where there is a plurality of signals for sensing and there is a plurality of antennas has been described above, the number of signals for sensing generated by transmission apparatus X101 and the number of antennas that transmit signals for sensing may be one, respectively.

Signals for sensing transmitted from antennas X103_1 to X103_M are reflected off object #1 (X110_1) or object #2 (X110_2). The reflected signals for sensing are received by antennas X104_1 to X104_N included in apparatus X100. Here, the number of antennas that receive signals for sensing is N, where N is an integer larger than or equal to one or an integer larger than or equal to two. The number M of antennas used for transmission may be the same as or different than the number N of antennas used for reception.

Reception signals X105_1 to X105_N received by antennas X104_1 to X104_N are inputted into reception apparatus X106. For example, reception apparatus X106 performs, on reception signals X105_1 to X105_N, filter processing of extracting a frequency band, in which signals for sensing are transmitted, or only channel components in the frequency band, frequency conversion processing of conversion from a radio frequency band to an intermediate frequency band (IF) and/or to a frequency band of a baseband signal, weighting/combining processing on N reception signals, and/or the like, and outputs estimation signal X107.

Coefficients used in the weighting/combining processing on the N reception signals may be configured for each of reception signals X105_1 to X105_N. Apparatus X100 can perform reception directionality control by changing the values of the coefficients. The coefficients may be estimated in advance, or reception signals X105_1 to X105_N may be used to estimate coefficients in which the amplitude or signal-to-noise ratio (CNR) of a sensing signal component after the weighting/combining processing is larger than that in a case where other coefficients are used, or exceeds a predetermined threshold.

Further, reception apparatus X106 may use a plurality of sets of N coefficients corresponding to reception signals X105_1 to X105_N to acquire signals having directionalities corresponding to each set of coefficients at the same time. Note that, reception apparatus X106 may not perform the weighting/combining processing.

Estimator X108 performs sensing, that is, estimation processing on the surrounding environment by using estimation signal X107. Details of the estimation processing performed by estimator X108 will be described later.

Control signal X109 is a control signal that is inputted into transmission apparatus X101, reception apparatus X106, and estimator X108, and instructs transmission apparatus X101, reception apparatus X106, and estimator X108 to perform sensing, performs sensing range instruction and control of sensing timing for transmission apparatus X101, reception apparatus X106, and estimator X108, and/or the like.

An example of the configuration of apparatus X100 has been described thus far.

Note that, although a case where signals generated by apparatus X100 are transmitted from M antennas and signals received by N antennas are subjected to signal processing by reception apparatus X106 has been described as an example in FIG. 1, the configuration of the apparatus that performs the sensing method described herein is not limited thereto.

For example, a plurality of transmission antenna processors that transmits signals may be each formed of a plurality of antenna units each of which includes a plurality of antennas. Here, the plurality of antenna units may have the same directionality and directionality control function, or ranges in which directionality control can be performed may differ between the antenna units. At this time, one transmission apparatus X101 may select an antenna unit to be used for sensing signal transmission from among the plurality of antenna units, or the same sensing signal may be transmitted from the plurality of antenna units at the same time.

Further, transmission apparatus X101 may switch between transmitting one sensing signal from one antenna unit and transmitting one sensing signal from a plurality of antenna units at the same time. Further, apparatus X100 may include a plurality of transmission apparatuses X101 or may include one transmission apparatus X101 for each antenna unit.

In the same manner, a plurality of reception antenna processors that receives signals may be each formed of a plurality of antenna units each of which includes a plurality of antennas. Here, the plurality of antenna units may have the same directionality control capabilities such as directionality control range and directionality control accuracy, or directionality control capabilities may differ between the antenna units. Further, the plurality of antenna units may be disposed such that the directionality control capabilities such as directionality control range and directionality control accuracy are the same, but spatial areas in which directionality control can be performed differ. At this time, one reception apparatus X106 may select an antenna unit that acquires reception signals from among a plurality of antenna units, or signals received from a plurality of antenna units may be subjected to signal processing at the same time.

Further, reception apparatus X106 may also switch between subjecting only reception signals received from one antenna unit to signal processing and subjecting reception signals received from a plurality of antenna units to signal processing at the same time. Further, apparatus X100 may include a plurality of reception apparatuses X106, and may include one reception apparatus X100 for each antenna unit.

Further, apparatus X100 may also include a plurality of antennas that can be used for both transmission and reception of signals, rather than including a plurality of antennas for transmission and a plurality of antennas for reception separately. In this case, apparatus X100 may select and switch between using each antenna for transmission and using each antenna for reception, or may temporally switch between using a plurality of antennas for transmission and using a plurality of antennas for reception.

Further, apparatus X100 may include a transmission and reception antenna processor that can be used commonly for both signal transmission and signal reception. Here, the transmission and reception antenna processor includes a plurality of antenna units, and can switch between using each antenna unit for transmission and using each antenna unit for reception. Apparatus X100 may also include a selector that selects and switches between an antenna unit used to transmit a signal generated by transmission apparatus X101 and an antenna unit used to receive a signal to be subjected to signal processing by reception apparatus X106.

In a case where sensing signals are transmitted by using a plurality of antenna units at the same time, the directionalities of the signals transmitted from each antenna unit may be the same or different. In a case where apparatus X100 transmits sensing signals with the same directionality from a plurality of antenna units, there is a possibility that the distances that the sensing signals reach can be lengthened or the distances to reflection points at which the reflected sensing signals are receivable can be lengthened.

Note that, the number of antennas that form the antenna unit described above does not need to be the same between the antenna units and may vary between the antenna units.

Next, the estimation processing performed by estimator X108 will be described as an example.

For example, estimator X108 estimates the distance between apparatus X100 and an object that has reflected a sensing signal. Estimation of the distance between apparatus X100 and an object that has reflected a sensing signal can be derived, for example, by detecting a delay time between the time of transmission of the sensing signal and the time of reception thereof, and multiplying the delay time by the propagation velocity of the electromagnetic wave.

Estimator X108 may estimate the direction of arrival of a reception signal, that is, the direction of an object that has reflected a sensing signal by using a direction-of-arrival estimation method such as a multiple signal classification (MUSIC) method, for example. Estimator X108 can estimate the position of an object that has reflected a transmitted signal by estimating the direction in addition to the distance between apparatus X100 and an object.

For example, estimator X108 can estimate the position of an object by performing triangulation by using information on direction-of-arrival estimation by the MUSIC method or the like, the positions of transmission antennas, the positions of reception antennas, and the direction of transmission directionality control, or the like. Estimator X108 may detect an object, movement of an object, the material of an object, and the like by using a reception signal. Further, estimator X108 may also estimate detection of an object, the position of an object, movement of an object, and the like by an estimation method other than triangulation. Note that, the method described herein can be mentioned as the sensing method.

The position of an object may be expressed in a polar coordinate system or in a three-dimensional orthogonal coordinate system. The origin of the coordinate system may be, for example, an arbitrary position in apparatus X100, and the axes in the coordinate system may be oriented arbitrarily.

Note that, in a case where a device including apparatus X100 includes a plurality of radio sensors or other distance sensors having the same or different configuration as apparatus X100 in addition to apparatus X100, the origins and axes of coordinate systems of data acquired by each sensor may be common among the sensors or may be unique to each sensor. Estimator X108 may output position information expressed in the unique coordinate systems described above as it is or may perform conversion into a common coordinate system in the device and output the common coordinate system. The converted coordinate system may be a coordinate system unique to the device or may be a coordinate system common to those of other devices, such as a coordinate system that is the same as a three-dimensional map data utilized by the device.

Further, estimator X108 may estimate distances to an object that has reflected signals in each of a plurality of directions and acquire three-dimensional coordinates of a plurality of estimated reflection positions as a point cloud. Note that, the format of data of a plurality of distance measurement results acquired by estimator X108 may not be a point cloud format including three-dimensional coordinate values, but may be, for example, a distance image format or any other format. In a case where the distance image format is used, positions (coordinates) of a distance image in a two-dimensional plane correspond to directions of arrival of reception signals viewed from apparatus X100, and distances to an object in directions corresponding to pixel positions of each image are stored as pixel sample values.

Further, estimator X108 may also perform recognition processing such as estimation of the shape of an object by using the above-described point cloud data or distance image data. For example, estimator X108 can regard and extract “one or more points of positions which are close to each other and whose distances are within a predetermined range”, a plurality of points or an image area as the same object, and estimate the shape of an object based on the positional relationship of the one or plurality of points or the shape of the image area. Estimator X108 may perform identification of an object subjected to sensing as recognition processing using an estimation result of the shape of an object. In this case, for example, estimator X108 performs identification whether an object in a sensing range is a person or an animal, performs identification of the type of the object, and the like.

Note that, the recognition processing performed by estimator X108 may not be identification of an object. For example, as the recognition processing, estimator X108 may detect the number of persons, automobiles, or the like in a sensing range, and/or may estimate the face position, posture or the like of a detected person. As recognition processing different from the above-described recognition processing, estimator X108 may perform processing such as face authentication in which it is determined whether the shape of the face of a detected person matches that of a person registered in advance, which person the detected person is, or the like.

Further, estimator X108 may also measure the distance between apparatus X100 and an object at different timings a plurality of times to acquire a temporal change in the distance between apparatus X100 and the object or in the position of a detected point. In this case, estimator X108 may also estimate the velocity, acceleration and the like of a moving object as recognition processing that uses a temporal change in the distance between apparatus X100 and the object or in the position of the point. For example, estimator X108 may also estimate the velocity, movement direction and the like of an automobile driving in a sensing range.

Note that, the recognition processing performed by estimator X108 using a temporal change in a distance or in the position of a point may not be estimation of the velocity and acceleration of an object. For example, estimator X108 may detect based on a change in the posture of a detected person whether the person has performed a specific action, and may utilize apparatus X100 as a gesture-inputting device for an electronic device such as a smart phone, a tablet, and a personal computer.

The estimation of the velocity of a moving object described above may be derived by comparing the frequency of a transmitted sensing signal with the frequency of a received reflected signal to estimate a change in frequency due to a Doppler effect received by the reflected signal.

Next, the sensing signal used in transmission apparatus X101 and reception apparatus X106 will be described as an example.

Apparatus X100 may transmit, for example, the pulse signal disclosed in NPLs 1 and 2 as a signal for sensing. Apparatus X100 transmits the pulse signal in a frequency band used for sensing, and measures the distance to an object that has reflected the signal for sensing, based on a delay time between the time of transmission of the pulse signal and the time of reception of a reflected signal.

As another example of the signal for sensing, apparatus X100 may use the signal in the FMCW scheme or the PMCW scheme described in NPL 3. The FMCW signal is a signal obtained by converting a chirp signal, whose frequency has been temporally changed, into a radio frequency. As estimation processing that uses a FMCW signal, estimator X108 superimposes a signal to be transmitted from transmission apparatus X101 and a signal received by reception apparatus X106 with a mixer. As a result, the superimposed signal becomes a signal having an intermediate frequency in accordance with the time of flight of the received signal so that the distance to an object that has reflected the FMCW signal is measured by detecting a frequency component included in the superimposed signal.

As another example of the signal for sensing, apparatus X100 may use a signal obtained by frequency-converting a modulated signal having a predetermined frequency into a signal of a frequency band used for sensing. In this case, for example, estimator X108 can estimate the distance to an object that has reflected a signal for sensing, based on a difference between the phase of a modulation component of a signal to be transmitted from transmission apparatus X101 and the phase of a modulation component of a signal received by reception apparatus X106.

Further, estimator X108 may also compare the frequency of a transmitted modulated signal with the frequency of a received modulated signal to thereby detect a variation in frequency due to a Doppler effect between the reflection of a sensing signal and the reception thereof, and estimate the movement velocity and direction of a moving object. Note that, there may be a plurality of frequency components included in a modulated signal and, for example, multicarrier transmission including a plurality of frequency components, such as an OFDM signal, may be used as the modulated signal described in NPL 4.

Examples of the signal for sensing are not limited to the above examples. The signal for sensing may be a signal modulated by a modulation scheme, may be an unmodulated carrier, or any other signal may be used.

As described above, apparatus X100 may use a plurality of antennas to transmit a plurality of sensing signals at the same time, or may use a plurality of antenna units each of which includes a plurality of antennas to transmit a plurality of sensing signals at the same time.

In Embodiment 1, as an example, a case where a distance is measured based on a difference between the time of transmission of a sensing signal and the time of reception of a reflected signal has been described as the estimation processing performed by estimator X108. However, the estimation processing performed by estimator X108 is not limited to the case described above.

For example, estimator X108 may estimate a transmission path state based on a received reflected signal and perform recognition processing based on a temporal change in the estimated transmission path state and comparison of the estimated transmission path state with an average value of past estimated transmission path states and/or a feature amount to determine whether an object is present in a sensing range, to detect the presence or absence of movement of an object, and the like. Further, estimator X108 may also detect the presence or absence of rainfall based on an attenuation situation of a reception signal, or the like.

Further, in Embodiment 1, an example in which a reflected wave of a transmitted sensing signal is used for sensing has been described. However, the apparatus that performs sensing by using a sensing signal is not limited to the apparatus that transmits the sensing signal.

For example, reception apparatus X106 of apparatus X100 may receive a sensing signal transmitted from another apparatus and, based on the reception signal, estimator X108 may determine that the other apparatus is in a range in which the sensing signal reaches and may estimate the direction of the other apparatus. Further, estimator X108 may also estimate the distance to the other apparatus based on the signal strength of the received sensing signal.

Further, reception apparatus X106 of apparatus X100 may also transmit a sensing signal such that another apparatus can use the sensing signal for sensing. The sensing signal to be transmitted at this time may be a sensing signal to be transmitted for apparatus X100 to perform sensing by using a reflected wave or may be periodically transmitted for another apparatus to perform sensing. Further, in a case where apparatus X100 receives a sensing signal transmitted from another apparatus, apparatus X100 may use transmission apparatus X101 to transmit a sensing signal in the direction in which the reception signal has been received. Note that, the sensing signal to be transmitted to another apparatus may be transmitted without performing directionality control. Further, the sensing signal may also be generated by the method described herein.

Further, although FIG. 1 illustrates an example in which apparatus X100 that performs sensing receives signals reflected off objects #1 and #2, apparatus X100 may use signals obtained by reflecting off objects #1 and #2 and further reflecting off other object(s) or matter to estimate detection of an object, the distance to an object, the position of an object, and the like.

Next, an example of a sensing method that uses radio waves different from those in FIG. 1 will be described.

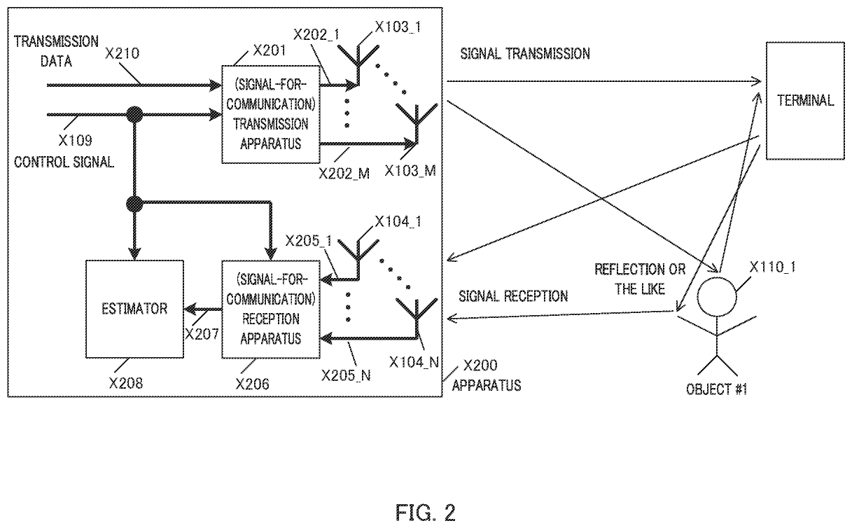

FIG. 2 illustrates an example of a configuration of apparatus X200 that performs sensing by using radio waves. In the configuration illustrated in FIG. 2, the configuration elements having the same functions as those in the configuration illustrated in FIG. 1 are denoted by the same reference signs, and detailed descriptions thereof will be omitted.

Apparatus X200 differs from apparatus X100 in that apparatus X200 performs sensing by using a modulated signal for sensing and/or a modulated signal for communication. Here, for example, apparatus X200 transmits signals and the terminal as the communication partner captures a change between the signals transmitted by apparatus X200 to estimate the position and size of an object (for example, object #1 in FIG. 2), the distance to an object (for example, object #2 in FIG. 2), or the like. Note that, in a case where apparatus X200 transmits a modulated signal for communication, data communication with the terminal is also possible. Hereinafter, a case in which sensing is performed by using a modulated signal for communication will be described.

Transmission apparatus X201 inputs control signal X109 and transmission data X210, and performs error correction coding processing, modulation processing, precoding, multiplexing processing, and/or the like to generate transmission signals for communication X202_1 to X202_M. Apparatus X200 transmits transmission signals X202_1 to X202_M from antennas X103_1 to X103_M, respectively.

The number of transmission signals and the number of antennas used for transmission are the same as described with respect to FIG. 1, and may be two or more or may be one. The description with reference to FIG. 2 differs from the description with reference to FIG. 1 in that the transmission signal in the description with reference to FIG. 1 includes a sensing signal component, whereas the transmission signal in FIG. 2 includes a component of a signal of modulated transmission data. However, transmission apparatus X201 and transmission apparatus X101 are the same in terms of being capable of performing directionality control by coefficients used in weighting/combining processing for generating a transmission signal. Further, in the same manner as apparatus X100, apparatus X200 may include one antenna unit including a plurality of antennas or may include a plurality of antenna units.

In a case where directionality control is performed, transmission apparatus X101 of FIG. 1 performs transmission directionality control in a direction in which sensing is to be performed, whereas transmission apparatus X201 of FIG. 2 performs transmission directionality control such that communication quality with the terminal as the communication partner improves. However, transmission apparatus X201 may perform transmission signal directionality control toward a direction in which sensing is to be performed, or may perform directionality control such that the terminal as the communication partner can use a signal transmitted by apparatus X200 to obtain a desirable sensing result in performing sensing.

In a case where transmission apparatus X201 performs directionality control for sensing by the terminal, transmission apparatus X201 transmits a signal by using a coefficient designated by the terminal. The signal transmitted here may or may not include a signal component modulated by using transmission data. The signal that does not include a signal component modulated by using transmission data is a signal modulated by a value known on a side of the terminal, such as a preamble and a reference signal, for example. Further, transmission apparatus X201 may perform different directionality controls depending on whether a signal including a signal component modulated by using transmission data is transmitted or a signal including no signal component modulated by using transmission data is transmitted.

Note that, the terminal obtains data (performs communication) as well as performs sensing by receiving a modulated signal transmitted by apparatus X200.

Further, the terminal may transmit signals and apparatus X200 as the communication partner may capture a change between the signals transmitted by the terminal to estimate the position and size of an object (for example, object #1 in FIG. 2), the distance to an object (for example, object #1 in FIG. 2), the type and material of an object (for example, object #1 in FIG. 2), and the like. Note that, in a case where the terminal transmits a modulated signal for communication, data communication with apparatus X200 is also possible.

For example, apparatus X200 uses antennas X104_1 to X104_N to receive modulated signals transmitted by the terminal. Reception apparatus X206 inputs control signal X109 and reception signals X205_1 to X205_N and performs demodulation processing, error correction decoding processing, and the like to acquire reception data. Further, reception apparatus X206 outputs, as estimation signal X207, transmission path characteristics and the like obtained by reception processing.

Coefficients used in the weighting/combining processing on the N reception signals can be configured for each of reception signals X205_1 to X205_N, and reception directionality control can be performed by changing the values of the coefficients. The coefficients may be estimated in advance, or reception signals X205_1 to X205_N may be used to estimate coefficients in which the amplitude or signal-to-noise ratio (CNR) of a sensing signal component after the weighting/combining processing is larger than that in a case where other coefficient are used, or exceeds a predetermined threshold. Further, reception apparatus X206 may use a plurality of sets of N coefficients corresponding to reception signals X205_1 to X205_N to acquire signals having directionalities corresponding to each set of coefficients at the same time.

Estimator X208 inputs control signal X109 and estimation signal X207, and performs estimation processing by using estimation signal X207. Estimator X208 estimates the surrounding environment, such as whether an object is present around, based on transmission path characteristics included in estimation signal X207, for example. Further, estimator X208 may also detect movement of an object, approach of an object or the like based on a temporal change in the transmission path characteristics.

For example, estimator X208 may estimate the direction of arrival of a reception signal, that is, the direction of an object that has reflected a sensing signal, by using a direction-of-arrival estimation method such as the MUSIC method. For example, estimator X208 may estimate the position of an object by performing triangulation by using information on direction-of-arrival estimation by the MUSIC method or the like, the positions of antennas (for example, the positions of the transmission apparatus and the reception apparatus), and the direction of transmission directionality control, or the like. Estimator X208 may also detect an object, movement of an object, the material of an object, and the like by using a reception signal.

For example, estimator X208 performs the aforementioned estimation processing, for example, signal processing in accordance with an event to be detected, such as the presence or absence of an object and the presence or absence of movement of an object as described above, on estimation signal X207. At this time, the estimation processing is performed, for example, based on a determination result of whether or not a feature amount extracted by the signal processing exceeds a predetermined threshold.

Estimator X208 may perform the estimation processing based on signal processing other than the signal processing exemplified above. For example, the estimation processing may also be performed with a model created by machine learning using a neural network having a multi-layered structure. In a case where a model created by machine learning using a neural network having a multi-layered structure is used in the estimation processing, estimator X208 may perform predetermined preprocessing on estimation signal X207 and then input the preprocessed data into the model created by the machine learning using the neural network having the multi-layered structure.

Further, estimator X208 may also use information on a frequency band used for communication, a channel number in the frequency band, or the like. Further, estimator X208 may also use the address of a communication apparatus that has transmitted a received signal for communication or the address of a communication apparatus that is the destination of the signal. Thus, by using information on a received signal for communication, such as a frequency band and the address of a communication apparatus, it is possible to perform a comparison between signals for communication, in which conditions, such as the positions of communication apparatuses, which have transmitted signals, and directionalities used when signals are transmitted, are the same or similar, and there is a possibility that the estimation accuracy will improve.

A case where sensing is performed by using a signal for communication transmitted by a communication partner has been described above. Although FIG. 2 illustrates the configuration of apparatus X200 in which transmission apparatus X201 and antennas X103_1 to X103_M, which are the configurations for performing transmission processing, and reception apparatus X206 and antennas X104_1 to X104_N, which are the configurations for performing reception processing, are different, the configuration of apparatus X200 is not limited thereto.

For example, transmission apparatus X201 and reception apparatus X206 may be realized as one configuration element, and/or a plurality of antennas may be commonly used for transmission and reception. Further, in the same manner as in the description with reference to FIG. 1, the plurality of antennas for transmission in apparatus X200 may be formed of a plurality of antenna units, and the plurality of antennas for reception in apparatus X200 may be formed of a plurality of antenna units. Further, the plurality of antennas for transmission and the plurality of antennas for reception may be formed as a common transmission and reception antenna processor.

Further, a signal for sensing may be used instead of a signal for communication. That is, a first apparatus may use a signal for sensing transmitted by another apparatus to estimate the position and size of an object (for example, object #1 in FIG. 2), the distance to an object (for example, object #1 in FIG. 2), the type and material of an object (for example, object #1 in FIG. 2), and the like.

The sensing method using a signal for communication may also be utilized for the same purpose as the example described with reference to FIG. 1 in which a sensing signal is transmitted to another apparatus. That is, apparatus X200 may also use a signal for communication transmitted from another apparatus such as a terminal, based on transmission path characteristics and the like of the signal, not for sensing the surrounding environment, but for determining that the other apparatus is in a range in which the signal for communication reaches or for estimating the direction of the other apparatus.

Note that, apparatus X200 may perform only a demodulation operation without performing a sensing operation when receiving a modulated signal for communication transmitted by, for example, the terminal as the communication partner.

Next, an apparatus that performs communication and sensing will be described.

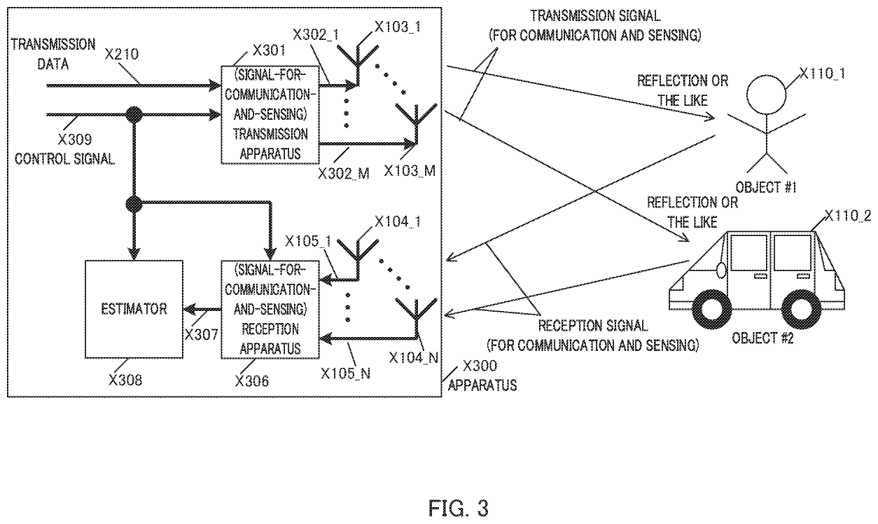

FIG. 3 illustrates an example of a configuration of apparatus X300 that performs communication and sensing. In the configuration illustrated in FIG. 3, the configurations having the same functions as those in the configurations illustrated in FIGS. 1 and 2 are denoted by the same reference signs, and detailed descriptions thereof will be omitted.

Apparatus X300 performs both sensing using a modulated signal for sensing and sensing using a modulated signal for communication.

That is, transmission apparatus X301 of apparatus X300 has a function of transmitting a signal for sensing in the same manner as transmission apparatus X101, and a function of transmitting a signal for communication to another communication apparatus in the same manner as transmission apparatus X201.

In addition, reception apparatus X306 of apparatus X300 has a function of receiving a signal for sensing in the same manner as reception apparatus X106, and a function of receiving a signal for communication transmitted by another communication apparatus in the same manner as reception apparatus X206.

Further, estimator X308 performs both estimation processing using a signal for sensing in the same manner as estimator X108, and estimation processing using a signal for communication in the same manner as estimator X208.

In the processing performed by each configuration element of apparatus X300, the processing of transmitting and receiving signals for sensing is the same as with apparatus X100 illustrated in FIG. 1, and the processing for transmitting and receiving signals for communication is the same as with apparatus X200 illustrated in FIG. 2. Accordingly, descriptions thereof will be omitted.

Although FIG. 3 illustrates the configuration of apparatus X300 in which transmission apparatus X301 and antennas X103_1 to X103_M, which perform transmission processing, and reception apparatus X306 and antennas X104_1 to X104_N, which perform reception processing, are different, the configuration of apparatus X300 is not limited thereto. For example, transmission apparatus X301 and reception apparatus X306 may be realized as one configuration element, and one or more antennas or a plurality of antennas may be used commonly for transmission and reception.

Apparatus X300 may also include, apart from the transmission apparatus for communication, a transmission apparatus for sensing. At this time, the transmission apparatus for communication and the transmission apparatus for sensing may use the same one or more antennas or the same plurality of antennas by switching, or may include one or more antennas or a plurality of antennas for communication and one or more antennas or a plurality of antennas for sensing, where the one or more antennas or the plurality of antennas for communication differ from the one or more antennas or the plurality of antennas for sensing.

Note that, transmission apparatus X301 for signals for communication and sensing may switch between transmitting a signal for sensing and transmitting a modulated signal for communication based on mode information included in control signal X309 and transmit the signal from the antenna. That is, a mode for transmitting a signal for sensing and a mode for transmitting a modulated signal for communication may be present. Further, transmission apparatus X301 for communication and sensing may also transmit a signal obtained by combining a signal for sensing and a modulated signal for communication.

Apparatus X300 may also include, apart from the reception apparatus for communication, a reception apparatus for sensing. At this time, the reception apparatus for communication and the reception apparatus for sensing may use the same one or more antennas or the same plurality of antennas by switching, or may include one or more antennas or a plurality of antennas for communication and one or more antennas or a plurality of antennas for sensing, where the one or more antennas or the plurality of antennas for communication differ from the one or more antennas or the plurality of antennas for sensing.

Further, apparatus X300 may also include a transmission apparatus for communication, a transmission apparatus for sensing, a reception apparatus for communication, and a reception apparatus for sensing separately from each another. Further, apparatus X300 may also include a transmission-reception apparatus for communication and a transmission-reception apparatus for sensing. Further, apparatus X300 may also include a transmission-reception apparatus for communication, a transmission apparatus for sensing, and a reception apparatus for sensing.

Further, in FIG. 3, in the same manner as in the descriptions with reference to FIGS. 1 and 2, one or more antennas for transmission or a plurality of antennas for transmission may be formed of one or more antenna units or a plurality of antenna units, and one or more antennas for reception or a plurality of antennas for reception may be formed of one or more antenna units or a plurality of antenna units. Further, the one or more antennas for transmission or the plurality of antennas for transmission and the one or more antennas for reception or the plurality of antennas for reception may be formed as a common transmission and reception antenna processor.

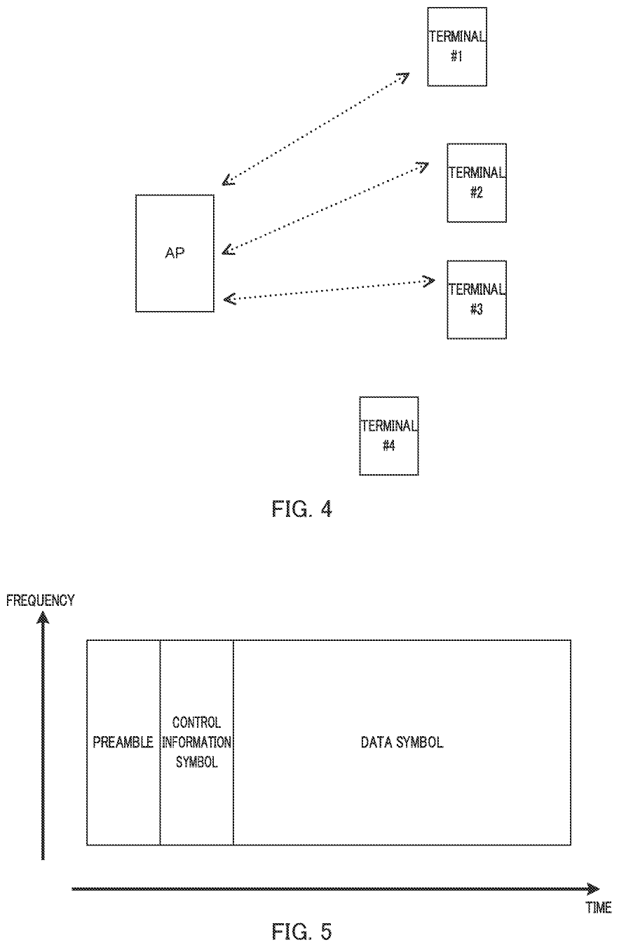

FIG. 4 illustrates an example of a communication system according to Embodiment 1. As an example, an AP and terminals communicate with each other. The AP has at least a communication function, and therefore has the configuration of apparatus X200 in FIG. 2 or apparatus X300 in FIG. 3.

The terminal may or may not have a communication function. For example, terminal #4 in FIG. 4 may have a function of sensing of an object and may not have a communication function. Thus, the terminals having a communication function (terminals #1, #2, and #3 in FIG. 3) have the configuration of apparatus X200 in FIG. 2 or apparatus X300 in FIG. 3. The terminal having no communication function (terminal #4 in FIG. 3) has the configuration of apparatus X100 in FIG. 1.

Hereinafter, an exemplary embodiment in which a modulated signal for communication and a signal for sensing are present in the same frequency band will be described.

FIG. 5 illustrates a configuration example of a frame for data transmission transmitted by an AP and a terminal having a communication function. The preamble illustrated in FIG. 5 is, for example, a symbol for a communication partner to perform signal detection, time synchronization, frequency synchronization, channel estimation, frequency offset estimation, and the like.

The control information symbol is a symbol for transmitting information on a data size, a method of transmitting a data symbol (for example, a modulation and coding scheme (MCS)) such as the number of transmission streams and an error correction coding method, and the like.

The data symbol is a symbol for transmitting data. The data symbol may include other symbols (for example, a reference symbol, a pilot symbol, a pilot carrier, or the like).

The frame configuration for frame for data transmission is not limited to the above example. The frame for data transmission may include symbols other than those illustrated in FIG. 5.

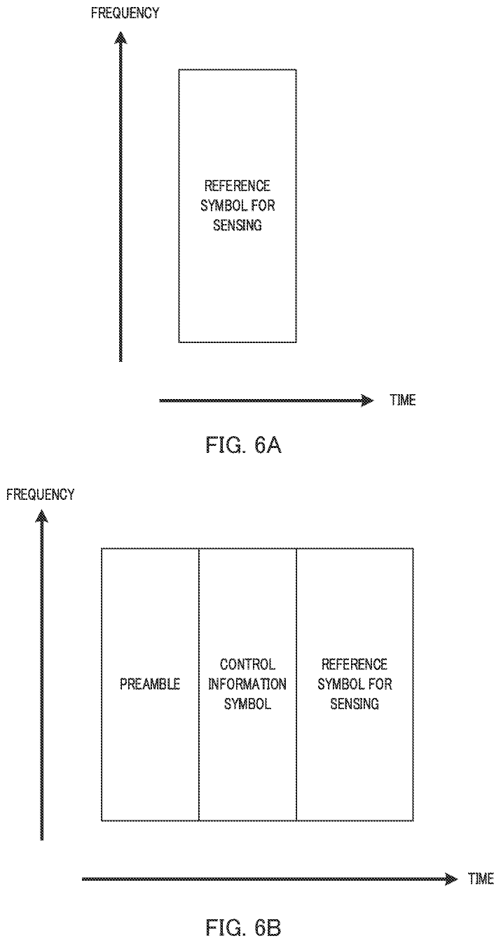

FIGS. 6A and 6B illustrate configuration examples of a frame for sensing transmitted by an AP and a terminal which have a sensing function. FIG. 6A illustrates a first example of the frame for sensing and FIG. 6B illustrates a second example of the frame for sensing.

The first example of the frame for sensing in FIG. 6A is formed of a reference symbol for sensing. However, other symbols may also be included in the frame for sensing.

The AP and the terminal perform sensing processing by using the reference symbol for sensing in FIG. 6A. The AP and the terminal may temporally continuously transmit reference symbols for sensing. Note that, although the term “reference symbol for sensing” is used, an unmodulated signal or a signal such as a carrier wave may be used. In this regard, the same also applies to FIG. 6B.

The second example of the frame for sensing in FIG. 6B is formed of, for example, a preamble, a control information symbol, and a reference symbol for sensing. However, other symbols may also be included in the frame for sensing.

The AP and the terminal perform sensing processing by using the reference symbol for sensing in FIG. 6B.

The preamble in FIG. 6B is, for example, a symbol for a communication partner to perform signal detection, time synchronization, frequency synchronization, channel estimation, frequency offset estimation, and the like. Note that, both the AP and the terminal which have a communication function are assumed to be capable of detecting this preamble. For example, the configuration of the preamble may be the same (or may not be the same) as that of the preamble in FIG. 5.

In this way, the AP and the terminal having a communication function can know the presence of a frame for sensing so that it is possible to obtain the effect that interference between a frame for sensing and a frame for communication can be reduced.

The control information symbol in FIG. 6B is a symbol including information on a reference symbol for sensing. The control information symbol may also include other information.

Examples of the information on a reference symbol for sensing include as follows:
the type of a sensing reference signal, which is assumed to be designatable from a plurality of symbol types, for example;
the frequency band of a sensing reference signal, which is assumed to be designatable from a plurality of frequency bands, for example; and
the time domain of a sensing reference signal, which is assumed to be designatable from a plurality of time intervals, for example.

The AP and the terminal which have a sensing function can configure a desired sensing accuracy by designating the information on a reference symbol for sensing in the control information symbol. However, the information in the control information symbol is not limited thereto.

The AP and the terminal perform sensing processing by using the reference symbol for sensing in FIG. 6B. The AP and the terminal may temporally continuously transmit reference symbols for sensing.

The configuration of the frame for sensing is not limited to those in FIGS. 6A and 6B. The frame for sensing may include symbols other than those illustrated in FIGS. 6A and 6B.

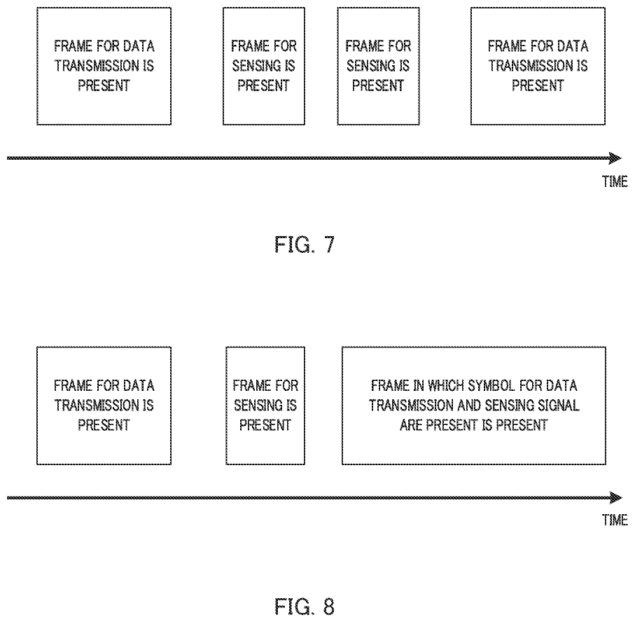

FIG. 7 illustrates an example of a frame state in a time axis of a certain frequency band. As illustrated in FIG. 7, for example, the AP may switch between the frame for data transmission and the frame for sensing for transmission thereof. The terminal may switch between the frame for data transmission and the frame for sensing for transmission thereof.

It is desirable that the AP and the terminal transmit frames and perform control such that the frames do not overlap at a certain frequency, that is, the frames do not interfere with each other as in FIG. 7, for example. Embodiment 1 relates to a transmission method for suppressing frame interference, and this point will be described hereinafter.

FIG. 8 illustrates another example of a frame state in a time axis of a certain frequency band. As illustrated in FIG. 8, for example, the AP may switch among the frame for data transmission, the frame for sensing, and the frame, in which a symbol for data transmission and a sensing signal are present, for transmission thereof. The terminal may switch among the frame for data transmission, the frame for sensing, and the frame, in which a symbol for data transmission and a sensing signal are present, for transmission thereof.

It is desirable that the AP and the terminal transmit frames and perform control such that the frames do not overlap at a certain frequency, that is, the frames do not interfere with each other as in FIG. 8, for example. Embodiment 1 relates to a transmission method for suppressing frame interference, and this point will be described hereinafter.

Note that, the frame configuration of the “frame in which a symbol for data transmission and a sensing signal are present” will be described later.

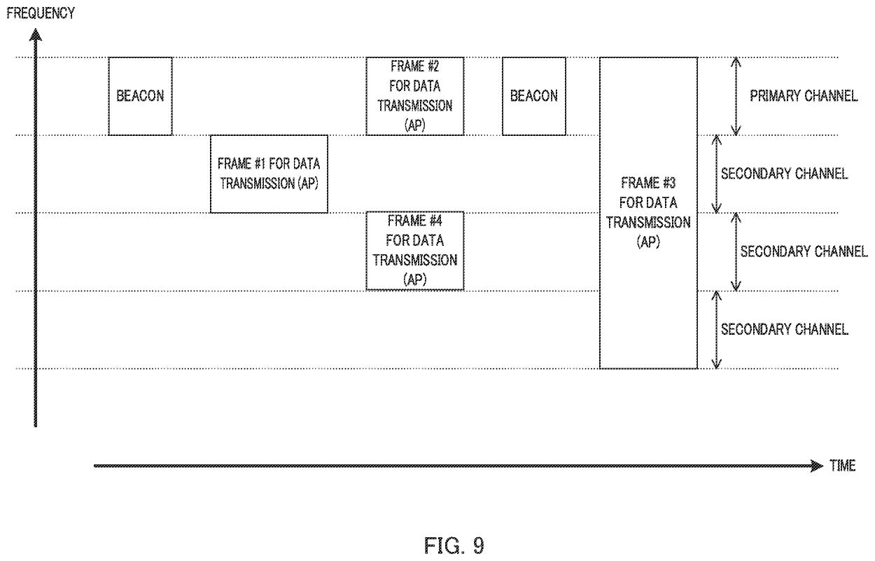

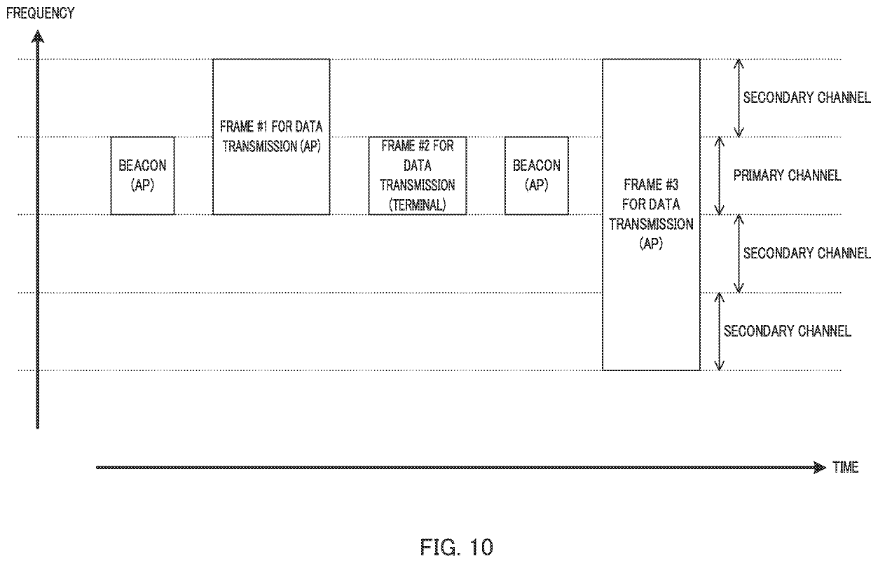

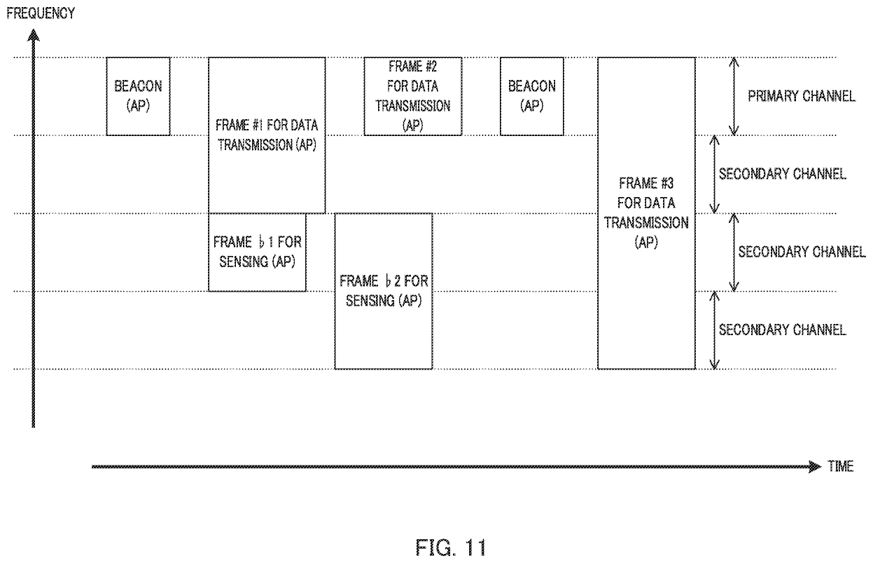

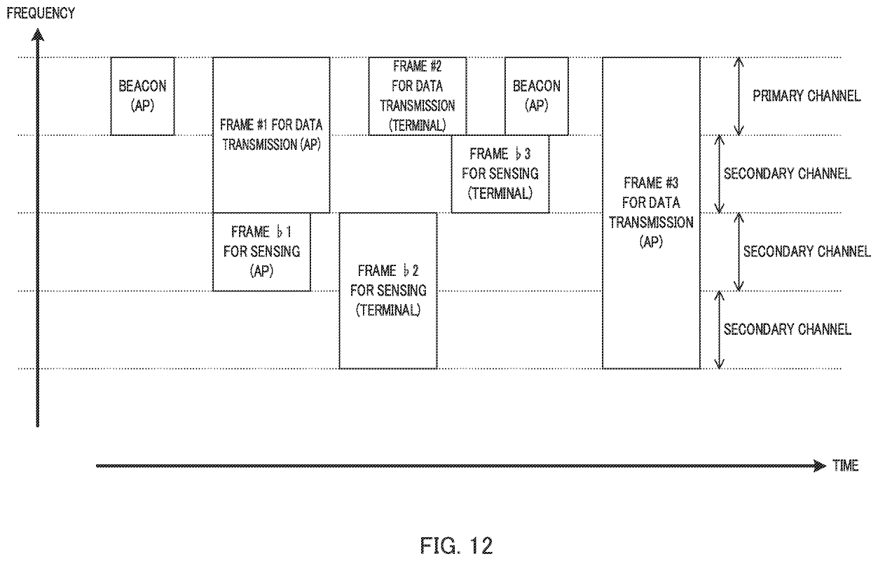

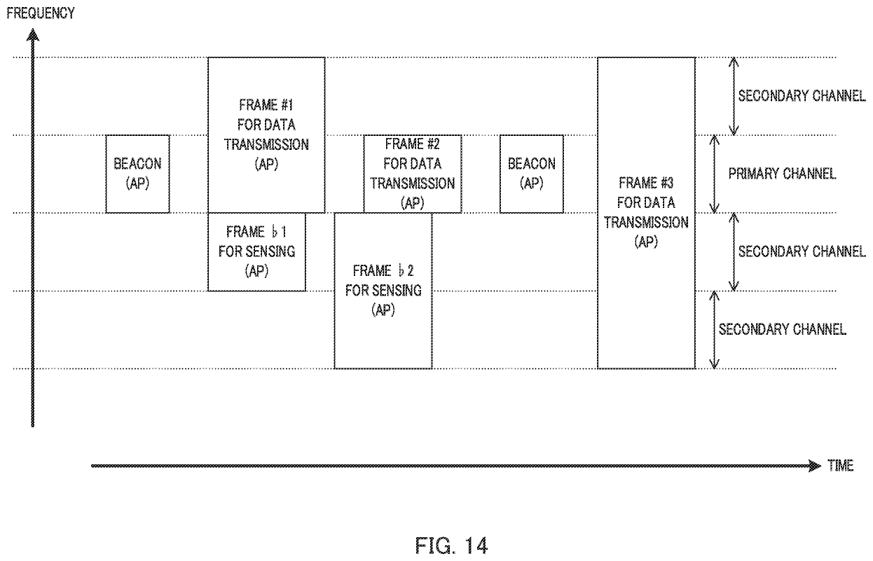

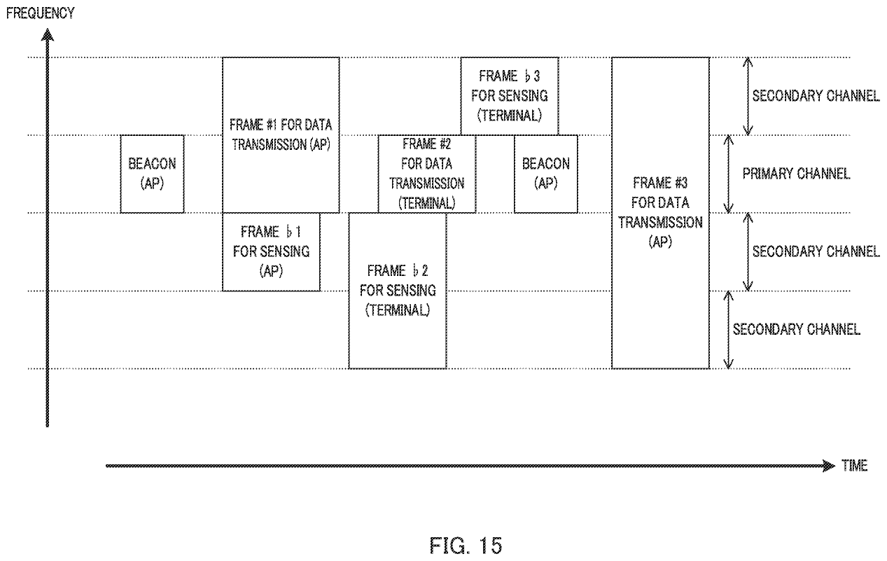

FIGS. 9 to 15 illustrate examples of a use state of time and frequency in a wireless LAN system. In a case where “ . . . (AP)” is described in FIGS. 9 to 15, it is indicated that the AP transmits a signal (frame). Further, in a case where “ . . . (TERMINAL)” is described in FIGS. 9 to 15, it is indicated that the terminal transmits a signal.

In FIGS. 9 to 15, primary channels and secondary channels are present. Both the primary channel and the secondary channel may be, for example, a 20 MHz band.

The AP transmits a beacon through the primary channel. The AP does not transmit a beacon through the secondary channel. Here, the terms “primary channel” and “secondary channel” are used, but the names thereof are not limited thereto. For example, the primary channel may be referred to as “first channel” and the secondary channel may be referred to as “second channel”.

In the cases of FIGS. 9 to 15, the AP and the terminal transmit frames by using one or more channels of four channels formed of primary and secondary channels. At this time, the AP and the terminal can perform the following communications:
Case 1: transmission of a frame by using one channel formed with 20 MHz (for example, “FRAME #1 FOR DATA TRANSMISSION (AP)” in FIG. 9); and
Case 2: transmission of a frame by bundling a plurality of contiguous channels formed with 20 MHz (for example, “FRAME #3 FOR DATA TRANSMISSION (AP)” in FIG. 9) (hereinafter referred to as channel bonding.)

Further, the AP and the terminal can perform the following communication:
Case 3: transmission of a plurality of “frames formed by Case 1” or a plurality of “frames formed by Case 2” by using a common time section. (As illustrated in FIG. 9, the AP transmits “FRAME #2 FOR DATA TRANSMISSION” and “FRAME #4 FOR DATA TRANSMISSION” by using a common time section.) (hereinafter referred to as channel aggregation.)

In FIGS. 9 to 15, the AP and the terminal transmit a frame for sensing by using the secondary channel of the primary channel and the secondary channel determined by the AP.

With this processing, the beacon transmitted by the AP is suppressed from interference by other signals, and the communication between the AP and the terminal is performed well. Further, the communication between the AP and the terminal by the primary channel can be performed frequently.

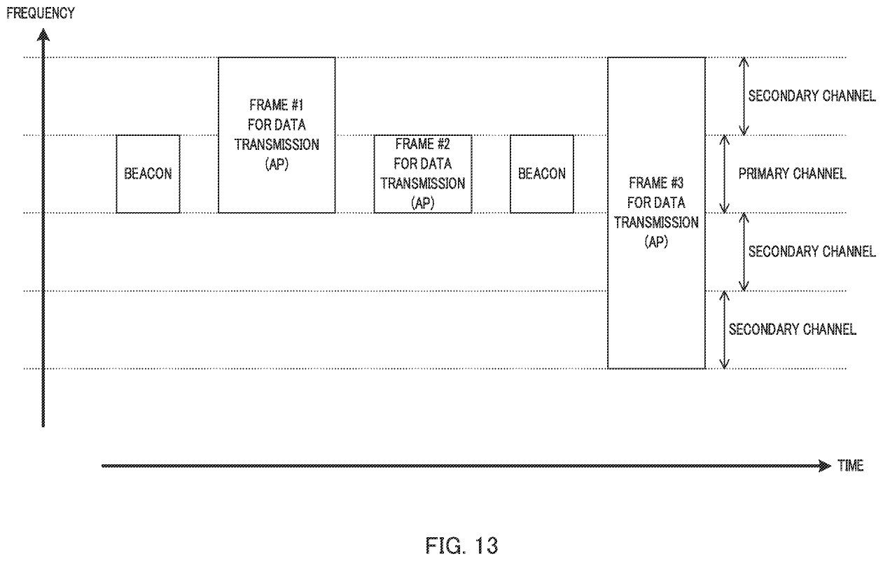

Note that, although an example of mapping the primary channel as illustrated in FIGS. 9 to 12 and an example of mapping the primary channel as illustrated in FIGS. 13 to 15 are indicated, the method of mapping the primary channel is not limited thereto.

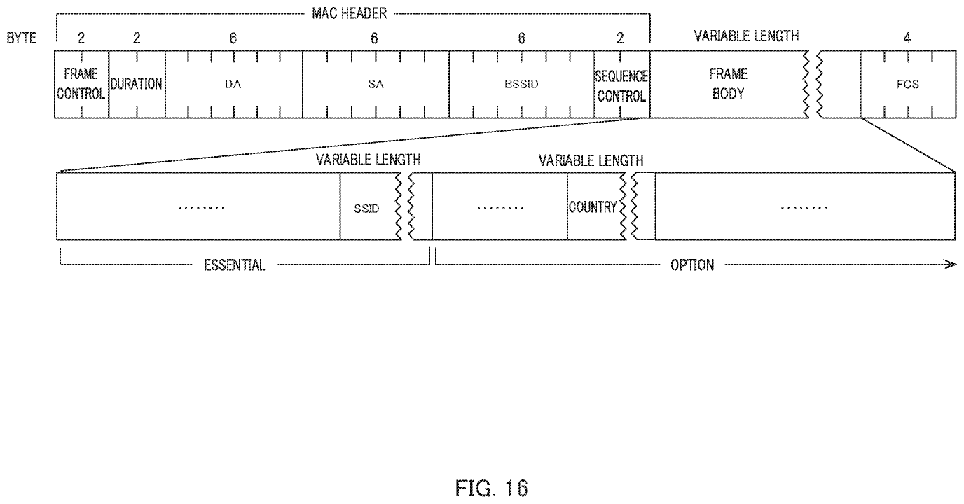

FIG. 16 illustrates an example of a configuration of a beacon. An extended area of the beacon (for example, the part OPTION in FIG. 16) may include, for example, the following information:
Information on whether a frequency domain corresponds to sensing; and
Information on the secondary channel corresponding to sensing.

This allows coexistence of a sensing signal and a modulated signal for communication.

Another method:

It may be defined by a standard that a sensing signal is transmitted through the secondary channel with no “information on the secondary channel corresponding to sensing” being present.

Note that, the beacon may be utilized in sensing of an object. For example, the extended area of the beacon may include information indicating that the beacon is utilized in sensing of an object.

Further, in a case where the beacon is utilized in sensing of an object, the temporal length of the beacon (the frame length of the beacon) may be lengthened. In this way, it is possible to obtain the effect that the estimation accuracy by sensing improves. Further, in this case, the beacon may include information indicating the frame length of the beacon.

Note that, the part to be utilized in sensing of an object is not limited to the beacon, but, for example, a preamble before a data symbol in a data frame may also be utilized in sensing of an object. At this time, the temporal length of the preamble may be configured to be longer in order to improve the estimation accuracy by sensing. Accordingly, the temporal length of the preamble to be transmitted only for communication and the temporal length of the preamble to be transmitted when performing sensing may be different, or the temporal length of the preamble may be configurable depending on situations such as only communication is performed, and/or sensing is performed. Note that, information on the length of the preamble may be transmittable in an arbitrary part of a frame.

The configuration of a frame transmitted by an AP or a terminal by using a plurality of channels with a 20 MHz bandwidth will be described.

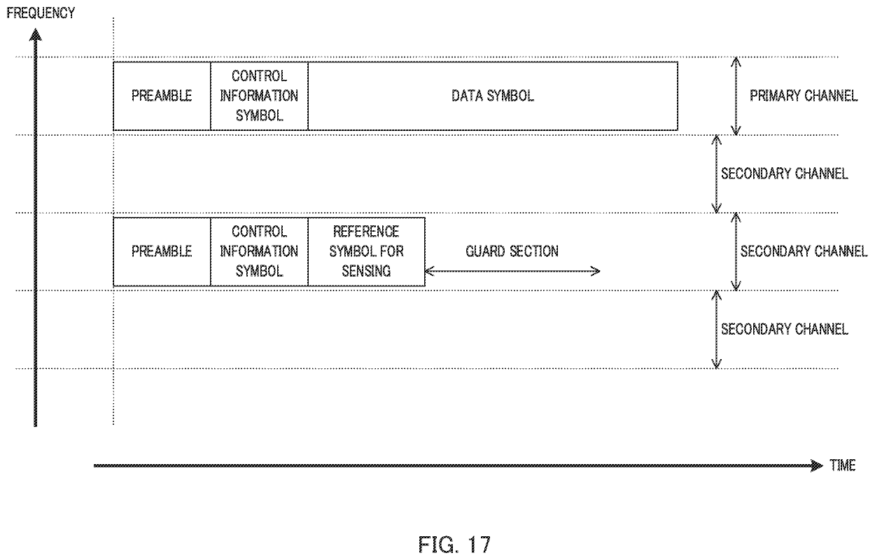

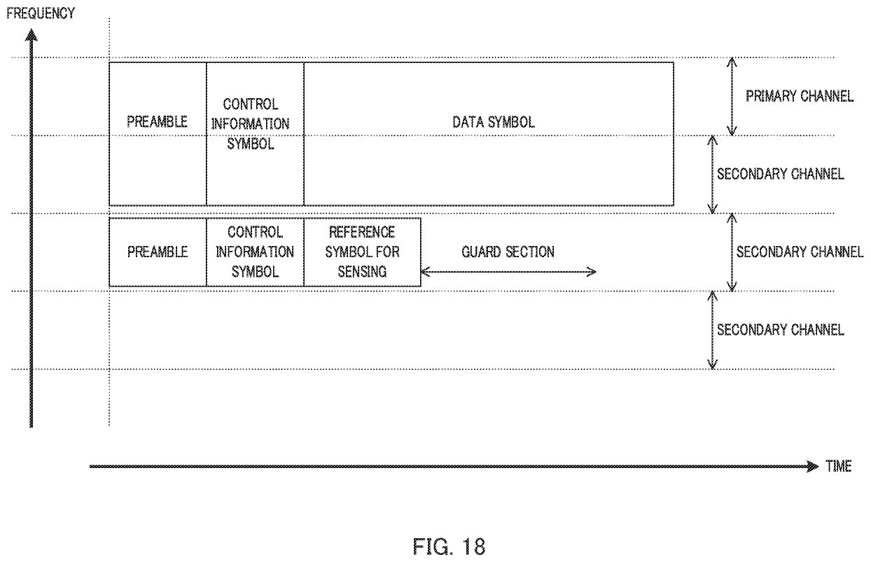

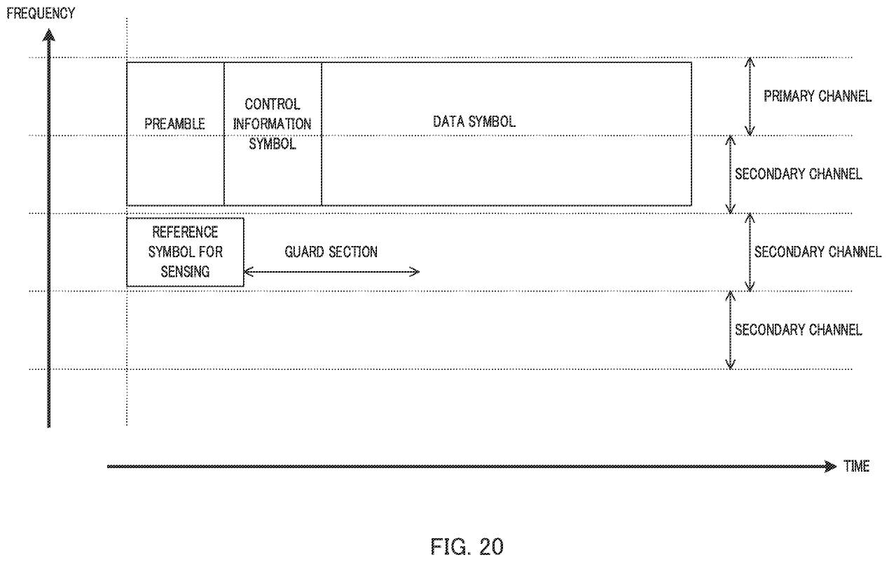

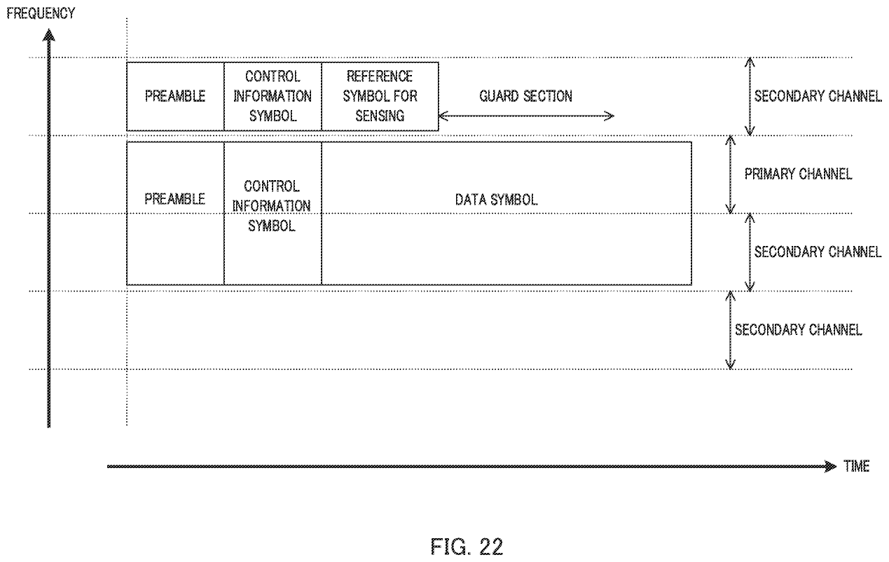

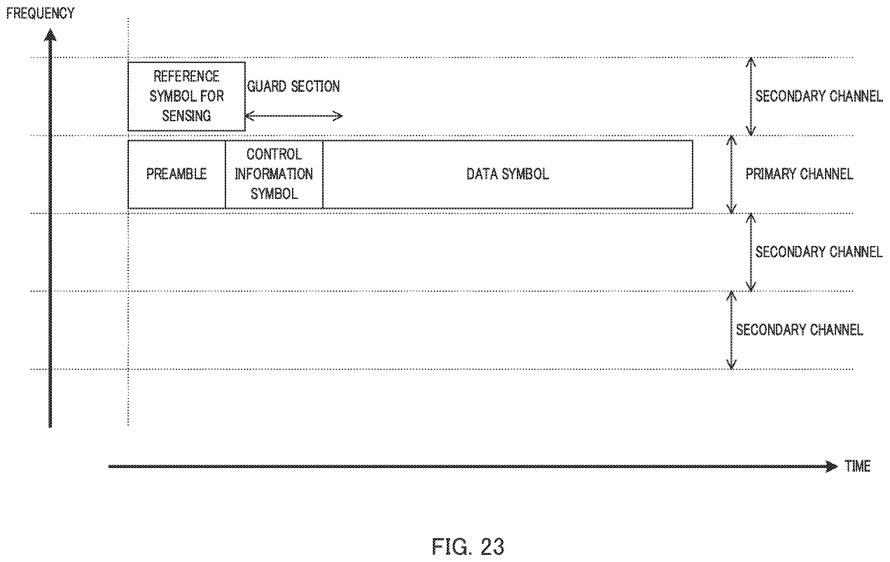

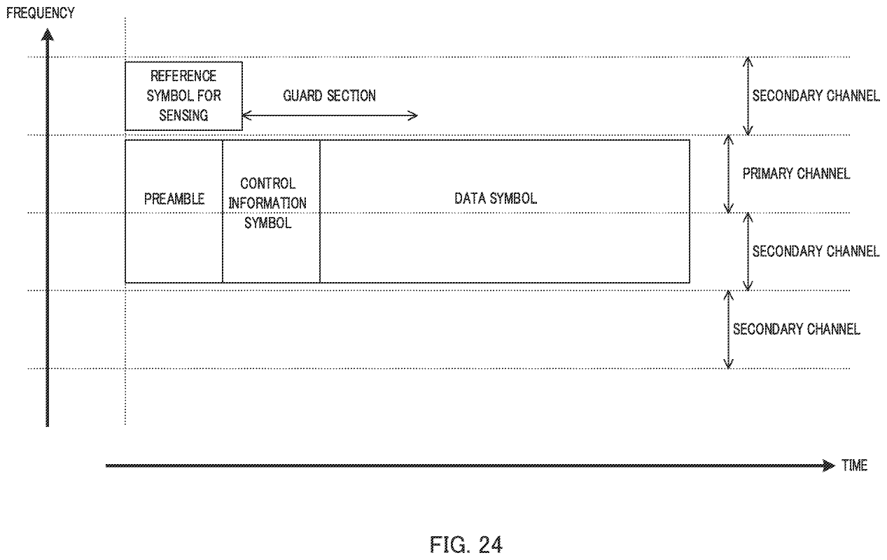

FIGS. 17 to 24 illustrate examples of a configuration of a frame of a signal transmitted by an AP or a terminal in channel aggregation. The frame including a data symbol in FIGS. 17 to 24 is a frame for data transmission. The frame including a reference symbol for sensing is a frame for sensing. The frame for sensing including a sensing symbol is present in a secondary channel.

The frame for data transmission may be mapped in the primary channel or in one or more secondary channels. Further, the frame for data transmission may be mapped in the primary channel and/or a secondary channel(s).

The frame for sensing may be mapped in one or more secondary channels. One of channel bonding and channel aggregation may be applied to the frame for sensing.

FIGS. 17 to 24 are exemplary. The method of how the frame for data transmission and the frame for sensing frames are present at the time of channel aggregation is not limited to the examples in FIGS. 17 to 24.

In the examples of FIGS. 17, 18, 21, and 22, the sensing frame includes the preamble and the control information symbol illustrated in FIG. 6B in addition to the reference symbol for sensing.

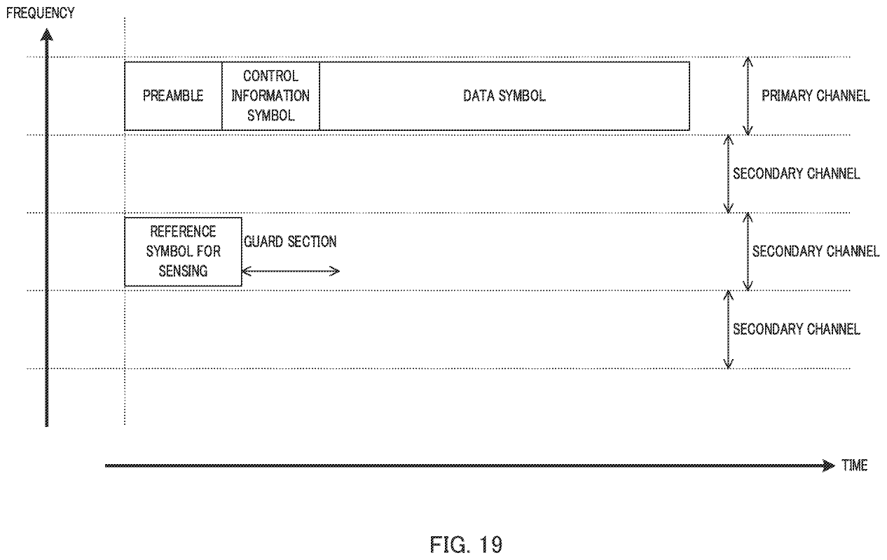

In the examples of FIGS. 19, 20, 23, and 24, the sensing frame includes the reference symbol for sensing, but does not include the preamble and the control information symbol illustrated in FIG. 6B.

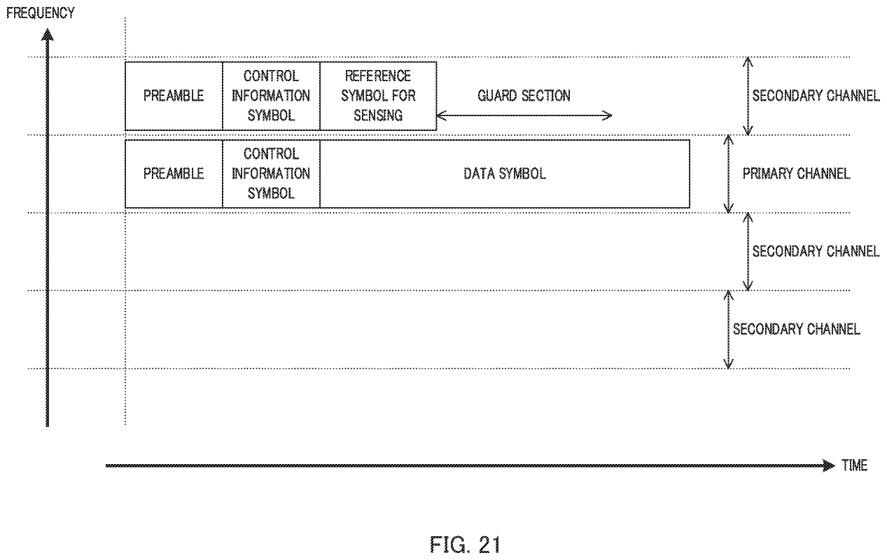

Although a case where the primary channel is mapped as illustrated in FIGS. 17 to 20 and a case where the primary channel is mapped as illustrated in FIGS. 21 to 24 have been indicated, the method of mapping the primary channel is not limited thereto.

In FIGS. 17 to 24, a guard section may or may not be present. For example, in a case where no guard section is present, the frame may be configured such that a reference symbol for sensing is present in a temporally long section.

In a case where the frame includes a guard section, a “directionality in precoding or beamforming used to transmit a reference symbol for sensing present before the guard section” and a “directionality in precoding or beamforming used to transmit a reference symbol for sensing present after the guard section” may be configured differently, for example, which allows wide-range sensing.

Further, in a case where the frame includes a guard section, an “antenna used to transmit a reference symbol for sensing present before the guard section” and an “antenna used to transmit a reference symbol for sensing present after the guard section” may be configured differently, which allows wide-range sensing.

Further, guard sections and reference signals for sensing may also be repeatedly mapped in the frame such that a reference symbol for sensing is mapped after a guard section, and thereafter a guard section, a reference signal for sensing, a guard section, a reference signal for sensing, and so on. At this time, the directionalities in precoding or beamforming to be used may be configured for each sensing reference symbol, and/or the antennas to be used may be switched for each sensing reference symbol.

Note that, the guard section is assumed to be, for example, a time section in which a signal or a symbol is not present.

The configuration of a frame transmitted by an AP or a terminal by using a plurality of channels with 20 MHz will be described.

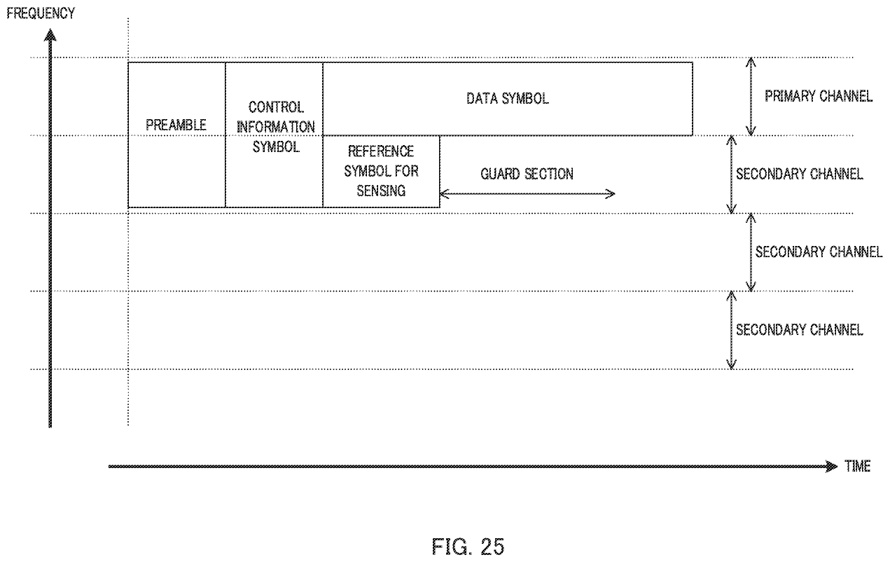

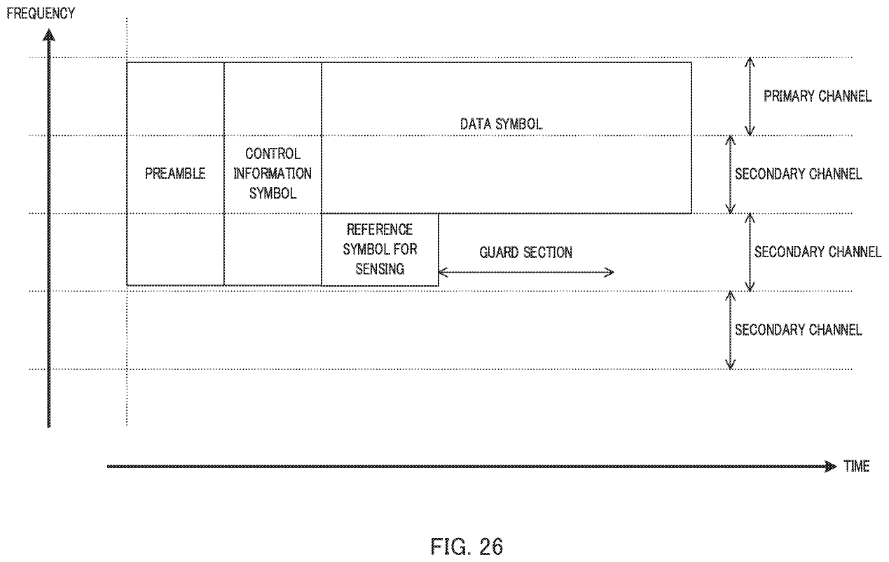

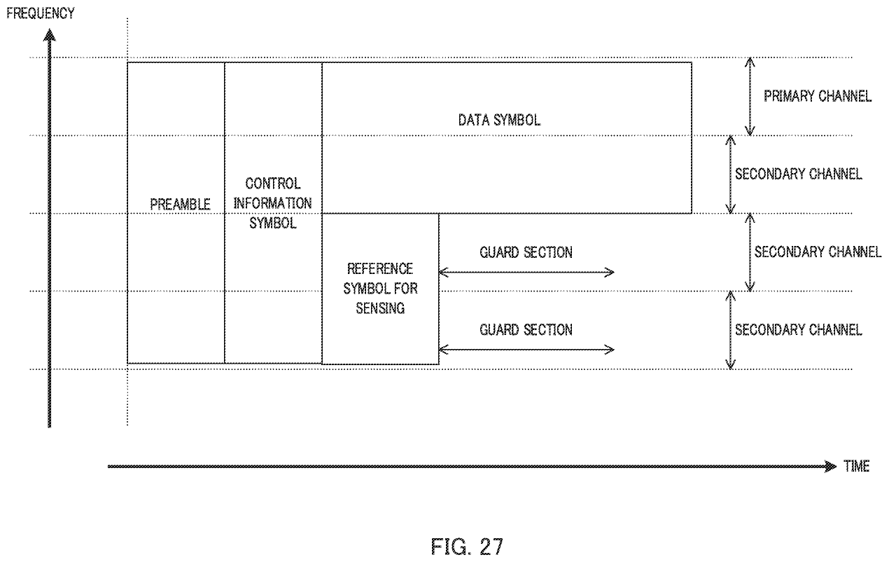

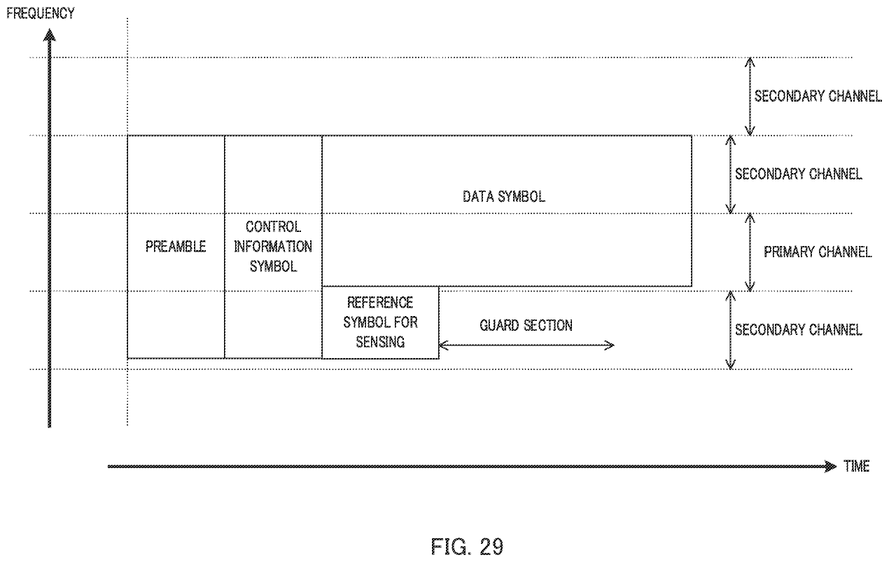

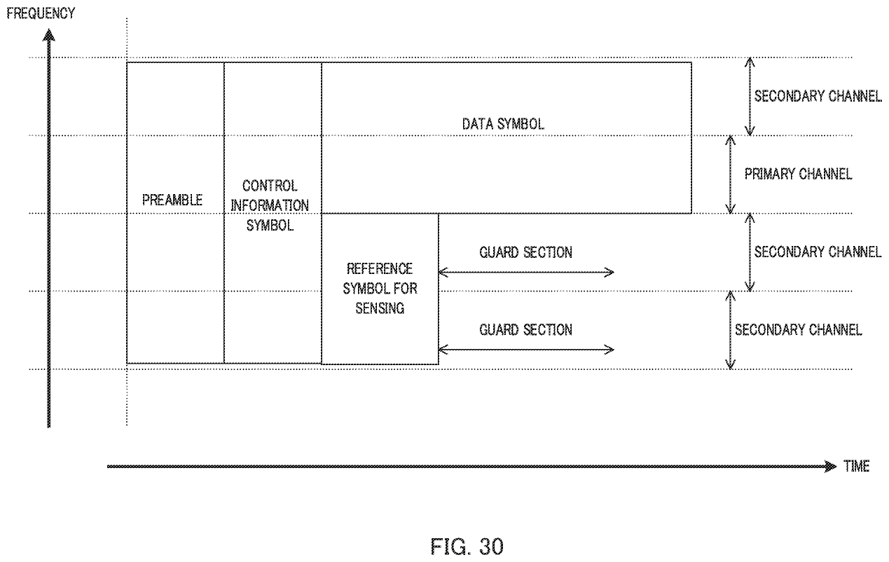

FIGS. 25 to 30 illustrate examples of a configuration of a frame of a signal transmitted by an AP or a terminal in channel bonding. In the examples of FIGS. 25 to 30, a data symbol and a reference symbol for sensing coexist at the time of channel bonding. Further, a symbol for sensing is mapped in a secondary channel(s). The data symbol may be mapped in the primary channel or a secondary channel(s). Further, the data symbol may be mapped in the primary channel and a secondary channel(s).

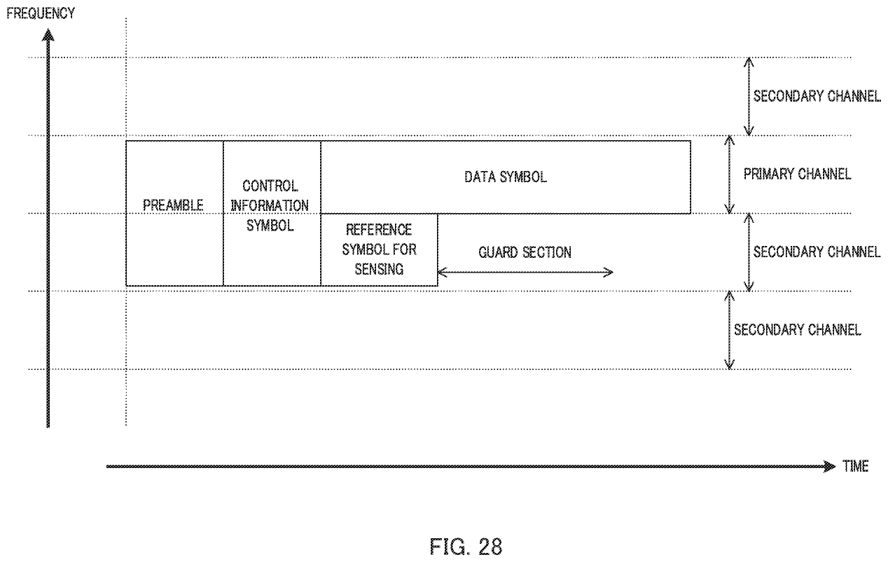

FIGS. 25 to 30 are exemplary. The method of how the data symbol and the reference symbol for sensing are present at the time of channel bonding is not limited to the examples in FIGS. 25 to 30. Further, although a case where the primary channel is mapped as illustrated in FIGS. 25 to 27 and a case where the primary channel is mapped as illustrated in FIGS. 28 to 30 have been indicated, the method of mapping the primary channel is not limited thereto.

In FIGS. 25 to 30, a guard section may or may not be present after a sensing reference symbol. For example, in a case where no guard section is present, the frame may be configured such that a reference symbol for sensing is present in a temporally long section.

In a case where the frame includes a guard section, a “directionality in precoding or beamforming used to transmit a reference symbol for sensing present before the guard section” and a “directionality in precoding or beamforming used to transmit a reference symbol for sensing present after the guard section” may be configured differently, for example, which allows wide-range sensing.

Further, in a case where the frame includes a guard section, an “antenna used to transmit a reference symbol for sensing present before a guard section” and an “antenna used to transmit a reference symbol for sensing present after a guard section” may be configured differently, which allows wide-range sensing. In a case where the frame includes a guard section, the data symbol may be mapped after the guard section.

Further, guard sections and reference signals for sensing may also be repeatedly mapped in the frame such that a reference symbol for sensing is mapped after a guard section, and thereafter a guard section, a reference signal for sensing, a guard section, a reference signal for sensing, and so on. At this time, the directionalities in precoding or beamforming to be used may be configured for each sensing reference symbol, and/or the antennas to be used may be switched for each sensing reference symbol.

Note that, the guard section is assumed to be, for example, a time section in which a signal or a symbol is not present.

The above configuration enables coexistence of a sensing signal and a modulated signal for communication, which makes it possible to reduce interference between the sensing signal and the modulated signal for communication. Further, communication apparatuses such as an AP and a terminal can perform parallel processing of processing for sensing and processing for communication. Further, in a case where a modulated signal for communication in the primary channel is preferentially assigned, it is also possible to obtain the effect that an adverse effect on a terminal that performs communication can be reduced.

With respect to each frame of Embodiment 1, the preamble, the control information symbol, the data symbol, and the reference symbol for sensing have been described, but other symbols or signals may also be present.

Further, symbols other than a data symbol, such as a reference symbol (reference signal), a pilot symbol (pilot signal), or a mid-amble may be included in the area described as the data symbol.

Further, although the beacon, the frame for data transmission, and the frame for sensing have been described, communication apparatuses such as an AP and a terminal may transmit other frames, such as a medium access control (MAC) management frame and a MAC control frame.

### Embodiment 2

In Embodiment 2, an example of a configuration of a frame in which a data symbol is also transmitted at a frequency (frequency band) for transmitting a reference signal for sensing.

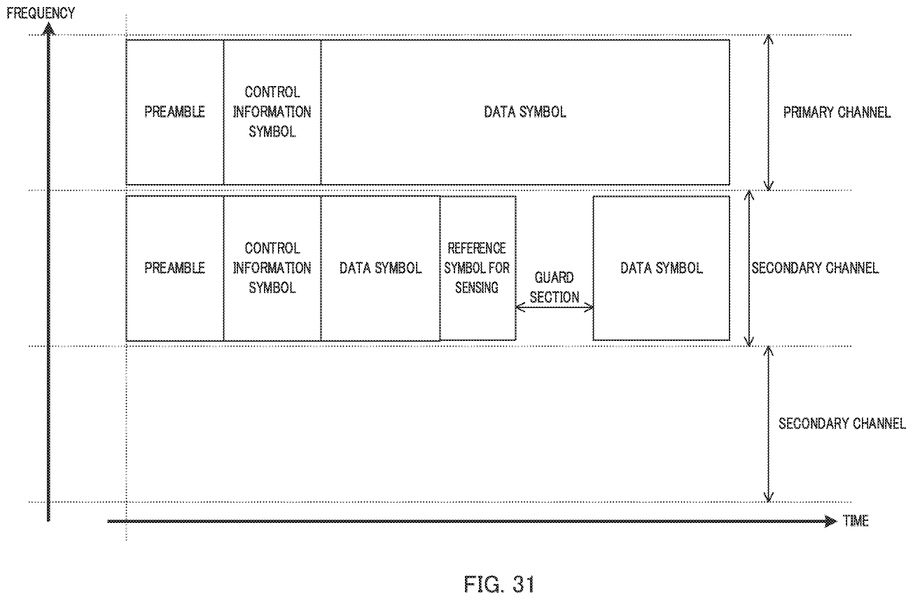

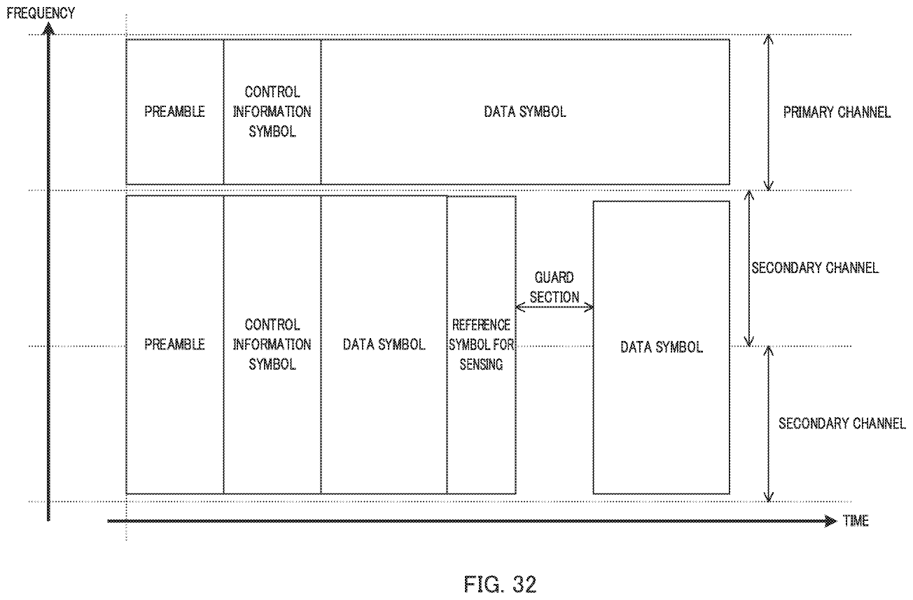

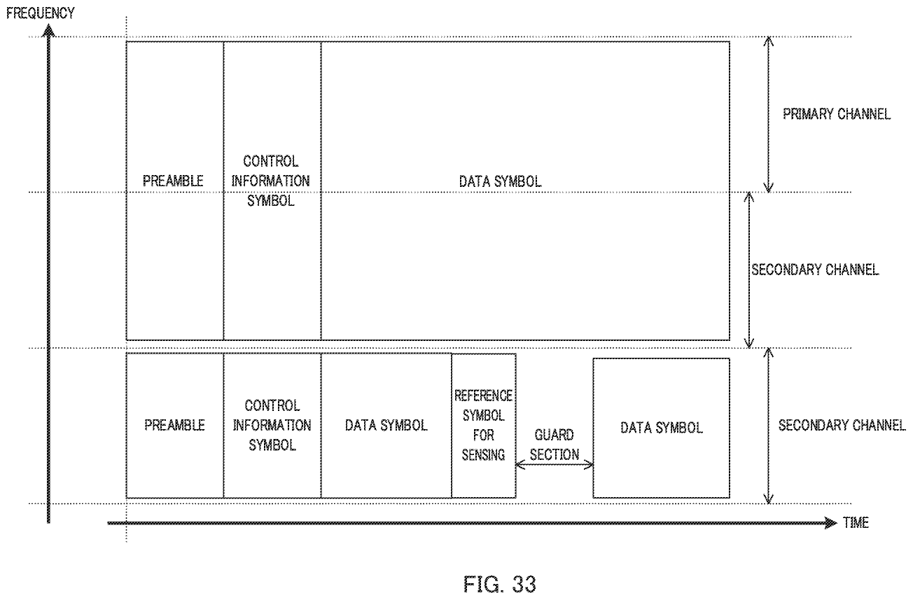

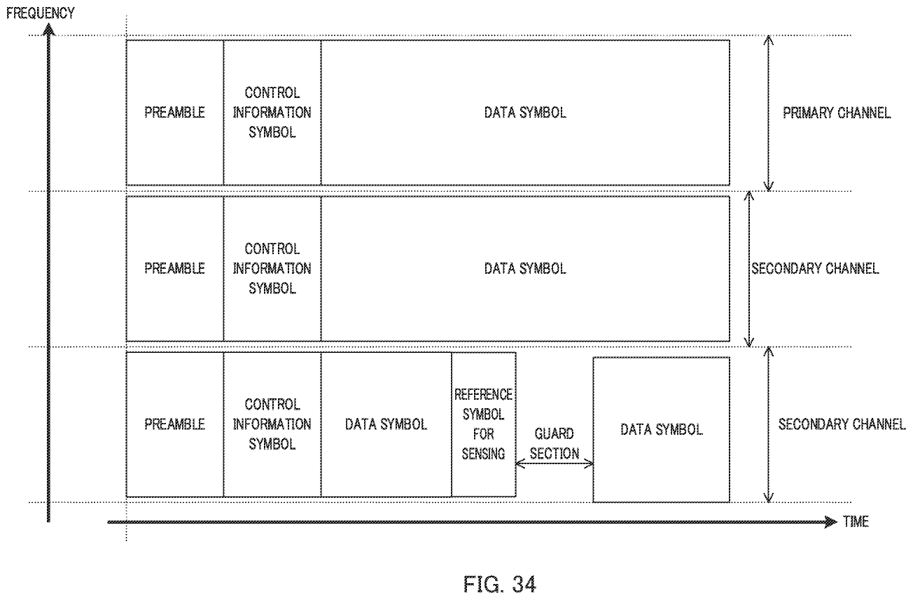

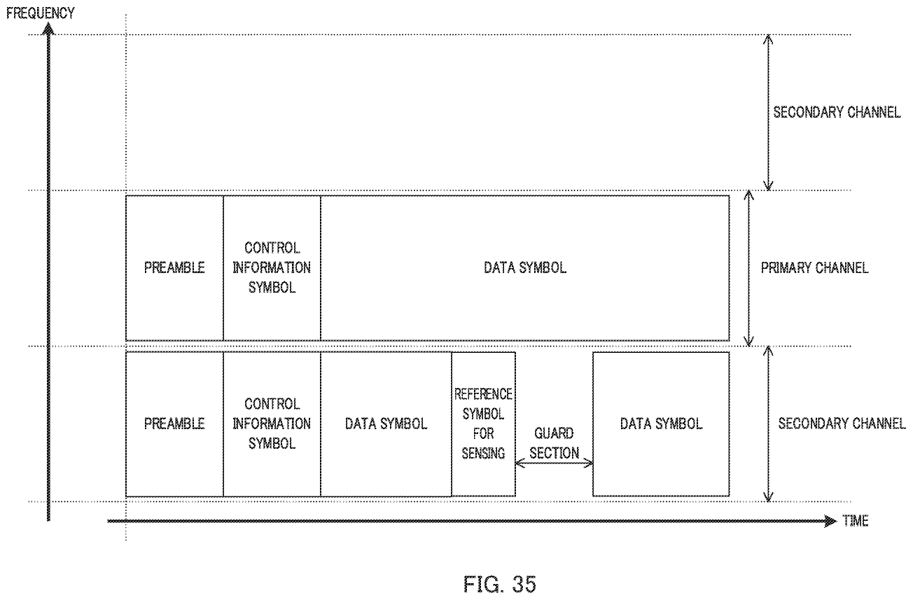

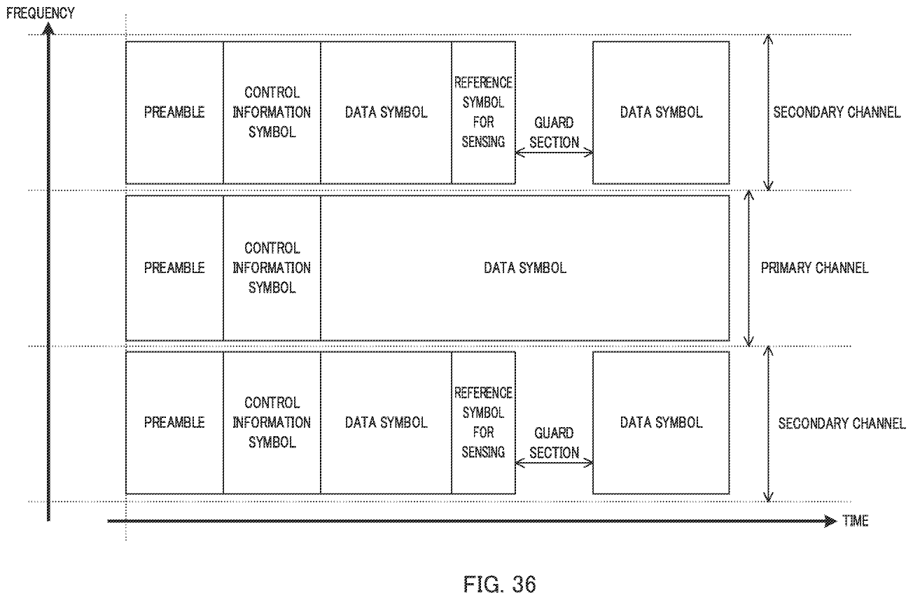

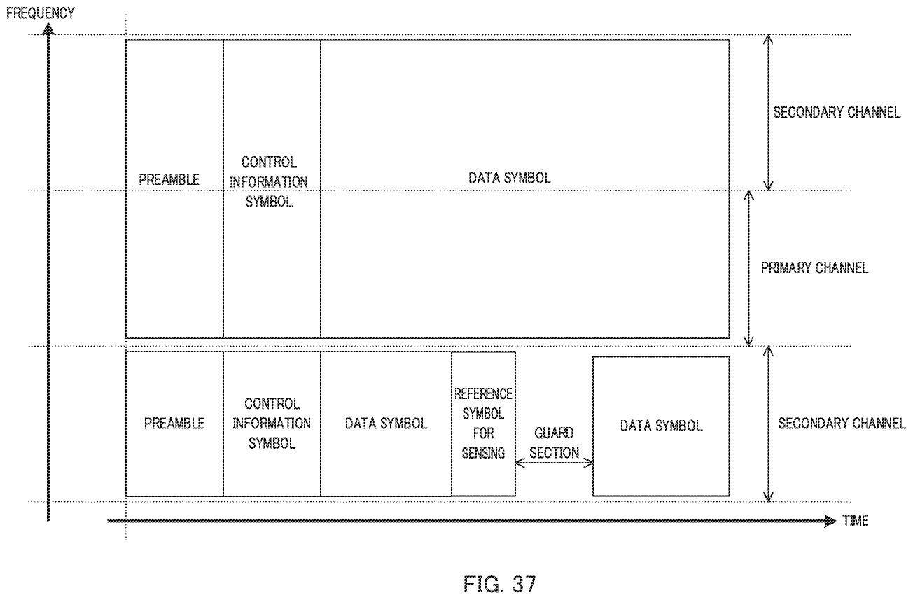

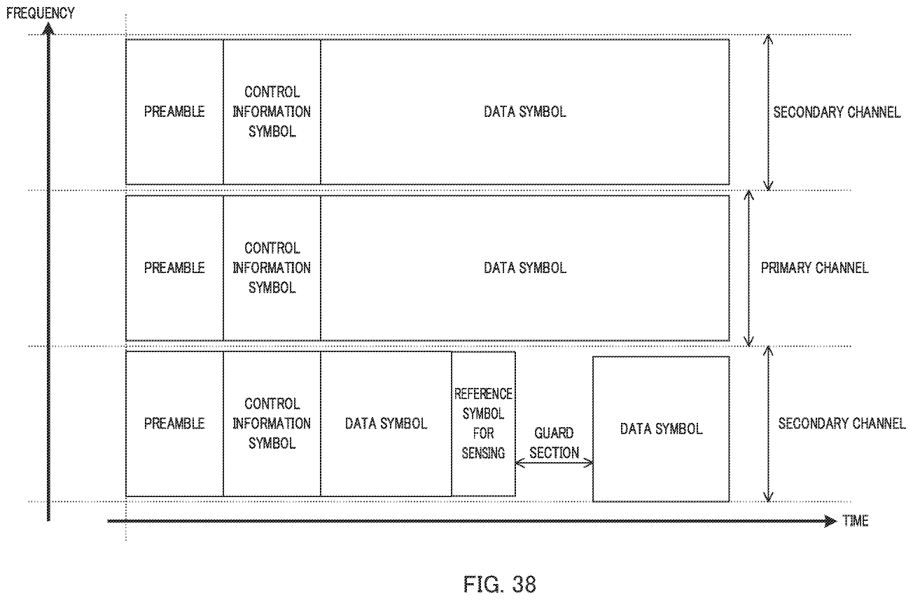

FIGS. 31 to 38 illustrate examples of a configuration of a frame transmitted by an AP or a terminal. FIGS. 31 to 38 illustrate examples of a configuration of a frame in channel aggregation. Further, FIGS. 31 to 38 illustrate examples of a configuration of a frame in which a reference symbol for sensing is inserted in the time axis direction. Reference symbols for sensing are mapped in secondary channels.

A guard section is present immediately after a reference symbol for sensing. In this case, a “directionality in precoding or beamforming performed on a reference symbol for sensing before the guard section” and “precoding or beamforming performed on a data symbol after the guard section” may be configured differently, or suitable control may be performed on each symbol.

Further, an “antenna used for a reference symbol for sensing before the guard section” and an “antenna used for a data symbol after the guard section” may be configured differently, or suitable control may be performed on each symbol.

This increases the possibility that each symbol will obtain good reception quality.

Note that, the guard section is assumed to be, for example, a time section in which a signal or a symbol is not present.

Further, in a case where the control as described above is not performed, no guard section may be present.

The mapping of reference symbols for sensing is not limited to the examples in FIGS. 31 to 38. For example, a reference symbol for sensing may be mapped, then a data symbol is mapped in the time axis direction, and further thereafter a reference symbol for sensing may be mapped in the time axis direction. That is, a plurality of reference symbols for sensing may be mapped, while a data symbol(s) or the like is/are mapped, in the time axis direction.

A guard section may also be present before a reference symbol for sensing. The frame configuration is not limited to the examples in FIGS. 31 to 38. The mapping of the primary channel is not limited to the examples in FIGS. 31 to 38.

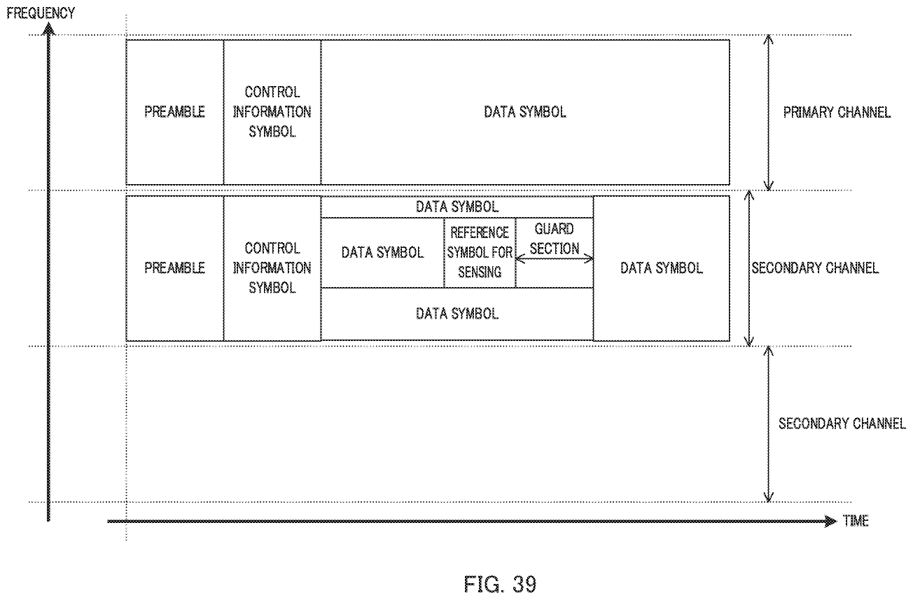

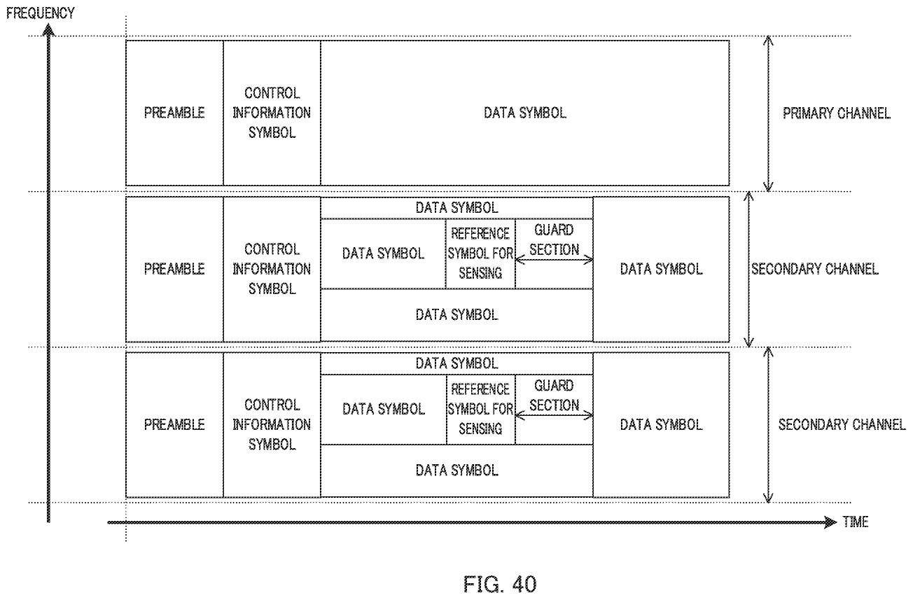

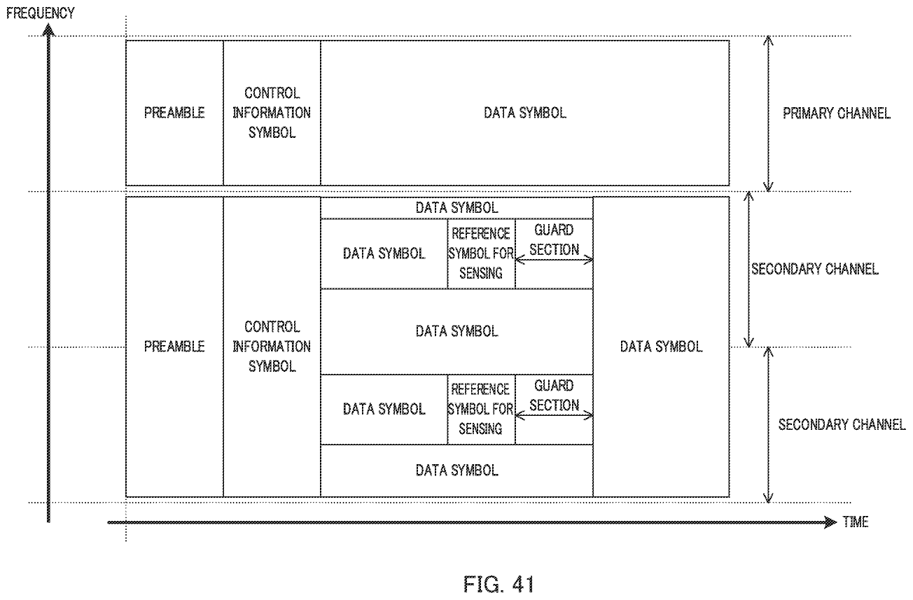

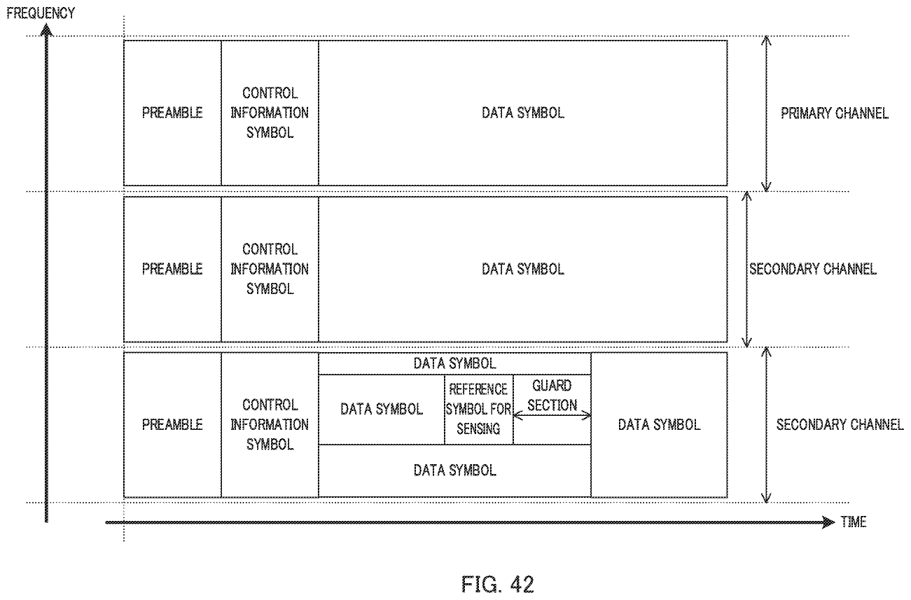

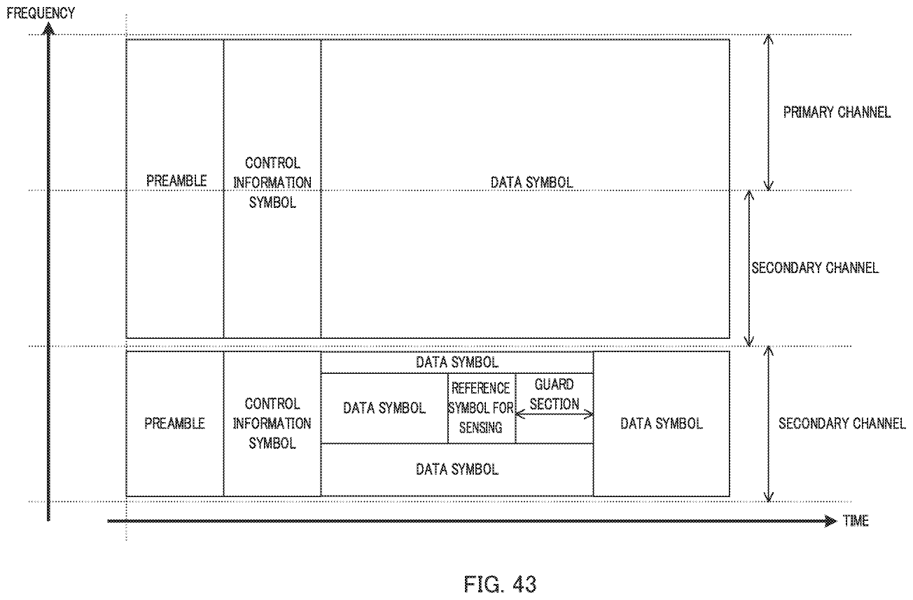

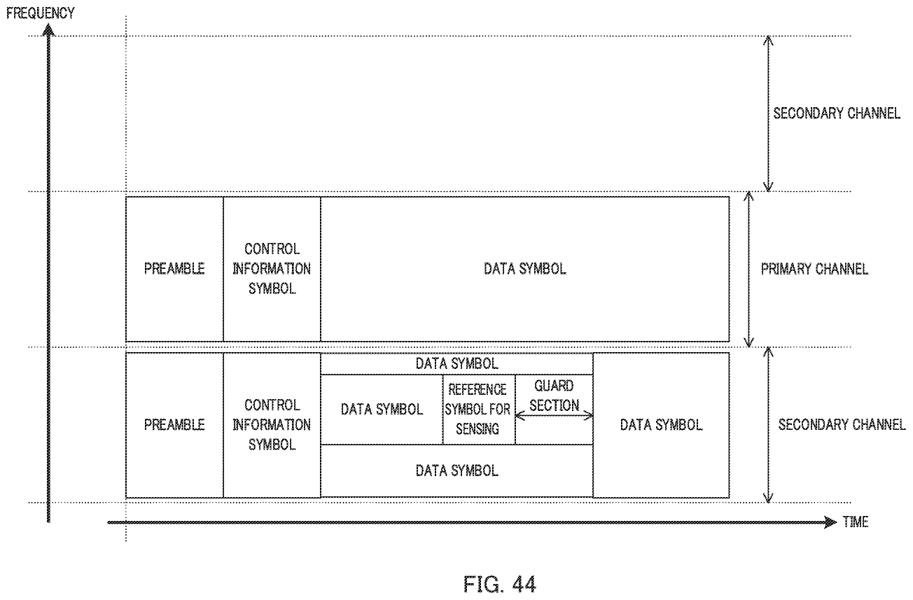

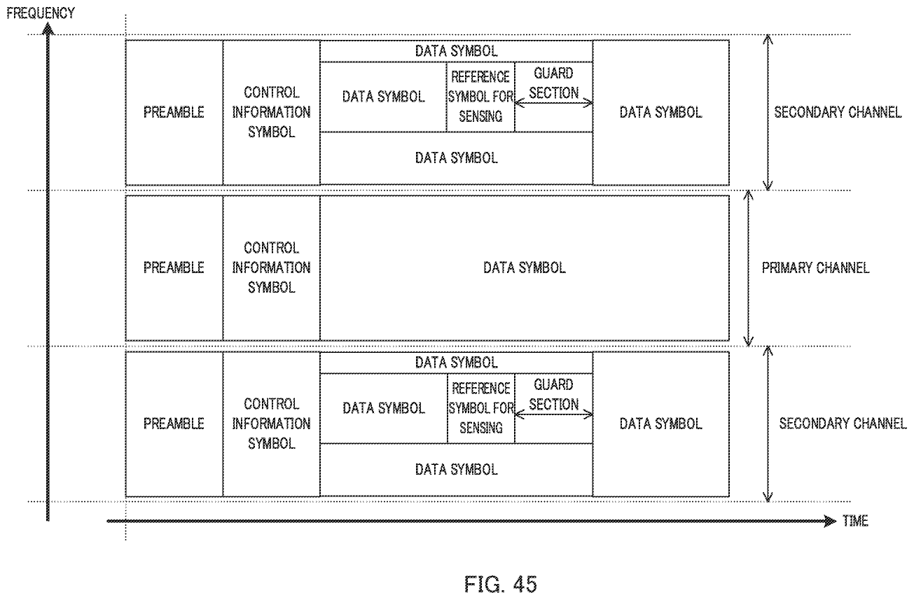

FIGS. 39 to 45 illustrate examples of a configuration of a frame transmitted by an AP or a terminal. FIGS. 39 to 45 illustrate examples of a configuration of a frame in channel aggregation. Further, FIGS. 39 to 45 illustrate examples of a configuration of a frame in which a reference symbol for sensing is inserted in the frequency axis direction. Reference symbols for sensing are mapped in secondary channels.

A guard section is present immediately after a reference signal for sensing. In this case, a “directionality in precoding or beamforming performed on a reference symbol for sensing before the guard section” and “precoding or beamforming performed on a data symbol after the guard section” may be configured differently, or suitable control may be performed on each symbol.

Further, an “antenna used for a reference symbol for sensing before the guard section” and an “antenna used for a data symbol after the guard section” may be configured differently, or suitable control may be performed on each symbol.

This increases the possibility that each symbol will obtain good reception quality.

Note that, the guard section is assumed to be, for example, a time section in which a signal or a symbol is not present.

Further, in a case where the control as described above is not performed, no guard section may be present.

The mapping of reference symbols for sensing is not limited to the examples in FIGS. 39 to 45. For example, a reference symbol for sensing may be mapped, then a data symbol is mapped in the time axis direction, and further thereafter a reference symbol for sensing may be mapped in the time axis direction. That is, a plurality of reference symbols for sensing may be mapped, while a data symbol(s) or the like is/are mapped, in the time axis direction.

Further, a plurality of reference symbols for sensing may be mapped in the frequency direction. A guard section may be present before a reference symbol for sensing. The frame configuration is not limited to the examples in FIGS. 39 to 45. The mapping of the primary channel is not limited to the examples in FIGS. 39 to 45.

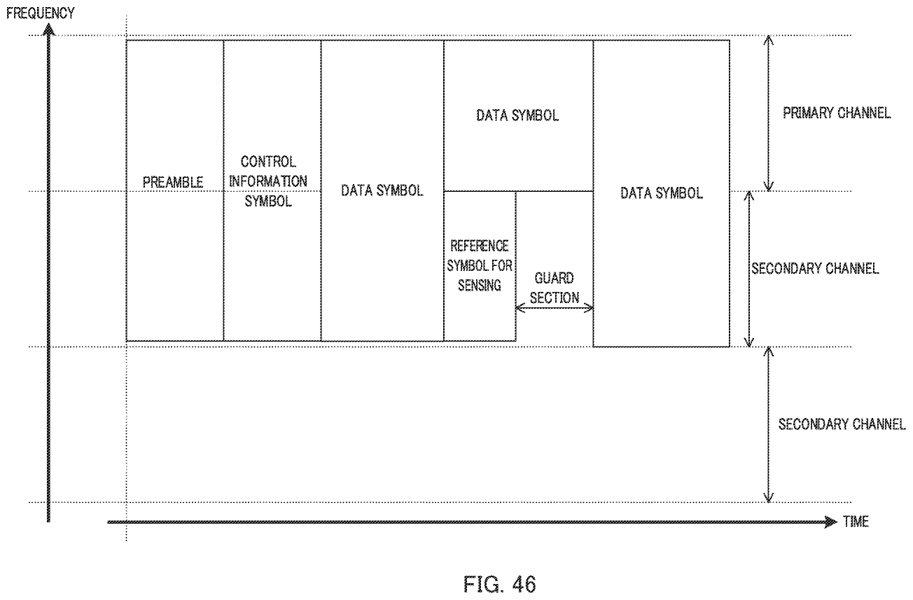

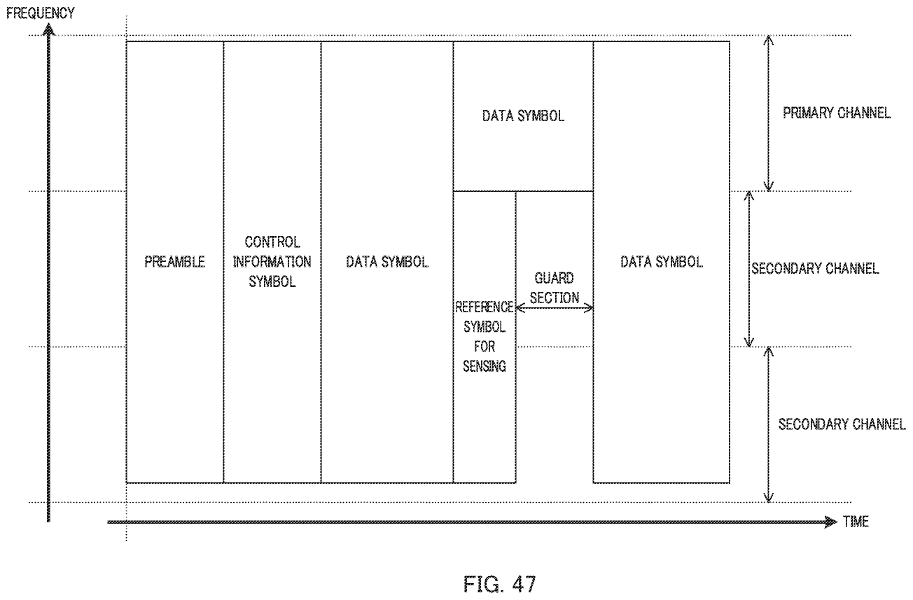

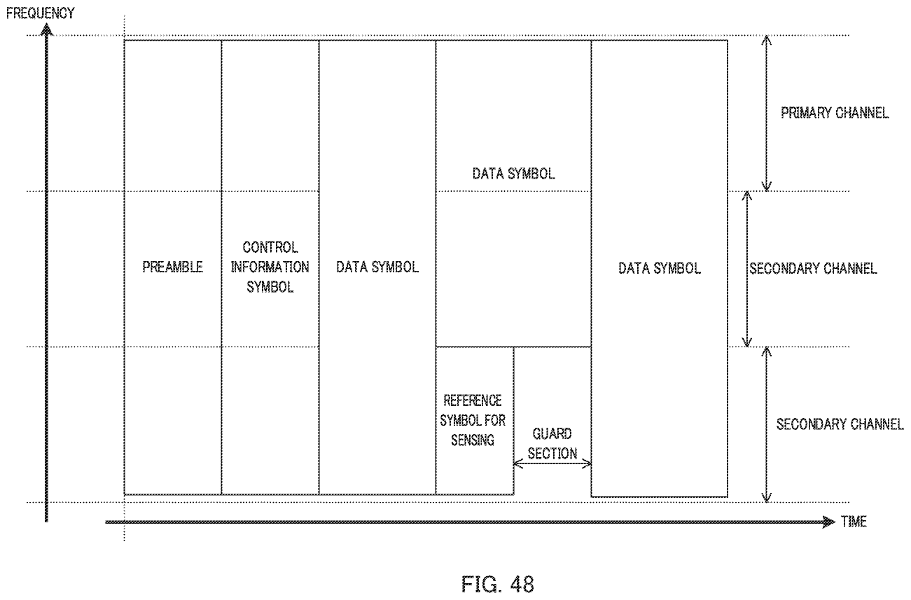

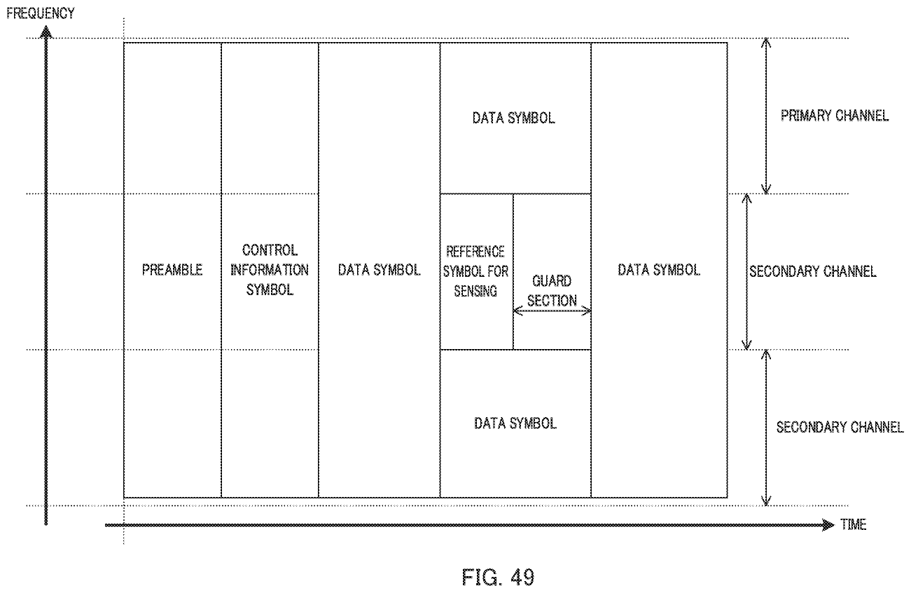

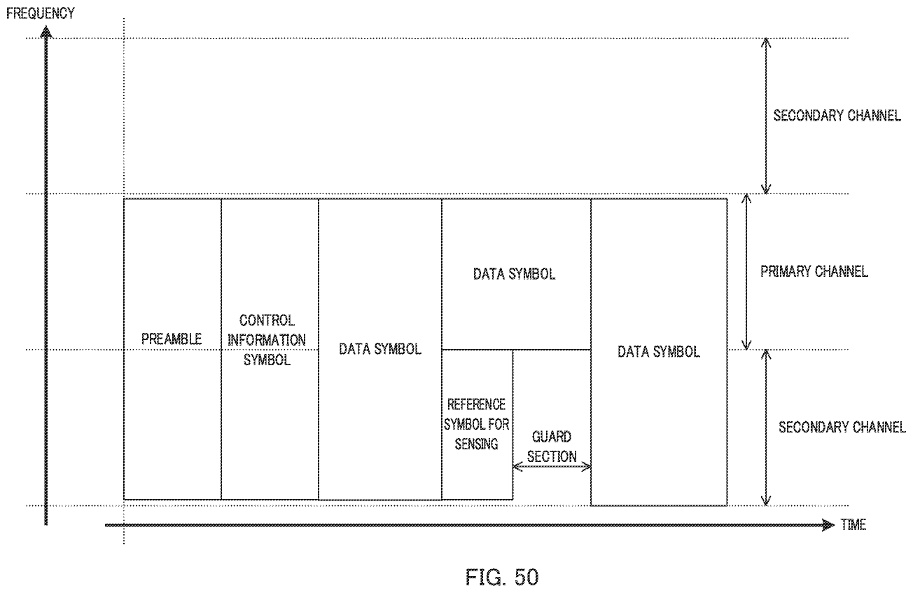

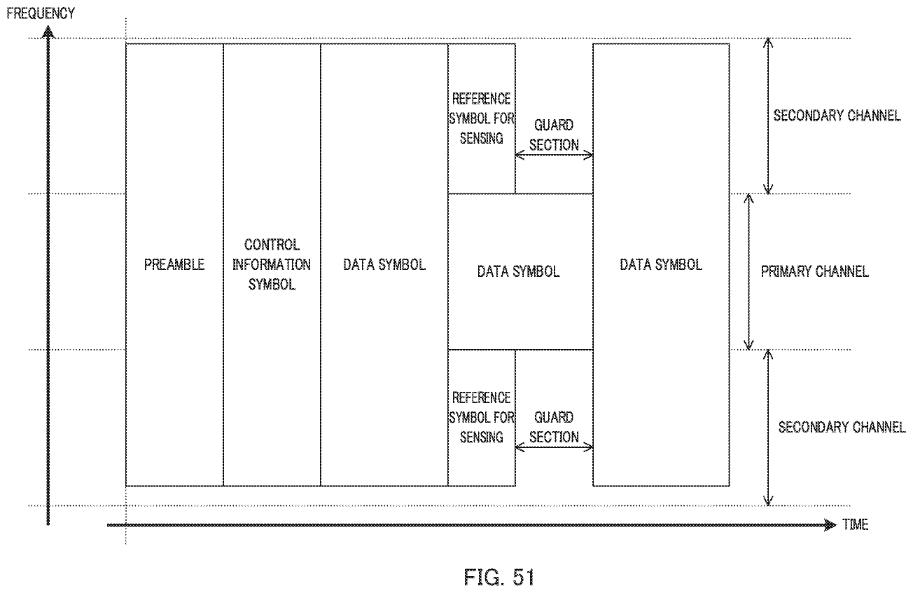

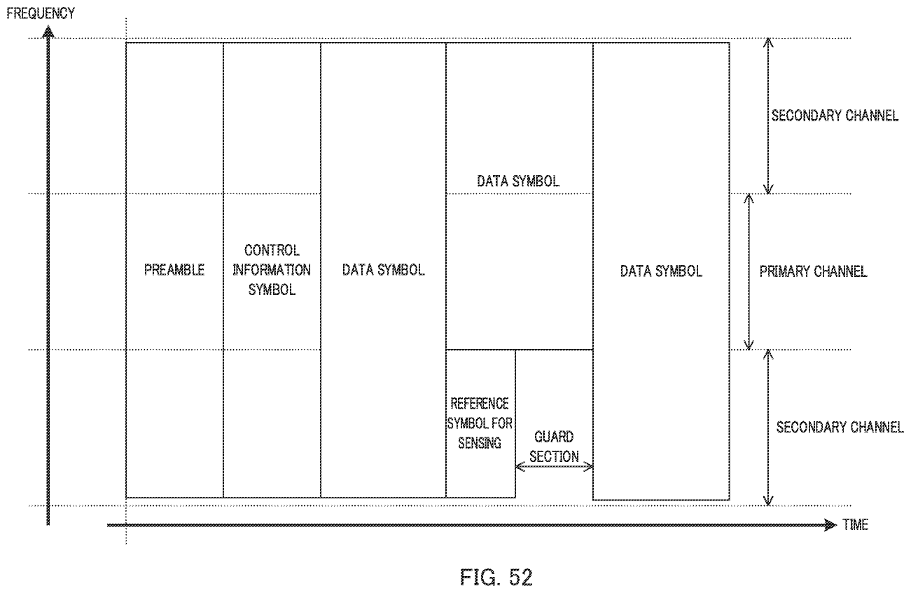

FIGS. 46 to 52 illustrate examples of a configuration of a frame transmitted by an AP or a terminal. FIGS. 46 to 52 illustrate examples of a configuration of a frame in channel bonding. Further, FIGS. 46 to 52 illustrate examples of a configuration of a frame in which a reference symbol for sensing is inserted in the time axis direction. Reference symbols for sensing are mapped in secondary channels.

A guard section is present immediately after a reference signal for sensing. In this case, a “directionality in precoding or beamforming performed on a reference symbol for sensing before the guard section” and “precoding or beamforming performed on a data symbol after the guard section” may be configured differently, or suitable control may be performed on each symbol.

Further, an “antenna used for a reference symbol for sensing before the guard section” and an “antenna used for a data symbol after the guard section” may be configured differently, or suitable control may be performed on each symbol.

This increases the possibility that each symbol will obtain good reception quality.

Note that, the guard section is assumed to be, for example, a time section in which a signal or a symbol is not present.

Further, in a case where the control as described above is not performed, no guard section may be present.

The mapping of reference symbols for sensing is not limited to the examples in FIGS. 46 to 52. For example, a reference symbol for sensing may be mapped, then a data symbol is mapped in the time axis direction, and further thereafter a reference symbol for sensing may be mapped in the time axis direction. That is, a plurality of reference symbols for sensing may be mapped, while a data symbol(s) or the like is/are mapped, in the time axis direction.

Further, a plurality of reference symbols for sensing may be mapped in the frequency direction. A guard section may be present before a reference symbol for sensing. The frame configuration is not limited to the examples in FIGS. 46 to 52. The mapping of the primary channel is not limited to the examples in FIGS. 46 to 52.

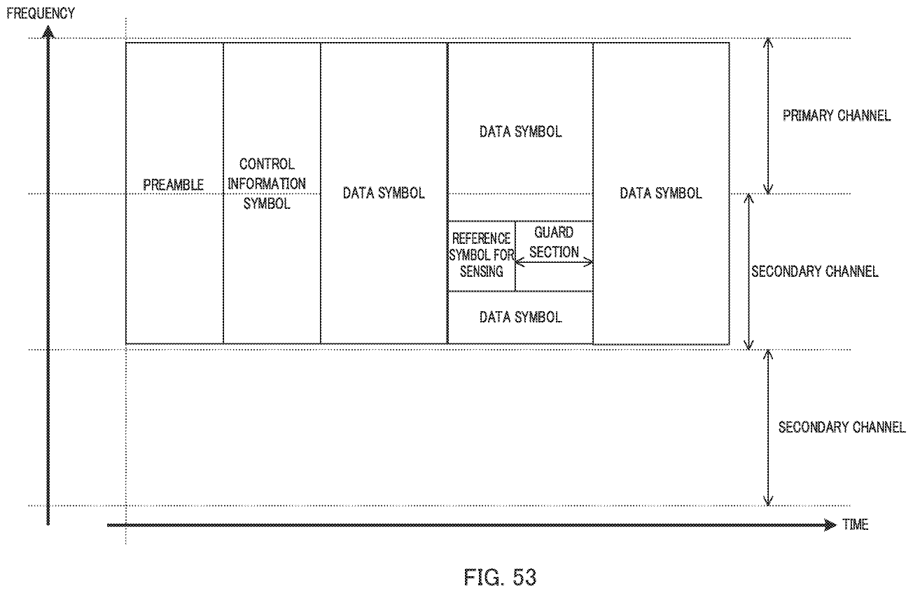

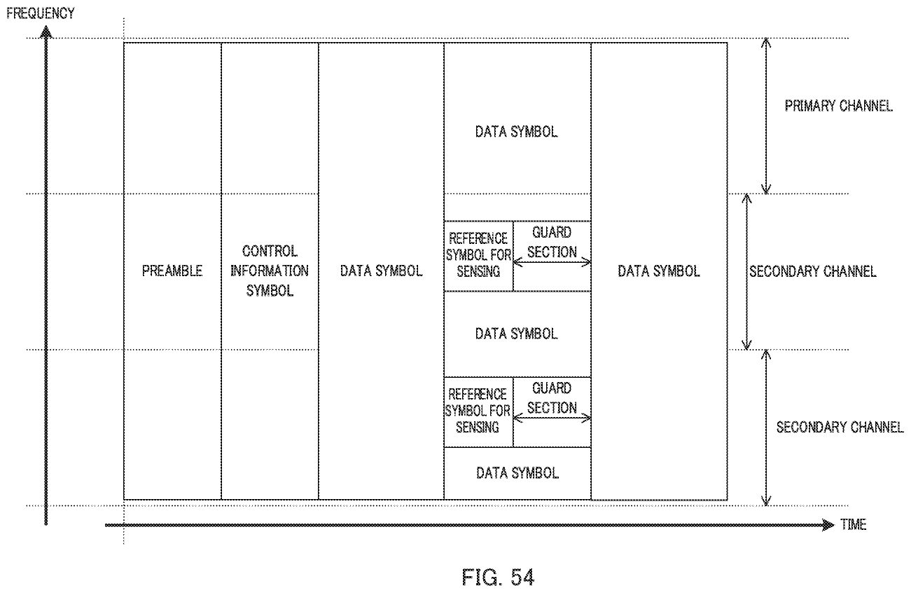

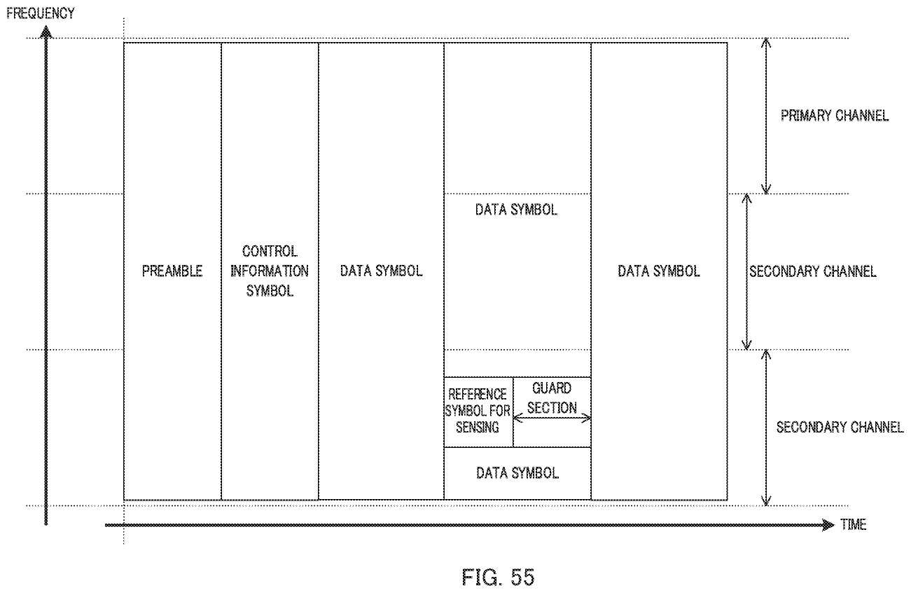

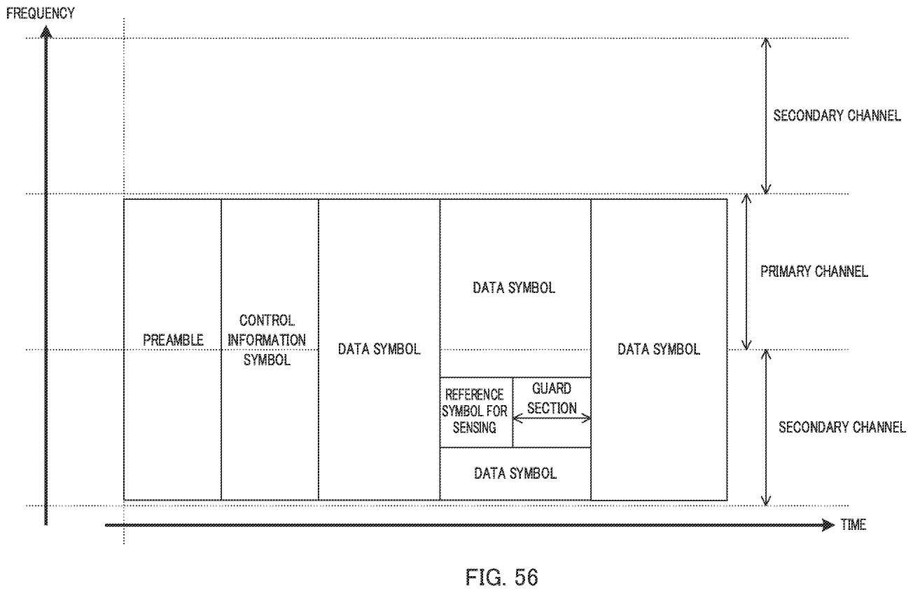

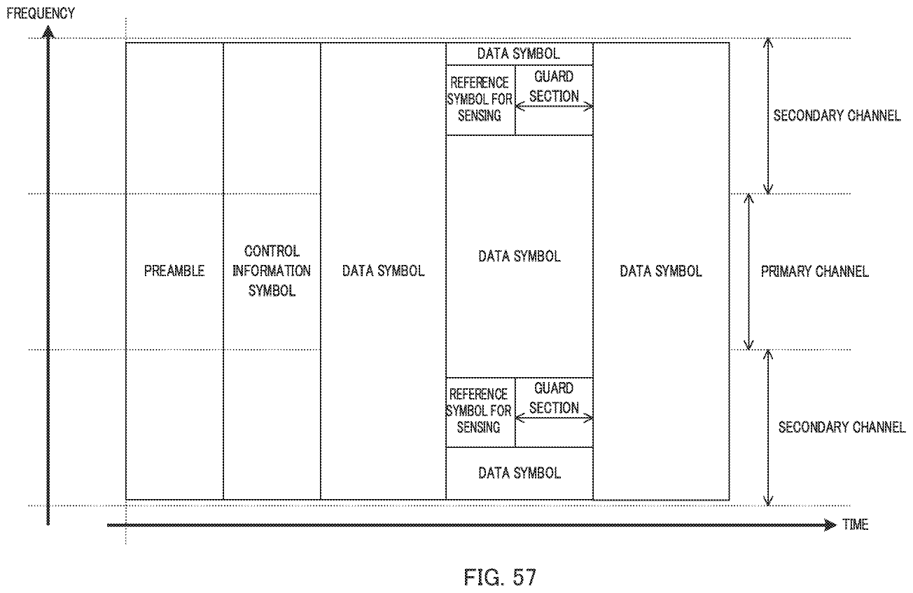

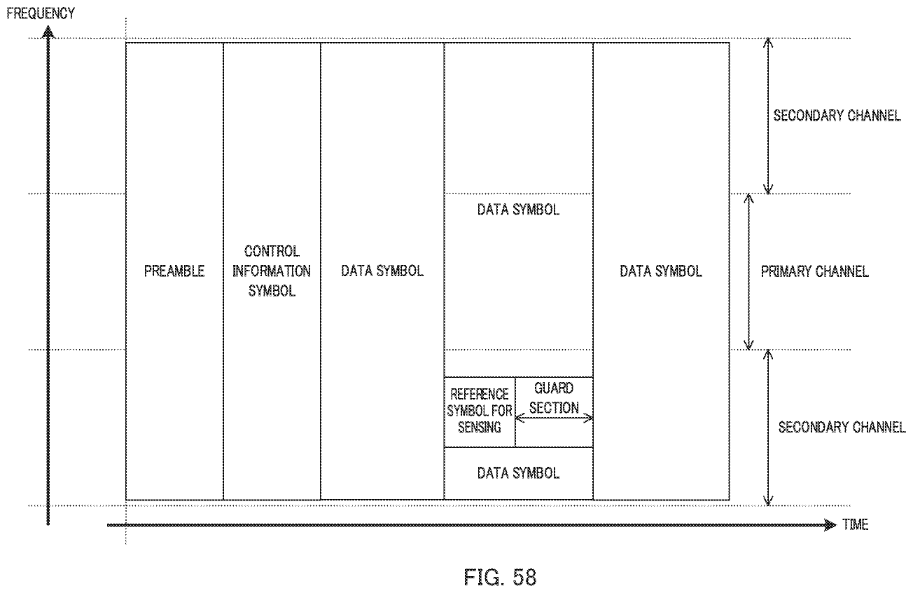

FIGS. 53 to 58 illustrate examples of a configuration of a frame transmitted by an AP or a terminal. FIGS. 53 to 58 illustrate examples of a configuration of a frame in channel bonding. Further, FIGS. 53 to 58 illustrate examples of a configuration of a frame in which a reference symbol for sensing is inserted in the frequency axis direction. Reference symbols for sensing are mapped in secondary channels.

A guard section is present immediately after a reference signal for sensing. In this case, a “directionality in precoding or beamforming performed on a reference symbol for sensing before the guard section” and “precoding or beamforming performed on a data symbol after the guard section” may be configured differently, or suitable control may be performed on each symbol.

Further, an “antenna used for a reference symbol for sensing before the guard section” and an “antenna used for a data symbol after the guard section” may be configured differently, or suitable control may be performed on each symbol.

This increases the possibility that each symbol will obtain good reception quality.

Note that, the guard section is assumed to be, for example, a time section in which a signal or a symbol is not present.

Further, in a case where the control as described above is not performed, no guard section may be present.

The mapping of reference symbols for sensing is not limited to the examples in FIGS. 53 to 58. For example, a reference symbol for sensing may be mapped, then a data symbol is mapped in the time axis direction, and further thereafter a reference symbol for sensing may be mapped in the time axis direction. That is, a plurality of reference symbols for sensing may be mapped, while a data symbol(s) or the like is/are mapped, in the time axis direction.

Further, a plurality of reference symbols for sensing may be mapped in the frequency direction. A guard section may be present before a reference symbol for sensing. The frame configuration is not limited to the examples in FIGS. 53 to 58. The mapping of the primary channel is not limited to the examples in FIGS. 53 to 58.

With the above configuration, communication apparatuses such as an AP and a terminal can transmit a sensing-related signal and a modulated signal for communication in one frame, for example, which makes it possible to perform communication and sensing in parallel. Further, coexistence of a sensing signal and a modulated signal for communication becomes possible, which makes it possible to reduce interference between the sensing signal and the modulated signal for communication. In addition, communication apparatuses such as an AP and a terminal can perform parallel processing of processing for sensing and processing for communication. Further, in a case where a modulated signal for communication in the primary channel is preferentially assigned, it is also possible to obtain the effect that an adverse effect on a terminal that performs communication can be reduced.

With respect to each frame of Embodiment 2, the preamble, the control information symbol, the data symbol, and the reference symbol for sensing have been described, but other symbols or signals may also be present.

Further, symbols other than a data symbol, such as a reference symbol (reference signal), a pilot symbol (pilot signal), or a mid-amble may be included in the area described as the data symbol.

Further, communication apparatuses such as an AP and a terminal may transmit, in addition to the frames described in Embodiment 2, other frames, for example, a medium access control (MAC) management frame, a MAC control frame, a data frame, a frame for sensing, and the like.

In Embodiment 2, a case where reference symbols for sensing are present in secondary channels has been described, but the present disclosure can be implemented even w % ben a reference symbol(s) for sensing is/are present in the primary channel.

### Embodiment 3

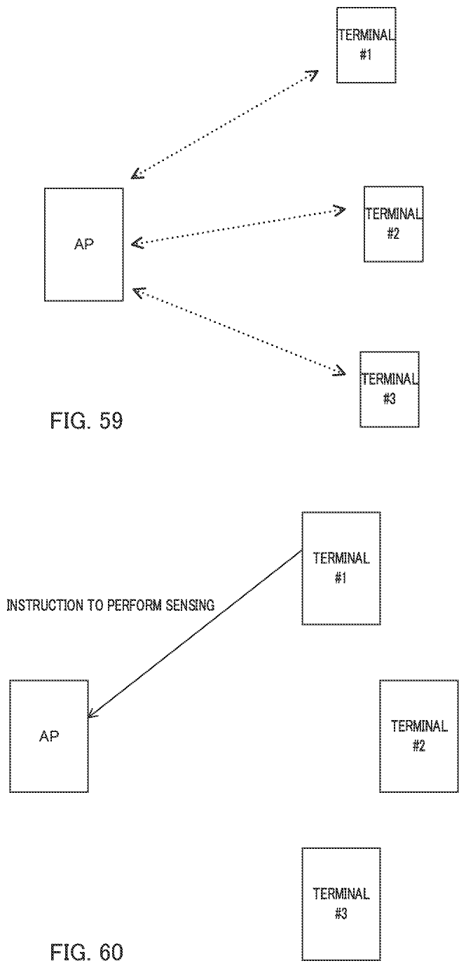

FIG. 59 illustrates an example of a configuration of a communication system according to Embodiment 3. The communication system according to Embodiment 3 assumes, for example, a wireless LAN system. As a matter of course, the communication system may be any other system such as a cellular system.

As illustrated in FIG. 59, the AP perform radio communication with terminals #1, #2, and #3. In the case of the communication system illustrated in FIG. 59, it is assumed, for example, that the AP is fixedly disposed and the terminals move. In this case, when a terminal performs sensing, the estimation accuracy of the sensing may decrease. In Embodiment 3, a system for alleviating the above problem will be described.

FIGS. 60, 61, 62A, and 62B are diagrams provided for describing operation examples of the communication system in FIG. 59. For example, terminal #1 transmits a modulated signal including data including information on an “instruction to perform sensing” to the AP. The AP receives and demodulates the modulated signal transmitted by terminal #1 to receive the notification of the “instruction to perform sensing”.

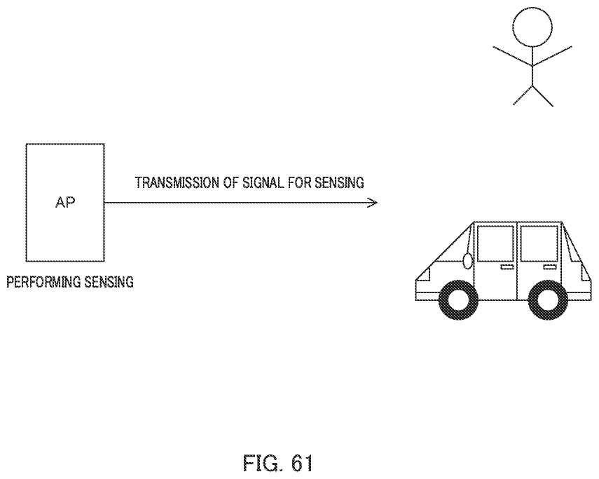

Upon receiving the notification of the “instruction to perform sensing”, the AP transmits, as illustrated in FIG. 61, a signal for sensing (for example, a signal including the reference symbol for sensing described in Embodiment 1 or 2) to perform sensing around. Note that, the examples of the sensing method have been described in Embodiment 1.

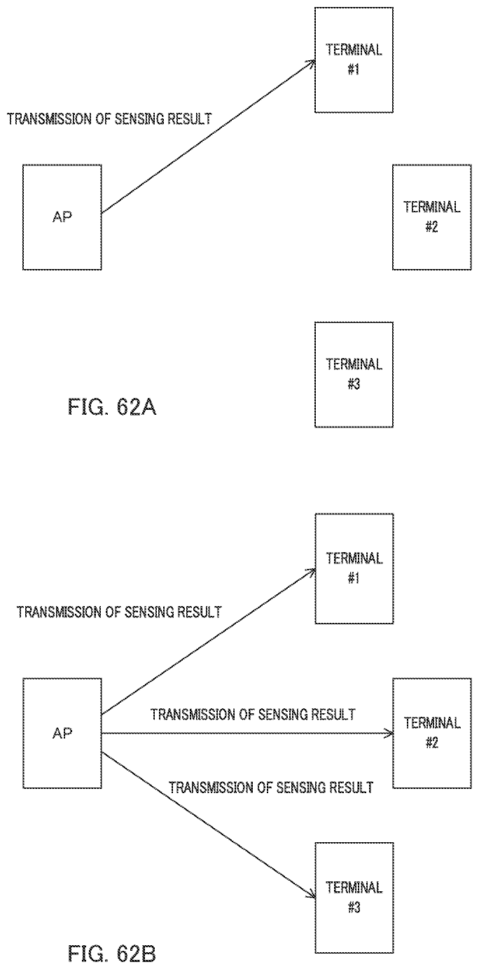

As illustrated in FIG. 62A, the AP may transmit a modulated signal including information on a result obtained by the sensing to terminal #1 that has requested the sensing. Alternatively, as illustrated in FIG. 62B, the AP may transmit modulated signals including information on a result obtained by the sensing to terminals #1 to #3 including terminal #1 that has requested the sensing by multicast, broadcast, or groupcast.

Note that, in each of multicast, broadcast, and groupcast, information is transmitted to one or more terminals or a plurality of terminals. In groupcast, a limitation is imposed on terminals subjected to the casting. This limitation limits terminals subjected to the casting.

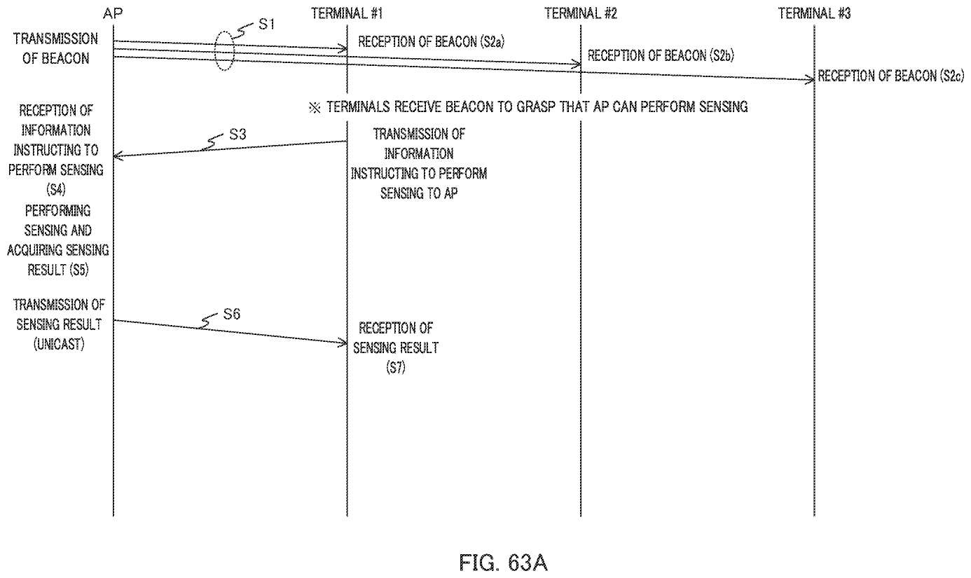

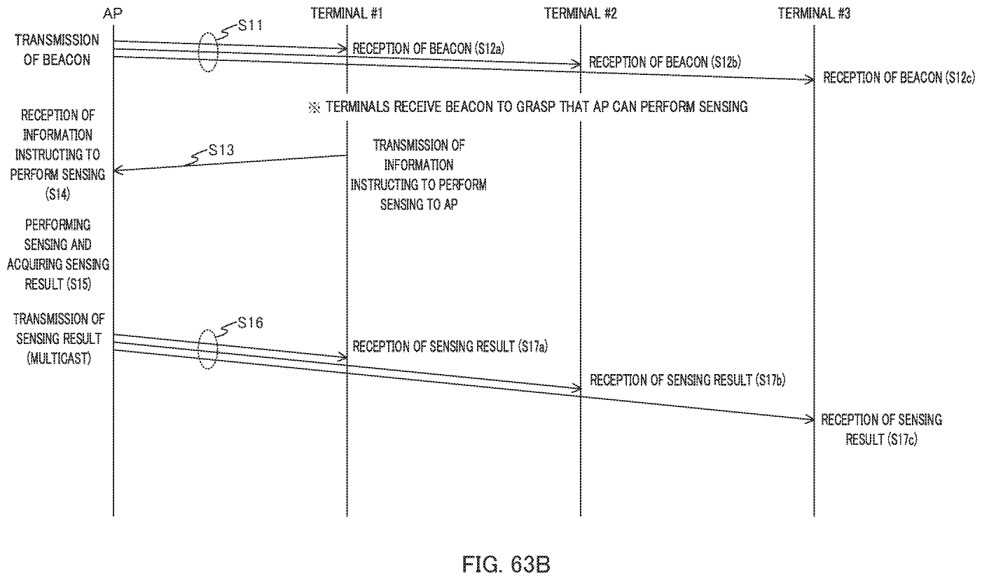

FIG. 63A is a sequence diagram illustrating an operation example of the terminals and the AP in FIG. 62A. As illustrated in FIG. 63A, the AP transmit a beacon (S1). Terminals #1 to #3 receive the beacon transmitted by the AP (S2a to S2c).

In an extended area of the beacon, information indicating that the AP can perform sensing is possible. Terminals #1 to #3 can grasp (recognize) based on the received beacon that the AP can perform sensing.

Among terminals #1 to #3 that have received the beacon, terminal #1 transmits information instructing to perform sensing to the AP (S3). The AP receives the information instructing to perform sensing transmitted by terminal #1 (S4).

The AP performs sensing and acquires a sensing result (S5), and transmits the sensing result to terminal #1 (S6). Terminal #1 receives the sensing result transmitted in S6 (S7).

FIG. 63B is a sequence diagram illustrating an operation example of the terminals and the AP in FIG. 62B. As illustrated in FIG. 63B, the AP transmit a beacon (S11). Terminals #1 to #3 receive the beacon transmitted by the AP (S12a to S12c).

In an extended area of the beacon, information indicating that the AP can perform sensing is possible. Terminals #1 to #3 can grasp (recognize) based on the received beacon that the AP can perform sensing.

Among terminals #1 to #3 that have received the beacon, terminal #1 transmits information instructing to perform sensing to the AP (S13). The AP receives the information instructing to perform sensing transmitted by terminal #1 (S14).

The AP performs sensing and acquires a sensing result (S15), and transmits the sensing result to terminals #1 to #3 (S16). Terminals #1 to #3 receive the sensing result transmitted in S16 (S17a to S17c).

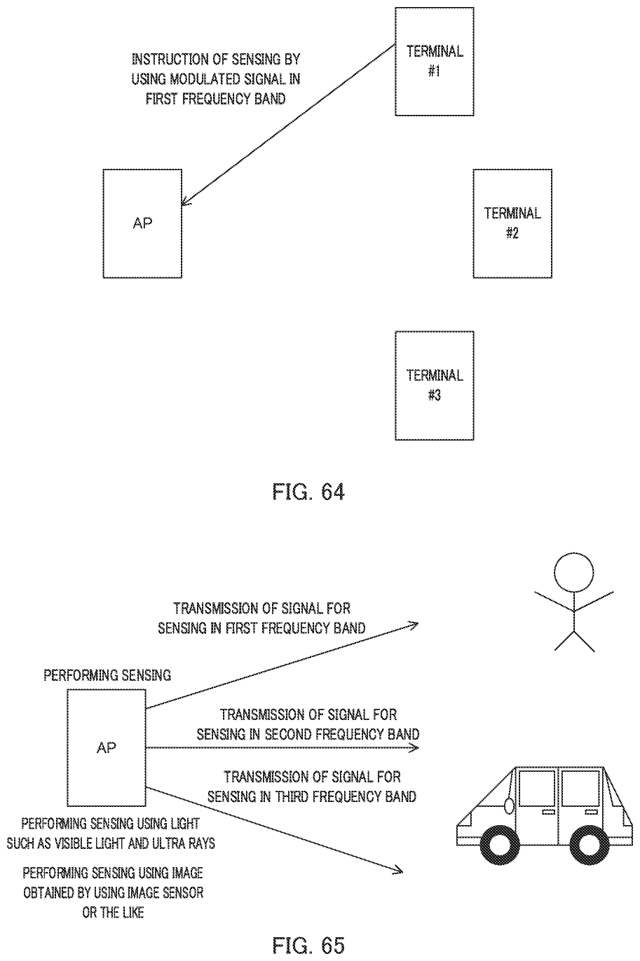

FIGS. 64, 65, 66A, and 66B are diagrams provided for describing other operation examples of the communication system in FIG. 59. For example, terminal #1 transmits a modulated signal including data including information on an “instruction to perform sensing” to the AP by using a first frequency band. The AP receives and demodulates the modulated signal transmitted by terminal #1 to receive the notification of the “instruction to perform sensing”.

Upon receiving the notification of the “instruction to perform sensing”, the AP transmits, as illustrated in FIG. 65, a signal for sensing (for example, a signal including the reference symbol for sensing described in Embodiment 1 or 2) to perform sensing around. Note that, the examples of the sensing method have been described in Embodiment 1.

The AP transmits at least one of signals for sensing in the first frequency band, a second frequency band, and a third frequency band. For example, the AP may transmit one of signals for sensing in the first, second, and third frequency bands. For example, the AP may transmit three signals for sensing in the first, second, and third frequency bands.

Note that, the AP may perform sensing using light such as visible light and infrared rays or may perform sensing using an image obtained by using an image sensor or the like. Further, the AP may also combine sensing using a radio wave, sensing using light, and sensing using an image.

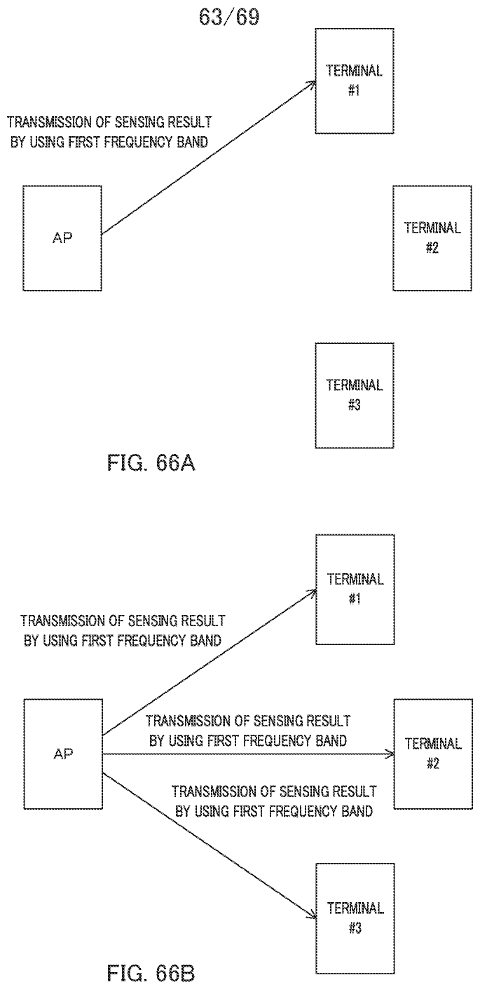

As illustrated in FIG. 66A, the AP may transmit a modulated signal including information on a result obtained by sensing to terminal #1 that has requested the sensing. Alternatively, as illustrated in FIG. 66B, the AP may transmit a modulated signal including information on a result obtained by sensing to terminals #1 to #3 including terminal #1 that has requested the sensing by multicast, broadcast, or groupcast.

In FIGS. 66A and 66B, the AP transmits the modulated signal including information on a result obtained by sensing by using a first frequency band. This is because the request made by terminal #1 to the AP uses the first frequency band. On the other hand, the AP may transmit the modulated signal including information on a result obtained by sensing by using other frequency bands.

With this processing, the AP can perform sensing with higher accuracy, and the terminal(s) can obtain a sensing result with higher accuracy.

### Embodiment 4

The communication system described above can be applied to a cellular system: a terminal makes a request for a frequency resource for sensing to a base station, and the base station transmits a frequency resource, which may be used, to the terminal.

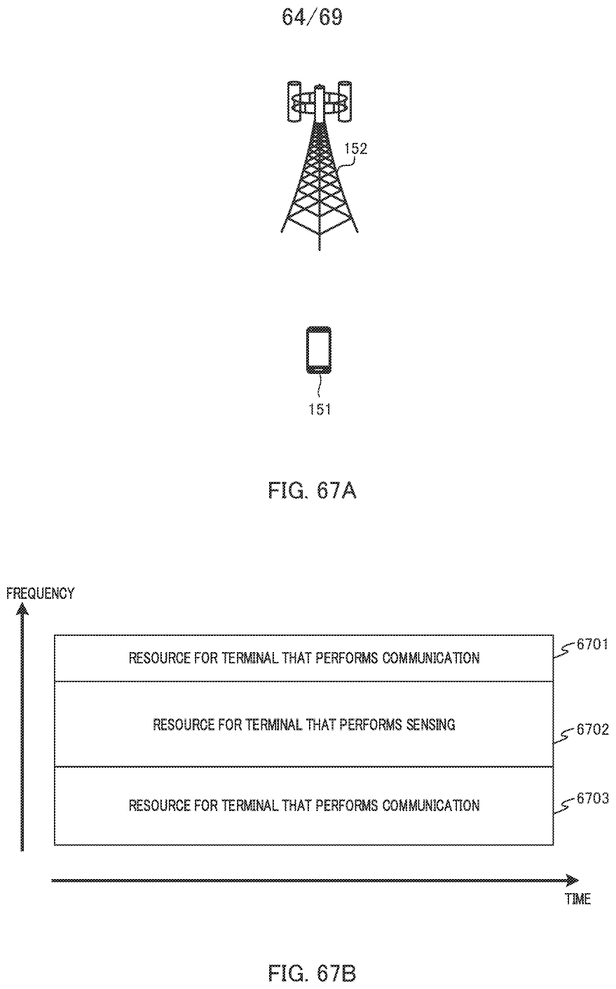

FIG. 67A illustrates an example of a configuration of a communication system according to Embodiment 4. FIG. 67A illustrates terminal 151 and base station 152. Terminal 151 may be, for example, a smart phone, a tablet terminal, or a cellular phone. Base station 152 may be referred to as, for example, a NodeB, an eNodeB (eNB), or a gNodeB (gNB).

Terminal 151 makes a request for a frequency resource for sensing (and a time resource) to base station 152. For example, terminal 151 makes a request for a frequency resource for sensing (and a time resource) to base station 152 by using a PUCCH (Physical Uplink Control Channel).

Upon receiving the request for a frequency resource for sensing from terminal 151, base station 152 transmits information on a frequency resource (and a time resource) allowed to be used for sensing to terminal 151. For example, base station 152 transmits information of a frequency resource (and a time resource) allowed to be used for sensing to terminal 151 by using a PDCCH (Physical Downlink Control Channel).

FIG. 67B illustrates an example of resource allocation of a signal transmitted by a terminal in time-frequency axes. Note that, as described above, the resource allocation in FIG. 67B is performed by base station 152, and base station 152 notifies each terminal of information on the resource allocation. The resource allocation in FIG. 67B is formed of resources 6701 and 6703 for a terminal that performs communication and resource 6702 for a terminal that performs sensing.

For example, resource 6702 for a terminal that performs sensing indicated in FIG. 67B is allocated to terminal 151 for sensing. Note that, carrier aggregation may be applied to frequency resource allocation. Further, a data symbol for performing communication may also be present in resource 6702 for a terminal that performs sensing in FIG. 67B as described in the other embodiments.

Note that, an area (for example, a PUCCH may be used) for notifying base station 152 of information on the frequency band, temporal length, signal type, and the like of a symbol for sensing present in resource 6702 for a terminal that performs sensing may be present, and terminal 151 may transmit a modulated signal including the above area to base station 152.

As another method, base station 152 may transmit the frequency band, temporal length, signal type, and the like of a symbol for sensing present in resource 6702 for a terminal that performs sensing to terminal 151. At this time, base station 152 may transmit these pieces of information to terminal 151 by using a PDCCH, for example. Note that, the base station may transmit these pieces of information to terminal 151 by using an area other than a PDCCH.

With the above configuration, the sensing of the present disclosure can also be applied to a cellular system.

### Embodiment 5

First, a problem in the present embodiment will be described.

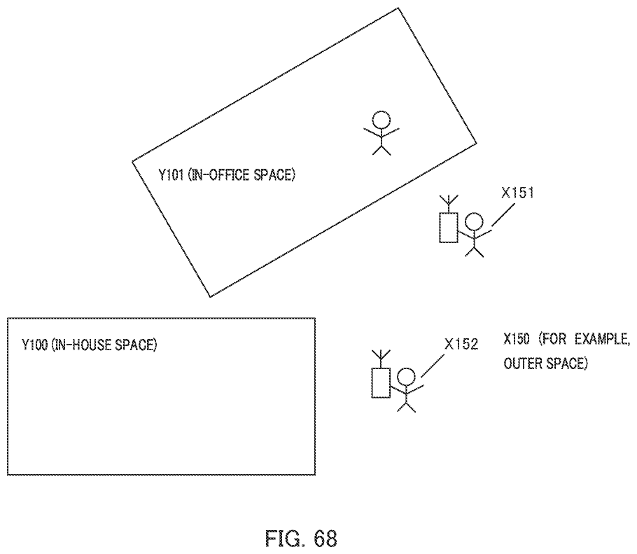

FIG. 68 illustrates an example of sensing. It is assumed that there is no person in in-house space Y100. It is assumed, on the other hand, that there is one person in in-office space Y101.

Further, it is assumed, for example, that in outer space X150, there are persons X151 and X152 each holding a device capable of performing at least sensing.

At this time, it is assumed that person X151 has been able to perform sensing of in-office space Y101 by using the device. Then, person X151 can know that there is one person in in-office space Y101.

Further, it is assumed that person X152 has been able to perform sensing of in-house space Y100 by using the device. Then, person X152 can know that there is no person in in-house space Y100.

In addition, it is assumed that the person in in-office space Y101 has been able to perform sensing of in-house space Y100 by using a device. Then, the person in in-office space Y101 can know that there is no person in in-house space Y100.

Thus, when devices capable of performing sensing perform sensing endlessly, there will be a situation in which information on the privacy of persons can be easily obtained. Accordingly, introduction of technology for protecting privacy is desired.

Embodiment 5 discloses a method of protecting the privacy of persons.

Hereinafter, an example of a low-frequency band such as a 2.4 GHz band and a 5 GHz band (note that, the frequency band is not limited to this example) and an example of a high-frequency band such as a 60 GHz band (note that, the frequency band is not limited to this example) will be described.

Example of High-Frequency Band Such as 60 GHz Band:

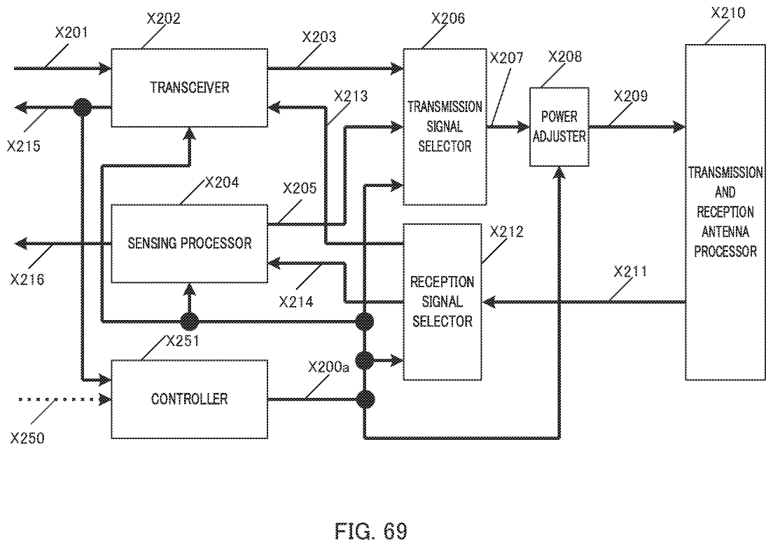

FIG. 69 illustrates an example of a configuration of an apparatus having a communication function and a sensing function according to Embodiment 5.

Transceiver X202 inputs data X201 and control signal X200a. Then, in a case where control signal X200a indicates that “communication is performed”, transceiver X202 performs processing including error correction coding, modulation, and the like on data X201, and outputs modulated signal X203. Note that, in a case where control signal X200a indicates that “sensing is performed”, transceiver X202 does not operate.

Sensing processor X204 inputs control signal X200a. In a case where control signal X200a indicates that “sensing is performed”, sensing processor X204 outputs signal X205 for sensing. Note that, in a case where control signal X200a indicates that “communication is performed”, sensing processor X204 does not operate, for example.

Transmission signal selector X206 inputs control signal X200a, modulated signal X203, and signal X205 for sensing. Then, in a case where control signal X200a indicates that “communication is performed”, transmission signal selector X206 outputs modulated signal X203 as selected signal X207.

Further, in a case where control signal X200a indicates that “sensing is performed”, transmission signal selector X206 outputs signal X205 for sensing as selected signal X207.

Power adjuster X208 inputs selected signal X207 and control signal X200a. In a case where control signal X200a indicates that “communication is performed”, power adjuster X208 performs power adjustment for communication on selected signal X207 (for example, a coefficient by which selected signal X207 is multiplied is a), and outputs transmission signal X209.

Further, in a case where control signal X200a indicates that “sensing is performed”, power adjuster X208 performs power adjustment for communication on selected signal X207 (for example, a coefficient by which selected signal X207 is multiplied is 0), and outputs transmission signal X209.

Note that, α and β are assumed to be real numbers larger than or equal to 0, for example, where α>β (α is larger than β). In this way, it is possible to obtain the effects that transmission power at the time of sensing can be reduced, which makes sensing through walls or the like difficult, increases the possibility that privacy can be ensured, and further enables high data reception quality to be obtained at the time of communication.

Further, α and β may be complex numbers, where |α|>|β|. Even in this case, it is possible to obtain the effects that transmission power at the time of sensing can be reduced, which makes sensing through walls or the like difficult, increases the possibility that privacy can be ensured, and further enables high data reception quality to be obtained at the time of communication. Then, transmission signal X209 is outputted as a radio wave from transmission and reception antenna processor X210.

Transmission and reception antenna processor X210 outputs reception signal X211. Reception signal selector X212 inputs control signal X200a and reception signal X211. In a case where control signal X200a indicates that “communication is performed”, reception signal selector X212 outputs reception signal X211 as signal X213.

Further, in a case where control signal X200a indicates that “sensing is performed”, reception signal selector X212 outputs reception signal X211 as signal X214.

Transceiver X202 inputs control signal X200a and signal X213. In a case where control signal X200a indicates that “communication is performed”, transceiver X202 performs processing including demodulation, error correction decoding, and the like on signal X213, and outputs reception data X215.

Sensing processor X204 inputs control signal X200a and signal X214. In a case where control signal X200a indicates that “sensing is performed”, sensing processor X204 performs sensing by using signal X214 or the like, and outputs sensing result X216. Controller X251 generates and outputs control signal X200a based on external signal X250, reception data X215, and the like.

Thus, it is possible to obtain the effect that sensing in consideration of the privacy of persons can be performed.

Example of Low-Frequency Band Such as 2.4 GHz Band and 5 GHz Band:

As described with reference to FIG. 69, the effects as described above can be obtained even when an apparatus having both a communication function and a sensing function is configured to change between transmission power “at the time of communication” and transmission power “at the time of sensing”. However, since the frequency is low, the distance attenuation of radio waves may be insufficient and protection of the privacy of persons may be insufficient.

For example, it is assumed that an AP is installed in in-house space Y100 in FIG. 68.

At this time, the AP transmits a beacon as described in the other embodiments. FIG. 16 has been indicated as a configuration example of the beacon.

It is assumed that the extended area of the beacon in FIG. 16 is provided with a “sensing allowed/not allowed” area (field). For example, it is assumed that the “sensing allowed/not allowed” area (field) is Z0. Then, Z0 is configured to “1” in a case where sensing is allowed, whereas Z0 is configured to “0” in a case where sensing is not allowed.

It is assumed that the AP installed in in-house space Y100 in FIG. 68 transmits a beacon in which Z0 is configured to “0”. At this time, it is assumed that a terminal owned by person X152 receives the beacon. Note that, the configuration of the terminal owned by person X152 is assumed to be as in FIG. 69.

Then, transceiver X202 in FIG. 69 demodulates the beacon to obtain Z0 as “0”. Controller X251 outputs, based on information included in reception data X215 in which Z0 is “0”, control signal X200a including information that sensing is not allowed.

Sensing processor X204 stops sensing-related transmission and reception operations based on the information in control signal X200a that sensing is not allowed.

Thus, it is possible to obtain the effect that the privacy of in-house space Y100 can be ensured.

The AP installed in in-house space 100 in FIG. 68 may be configured to allow sensing by a terminal. For example, it is assumed that the AP installed in in-house space 100 in FIG. 68 transmits a beacon in which Z0 is configured to “1”. At this time, it is assumed that the terminal owned by person X152 receives the beacon.

Then, transceiver X202 of the terminal having the configuration in FIG. 69 demodulates the beacon to obtain Z0 as “1”. Then, transceiver X202 outputs reception data X215 including the above information. Controller X251 outputs, based on the information included in reception data X215 in which Z0 is “1”, control signal X200a including information that sensing is allowed.

Sensing processor X204 is in a state of being capable of performing sensing-related transmission and reception operations based on the information in control signal X200a that sensing is allowed.

As another state, it is assumed that no AP is installed in-house space 100 in FIG. 68. At this time, the terminal owned by person X152 cannot receive a beacon.

At this time, controller X251 cannot obtain information on Z0. Accordingly, controller X251 performs one of the following cases:

Case 1:

It is assumed that in a case where information on Z0 cannot be obtained, controller X251 outputs control signal X200a including information that sensing is allowed. Accordingly, sensing processor X204 is in a state of being capable of performing sensing-related transmission and reception operations based on the information in control signal X200a that sensing is allowed.

Case 2:

It is assumed that in a case where information on Z0 cannot be obtained, controller X251 outputs control signal X200a including information that sensing is not allowed. Accordingly, sensing processor X204 stops sensing-related transmission and reception operations based on the information in control signal X200a that sensing is not allowed.

Note that, although the beacon has been exemplified above, the frame in which the AP transmits “sensing allowed/not allowed” area (field) Z0 is not limited to the beacon.

Next, another exemplary embodiment will be described. For example, a case where there are a first AP in in-house space Y100, a second AP and a third AP in in-office space Y101, and further a fourth AP in FIG. 68 and a terminal owned by person X152 can receive beacons from these four APs will be described as an example. Note that, the beacon transmitted by the first AP is referred to as “first beacon”, the beacon transmitted by the second AP is referred to as “second beacon”, the beacon transmitted by the third AP is referred to as “third beacon”, and the beacon transmitted by the fourth AP is referred to as “fourth beacon”.

At this time, the first AP transmits a beacon as described in the other embodiments. It is assumed that the extended area of the beacon in FIG. 16 is provided with a “sensing allowed/not allowed” area (field). For example, it is assumed that the “sensing allowed/not allowed” area (field) is Z10. Then, Z10 is configured to “1” in a case where sensing is allowed, whereas Z10 is configured to “0” in a case where sensing is not allowed.

The second AP transmits a beacon as described in the other embodiments. It is assumed that the extended area of the beacon in FIG. 16 is provided with a “sensing allowed/not allowed” area (field). For example, it is assumed that the “sensing allowed/not allowed” area (field) is Z20. Then, Z20 is configured to “1” in a case where sensing is allowed, whereas Z20 is configured to “0” in a case where sensing is not allowed.

The third AP transmits a beacon as described in the other embodiments. It is assumed that the extended area of the beacon in FIG. 16 is provided with a “sensing allowed/not allowed” area (field). For example, it is assumed that the “sensing allowed/not allowed” area (field) is Z30. Then, Z30 is configured to “1” in a case where sensing is allowed, whereas Z30 is configured to “0” in a case where sensing is not allowed.

The fourth AP transmits a beacon as described in the other embodiments. It is assumed that the extended area of the beacon in FIG. 16 is provided with a “sensing allowed/not allowed” area (field). For example, it is assumed that the “sensing allowed/not allowed” area (field) is Z40. Then, Z40 is configured to “1” in a case where sensing is allowed, whereas Z40 is configured to “0” in a case where sensing is not allowed.

Then, transceiver X202 of the terminal having the configuration in FIG. 69 obtains the first, second, third, and fourth beacons. For example, transceiver X202 demodulates the first beacon to obtain Z10 as “1”. Then, transceiver X202 demodulates the second beacon to obtain Z20 as “1”. Transceiver X202 demodulates the third beacon to obtain Z30 as “1”. Transceiver X202 demodulates the fourth beacon to obtain Z40 as “1”. Then, transceiver X202 outputs reception data X215 including these pieces of information.

Controller X251 determines based on “information on Z10 as ‘1’”, “information on Z20 as ‘1’”, “information on Z30 as ‘1’”, and “information on Z40 as ‘1’” included in reception data X215 that sensing is allowed, and outputs control signal X200a including information that sensing is allowed.

Sensing processor X204 is in a state of being capable of performing sensing-related transmission and reception operations based on the information in control signal X200a that sensing is allowed.

It is assumed that controller X251 operates, for example, as follows. Controller X251 obtains a plurality of beacons from the plurality of APs. At this time, in a case where all the beacons allow sensing, it is assumed that controller X251 outputs control signal X200a including informational that sensing is allowed.

However, the method of determining that sensing is allowed is not limited to the examples described above. For example, a threshold value may be provided for the reception electric field strength (for example, a received signal strength indicator (RRSI)), and only information on a beacon larger than or equal to the threshold value may be determined as valid and determination of sensing control may be performed.

Further, the terminal may perform transmission power control (change transmission power) for a signal for sensing in accordance with the reception electric field strength (for example, RRSI).

Note that, although the beacon has been exemplified above, the frame in which the AP transmits the “sensing allowed/not allowed” area (field) is not limited to the beacon.

Thus, it is possible to obtain the effect that sensing in consideration of the privacy of persons can be performed.

Still another exemplary embodiment will be described. For example, a case where there are a first AP in in-house space Y100, a second AP and a third AP in in-office space Y101, and further a fourth AP in FIG. 68 and a terminal owned by person X152 can receive beacons from these four APs will be described as an example. Note that, the beacon transmitted by the first AP is referred to as “first beacon”, the beacon transmitted by the second AP is referred to as “second beacon”, the beacon transmitted by the third AP is referred to as “third beacon”, and the beacon transmitted by the fourth AP is referred to as “fourth beacon”.

At this time, it is assumed that the terminal having the configuration in FIG. 69 has obtained one of the first, second, third, and fourth beacons.

Controller X251 outputs, based on information on the one beacon in reception data X215, control signal X200a including information that sensing is not allowed.

Then, sensing processor X204 stops sensing-related transmission and reception operations based on the information in control signal X200a that sensing is not allowed.

It is assumed, on the other hand, that the terminal having the configuration in FIG. 69 has not been able to obtain any of the first, second, third, and fourth beacons.

At this time, controller X251 outputs control signal X200a including information that sensing is allowed.

Then, sensing processor X204 is in a state of being capable of performing sensing-related transmission and reception operations based on the information in control signal X200a that sensing is allowed.

Note that, the operation examples are not limited to those described above. For example, a threshold value may be provided for the reception electric field strength (for example, RRSI), and controller X251 may output control signal X200a including information that sensing is not allowed when a beacon larger than or equal to the threshold value is obtained. Further, controller X251 may output control signal X200a including information that sensing is allowed when a beacon less than the threshold value (or less than or equal to the threshold value) is obtained.

Further, the terminal may perform transmission power control (change transmission power) for a signal for sensing in accordance with the reception electric field strength (for example, RRSI).

Thus, it is possible to obtain the effect that sensing in consideration of the privacy of persons can be performed.

Still another exemplary embodiment will be described.

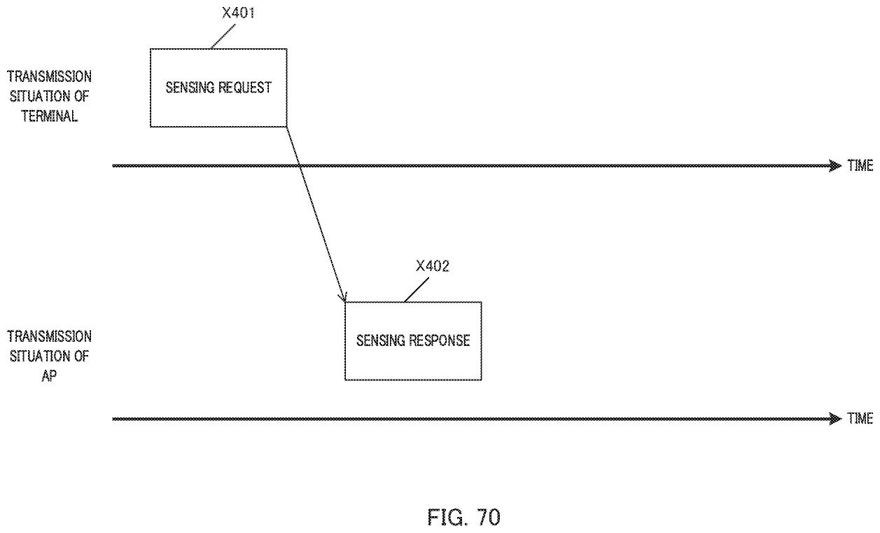

FIG. 70 illustrates an example of a transmission situation of a terminal and a transmission situation of an AP. The horizontal axis is assumed to indicate time.

First, the terminal having the configuration in FIG. 69 transmits sensing request X401 to ask “whether sensing may be performed or not”. The AP that has received this signal transmits sensing response X402 including information on one of “sensing allowed/not allowed”.

Then, the terminal receives sensing response X402 from the AP. Controller X251 of the terminal determines whether sensing is allowed or not allowed, based on the information included in sensing response X402 included in reception data X215.

In a case where controller X251 determines that sensing is not allowed, controller X251 outputs control signal X200a including information that sensing is not allowed. Then, sensing processor X204 stops sensing-related transmission and reception operations based on the information in control signal X200a that sensing is not allowed.

In a case where controller X251 determines that sensing is allowed, controller X251 outputs control signal X200a including information that sensing is allowed. Then, sensing processor X204 is in a state of being capable of performing sensing-related transmission and reception operations based on the information in control signal X200a that sensing is allowed.

There may be a case where the terminal having the configuration in FIG. 69 has transmitted sensing request X401, but does not receive a response from the AP.

In this case, the terminal may determine that sensing is allowed or may determine that sensing is not allowed. Sensing processor X204 controls transmission and reception operations based on the determination.

Note that, sensing request X401 may include address information (for example, the media access control (MAC) address of the AP serving as the address) and terminal information (for example, the MAC address of the terminal (itself)), and further may also include other information. Further, sensing request X401 may also include a pilot symbol, a pilot signal, a reference symbol, a reference signal, a preamble, and/or the like for demodulation, or may also include other signals and symbols.

Then, sensing response X402 may include address information (for example, the MAC address of the terminal serving as the address) and AP information (for example, the MAC address of the AP (itself), the service set identifier (SSID) of the AP (itself), or the like), and further may include other information. Further, sensing response X402 may also include a pilot symbol, a pilot signal, a reference symbol, a reference signal, a preamble, and/or the like for demodulation, and may also include other signals and symbols.

For example, sensing response X402 may also include information on transmission power of the terminal when transmitting a sensing signal. At this time, power controller X208 in the terminal controls the transmission power for a sensing signal based on the information in sensing response X402.

Further, sensing response X402 may also include information on a time interval at which a sensing signal may be transmitted. It is assumed that a terminal and an AP communicate with each other and the terminal starts sensing as in FIG. 70. At this time, when the terminal continues to perform sensing, the terminal may be able to perform line signaling even at a place where a privacy problem arises.

It is assumed that sensing response X402 includes “information on a time section in which a sensing signal may be transmitted”. Controller X251 of the terminal having the configuration in FIG. 69 obtains information included in sensing response X402 included in reception data X215 to obtain the “information on a time section in which a sensing signal may be transmitted”. Then, controller X251 outputs, based on the information, control signal X200a including the information of the time section for performing sensing operation. Sensing processor X204 inputs control signal X200a, and controls the time for performing transmission processing and reception processing for sensing based on the information on the time for performing sensing operation included in control signal X200a.

Thus, it is possible to obtain the effect that sensing in consideration of the privacy of persons can be performed.

Note that, although the term “sensing processor” is used in FIG. 69, sensing processor X204 is a processor that generates a signal for sensing to be transmitted and performs processing for generating a sensing result, and can be considered to be a signal processor for sensing.

Although the embodiments have been described thus far, the embodiments may be combined. Further, the embodiments may also be combined with supplements described below.

The configurations of the AP and the terminal are not limited to those in FIGS. 1, 2, and 3. The AP and the terminal may be configured to include one or more transmission antennas or a plurality of transmission antennas in each frequency band and to generate and transmit one or more modulated signals or a plurality of modulated signals and one or more signals for sensing or a plurality of signals for sensing in each frequency band, and/or may be configured to include one or more reception antennas or a plurality of reception antennas in each frequency band and to receive signals of each frequency band. A transmission antenna and a reception antenna may be configured as an antenna for both transmission and reception.

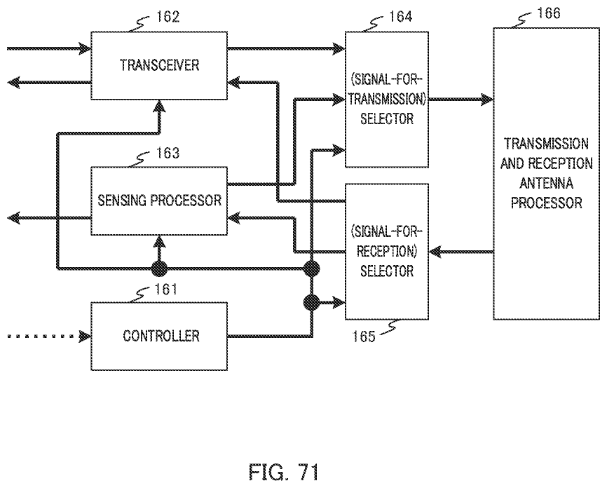

FIG. 71 illustrates an example of a configuration of an apparatus including an antenna for both transmission and reception, such as an AP and a terminal. Transceiver 162 outputs a transmission signal to selector 164. Transceiver 162 inputs a reception signal outputted from selector 165.

Sensing processor 163 outputs a sensing signal to selector 164. Sensing processor 163 inputs a sensing reception signal (for example, a signal of a reflected wave) outputted from selector 165. Sensing processor 163 may have a function of an estimator and perform sensing of an object based on a sensing reception signal.

Selector 164 outputs a transmission signal outputted from transceiver 162 to transmission and reception antenna processor 166 in accordance with control of controller 161. Further, selector 164 outputs a sensing signal outputted from sensing processor 163 to transmission and reception antenna processor 166 in accordance with control of controller 161.

Selector 165 outputs a reception signal outputted from selector 165 to transceiver 162 in accordance with control of controller 161. Further, selector 165 outputs a sensing reception signal outputted from selector 165 to sensing processor 163 in accordance with control of controller 161.

Controller 161 controls selectors 164 and 165 based on transmission timings of a transmission signal and a sensing signal and reception timings of a reception signal and a sensing reception signal. Controller 161 temporally switches between using an antenna(s) of transmission and reception antenna processor 166 for transmission and for reception. Transmission and reception antenna processor 166 includes one antenna or two or more antennas.

The embodiments are merely exemplary. For example, even when “a modulation scheme, an error correction coding scheme (error correction code, code length, coding rate, and the like to be used), control information, and the like” are exemplified, the present disclosure can be implemented with the same configuration even in a case where other “modulation scheme, error correction coding scheme (error correction code, code length, coding rate, and the like to be used), control information, and the like” are applied.

Regarding the modulation scheme, the embodiments and other contents described herein can be implemented even when a modulation scheme other than the modulation scheme described herein is used. For example, amplitude phase shift keying (APSK) (for example, 16APSK, 64APSK, 128APSK, 256APSK, 1024APSK, 4096APSK, and the like), pulse amplitude modulation (PAM) (for example, 4PAM, 8PAM, 16PAM, 64PAM, 128PAM, 256PAM, 1024PAM, 4096PAM, and the like), phase shift keying (PSK) (for example, BPSK, QPSK, 8PSK, 16PSK, 64PSK, 128PSK, 256PSK, 1024PSK, 4096PSK, and the like), quadrature amplitude modulation (QAM) (for example, 4QAM, 8QAM, 16QAM, 64QAM, 128QAM, 256QAM, 1024QAM, 4096QAM, and the like), or the like may be applied, or uniform mapping or non-uniform mapping may be performed in each modulation scheme.

Further, the method of mapping 2, 4, 8, 16, 64, 128, 256, 1024, and the like of signal points on an I(in-phase)-Q(quadrature) plane (a modulation scheme including 2, 4, 8, 16, 64, 128, 256, 1024, and the like of signal points) is not limited to the signal point mapping method of the modulation scheme described herein.

It can be considered that the device including the transmission apparatus, the reception apparatus, the communication apparatus, the sensing apparatus, and the apparatus having a sensing function and a communication function herein is a communication and broadcast device such as a broadcast station, a base station, an access point, a terminal, and a mobile phone, or a device such as a television, a radio, a personal computer, an eNB (eNodeB), a gNB (gNodeB), a repeater, a server, a home electric appliance, a smart phone, a tablet, a vehicle, an automobile, a ship, an airplane, a drone, a satellite, an electric bicycle, an electric bike, an electric kickboard, an electric kick scooter, a bicycle, a bike, a motorcycle, a kickboard, and a kick scooter. Thus, the processor described as the AP herein can be applied to “a communication and broadcast device such as a broadcast station, a base station, an access point, a terminal, and a mobile phone, or a device such as a television, a radio, a personal computer, an eNB (eNodeB), a gNB (gNodeB), a repeater, a server, a home electric appliance, a smart phone, a tablet, a vehicle, an automobile, a ship, an airplane, a drone, a satellite, an electric bicycle, an electric bike, an electric kickboard, an electric kick scooter, a bicycle, a bike, a motorcycle, a kickboard, and a kick scooter”. Further, the processor described as the terminal herein can be applied to “a communication and broadcast device such as a broadcast station, a base station, an access point, a terminal, and a mobile phone, or a device such as a television, a radio, a personal computer, an eNB (eNodeB), a gNB (gNodeB), a repeater, a server, a home electric appliance, a smart phone, a tablet, a vehicle, an automobile, a ship, an airplane, a drone, a satellite, an electric bicycle, an electric bike, an electric kickboard, an electric kick scooter, a bicycle, a bike, a motorcycle, a kickboard, and a kick scooter”.

Further, it is also considered that the transmission apparatus and the reception apparatus herein are devices having a sensing function and/or a communication function, and that the devices are configured to be connectable to a device for executing an application of a television, a radio, a personal computer, a mobile phone, or the like, via a certain interface.

Further, in the present embodiment, symbols other than data symbols, such as pilot symbols (preambles, unique words, postambles, reference symbols, mid-ambles, and the like), symbols for control information, and null symbols may be mapped in any manner in a frame. Here, although the terms “pilot symbol” and “symbol for control information are used, they may be named any way, and the function itself is important.

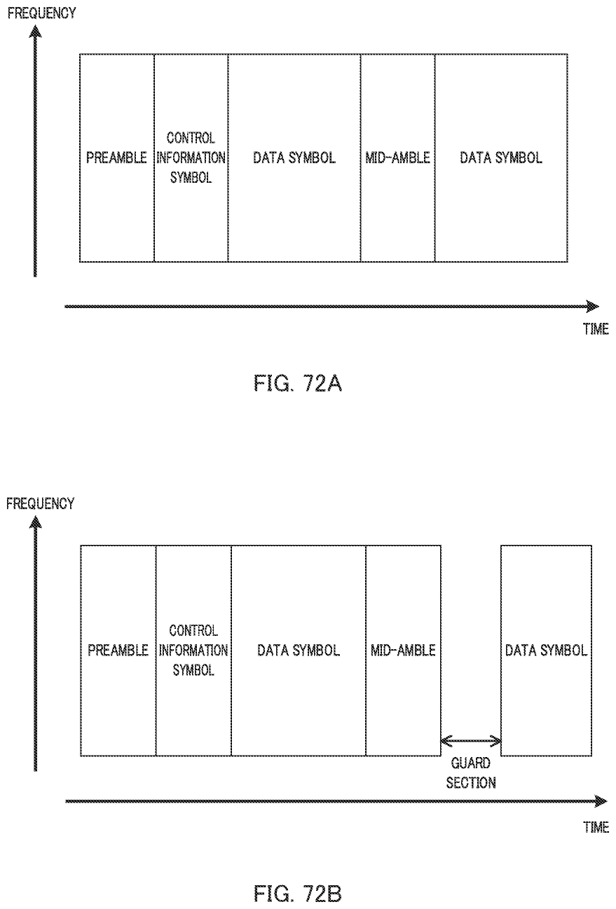

FIGS. 72A and 72B illustrate examples of a configuration of a frame in which a mid-amble is mapped. As illustrated in FIGS. 72A and 72B, a mid-amble may be mapped in the frame. Further, as illustrated in FIG. 72B, a guard section may be provided afterward and/or frontward from the mid-amble in the time axis direction. Further, the mid-amble may also be used as a signal for sensing.

Further, although the term “reference symbol for sensing” is used above, it may also be referred to as “beacon for sensing”, for example, or any other name is possible. What matters is the function. Further, the beacon may also be referred to as “beacon signal”.

The pilot symbol may be, for example, a known symbol modulated by using PSK modulation in a transceiver, and a receiver uses this symbol to perform frequency synchronization, time synchronization, channel estimation (channel state information (CSI) estimation) for each modulated signal, signal detection, and the like. Alternatively, the pilot symbol may enable a receiver to know a symbol transmitted by a transmitter by synchronization of the receiver.

Further, the symbol for control information is a symbol for transmitting information (such as a modulation scheme, an error correction coding scheme, a coding rate of the error correction encoding scheme, upper-layer configuration information, and the like that are used in communication) that needs to be transmitted to a communication partner for realizing communication other than communication of data (data of an application or the like).

Note that, the present disclosure is not limited to the embodiments, and can be implemented by various modifications. For example, although the embodiments describe apparatuses, the present disclosure is not limited thereto, and a communication method of the apparatuses can also be implemented as software.

For example, a program for executing the communication method described above may be stored in a ROM in advance to cause a CPU to operate the program.

Further, a program for executing the communication method described above may be stored in a computer-readable storage medium, the program stored in the storage medium may be recorded in a RAM of a computer, and the computer may be caused to operate in accordance with the program.

Each configuration of the embodiments described above or the like may be realized as an LSI which is typically an integrated circuit that includes an input terminal and an output terminal. The LSIs may be individually formed as chips, or one chip may be formed so as to include the entire configuration or part of the configuration of each embodiment. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit or a general-purpose processor. An FPGA that can be programmed after the manufacture of the LSI or a reconfigurable processor in which the connections and the settings of circuit cells disposed inside the LSI can be reconfigured may be used. If future integrated circuit technology replaces LSIs as a result of the advancement of semiconductor technology or other derivative technology, the functional blocks could be integrated using the future integrated circuit technology. Biotechnology can also be applied.

Note that, the transmission method supported by the base station, the AP, the terminal, and the like may be a multi-carrier scheme such as OFDM or may be a single-carrier scheme. Further, the base station, the terminal, and the access point may support both a multi-carrier scheme and a single-carrier scheme. At this time, there is a plurality of methods that generates a single-carrier-scheme modulated signal, and implementation is possible regardless of which method is used. Examples of the single-carrier scheme include “discrete Fourier transform (DFT)-spread orthogonal frequency division multiplexing (OFDM)”. “trajectory constrained DFT-spread OFDM”. “OFDM based single carrier (SC)”, “single carrier (SC)-frequency division multiple access (FDMA)”, and “guard interval DFT-spread OFDM”.

At least one of the field programmable gate array (FPGA) and the central processing unit (CPU) may be configured such that all or some of software that needs to realize the communication method and/or the sensing method described herein can be downloaded by radio communication or wired communication. Further, at least one of the FPGA and the CPU may also be configured such that all or some of software for updating can be downloaded by radio communication or wired communication. Further, it may also be configured such that the digital signal processing described herein is performed by storing the downloaded software in a storage and operating at least one of the FPGA and the CPU based on the stored software.

At this time, radio connection or wired connection between a device including at least one of the FPGA and the CPU and a communication modem may be established, and the device and the communication modem may realize the communication method and/or the sensing method each described herein.

For example, the communication and/or sensing apparatuses described herein, such as the base station, the AP, and the terminal may include at least one of the FPGA and the CPU, and may include an interface for obtaining software for operating at least one of the FPGA and the CPU from an external source. Further, the communication and/or sensing apparatuses may include a storage for storing software obtained from the external source, and realize the signal processing described herein by operating the FPGA and/or the CPU based on the stored software.

When the AP or the terminal transmits a data symbol or the like, a multiple-input multiple-output (MIMO) transmission scheme for transmitting a plurality of modulated signals from a plurality of antennas may be used.

The processor and operation described with respect to the AP herein may be a processor and operation of a communication device such as a base station, a terminal, a mobile phone, a television, a radio, a personal computer, an eNB, a gNB, a repeater, a server, a home electric appliance, a smart phone, a tablet, a vehicle, an automobile, a ship, an airplane, a drone, a satellite, an electric bicycle, an electric bike, an electric kickboard, an electric kick scooter, a bicycle, a bike, a motorcycle, a kickboard, and a kick scooter. Further, the processor and operation described with respect to the terminal herein may be a processor and operation of a communication device such as a base station, an access point, a mobile phone, a television, a radio, a personal computer, an eNB, a gNB, a repeater, a server, a home electric appliance, a smart phone, a tablet, a vehicle, an automobile, a ship, an airplane, a drone, a satellite, an electric bicycle, an electric bike, an electric kickboard, an electric kick scooter, a bicycle, a bike, a motorcycle, a kickboard, and a kick scooter.

The communication between the AP and the terminal is performed by, for example, carrier sense multiple access (CSMA), carrier sense multiple access with collision avoidance (CSMA/CA), time division duplex (TDD), time division multiplexing (TDM), frequency division duplex (FDD), or frequency division multiplexing (FDM). The communication between the gNB and the terminal is performed by, for example, TDD, TDM, FDD or FDM.

In the above description, for example, the AP may transmit a signal for communication in a 5 GHz band, and may transmit a signal for sensing in a 6 GHz band. The terminal may transmit a signal for communication in a 5 GHz band, and may transmit a signal for sensing in a 6 GHz band. In other words, it may be considered that the 5 GHz band corresponds to the primary channel described herein and the 6 GHz band corresponds to the secondary channel described herein. In a broad sense, it may be considered that the first frequency band corresponds to the primary channel described herein and the second frequency band corresponds to the secondary channel described herein. Note that, it is assumed that the first frequency band and the second frequency band are different frequency bands.

Note that, for example, a terminal that communicates with an AP includes a receiver. The receiver receives a beacon signal transmitted through a first channel from the AP.

The terminal includes a controller. The controller generates a sensing signal based on information included in an extended area of the beacon signal. Further, the controller generates a data signal.

The information included in the extended area is, for example, the information described in FIG. 16. For example, the controller of the terminal may generate, based on information of a channel (information indicating a second channel) included in the extended area of the beacon signal and corresponding to sensing, a sensing signal to be transmitted through the second channel.

The terminal includes a transmitter. The transmitter transmits the sensing signal generated by the controller through the second channel. Further, the transmitter transmits the data signal generated by the controller through both or one of the first channel and the second channel.

The receiver of the terminal may correspond to, for example, reception apparatuses X106, X206, and X308 illustrated in FIGS. 1 to 3. The controller of the terminal may correspond to, for example, transmission apparatuses X101, X201, and X301 illustrated in FIGS. 1 to 3. The transmitter of the terminal may correspond to, for example, transmission apparatuses X101, X201, and X301 illustrated in FIGS. 1 to 3.

Further, for example, an AP that communicates with a terminal includes a controller. The controller configures information on sensing of an object, which uses a second channel, in an extended area of a beacon signal.

The controller of the AP may configure, for example, the information described in FIG. 16 in the extended area of the beacon signal. For example, the controller may configure, in the extended area of the beacon signal, information on a channel (information indicating the second channel different from a first channel through which the beacon signal is transmitted) corresponding to sensing. Further, the controller generates a data signal. Further, the controller may generate a sensing signal to be transmitted through the second channel and perform the sensing of the object.

The AP includes a transmitter. The transmitter transmits a beacon signal through the first channel. Further, the transmitter transmits the data signal generated by the controller through both or one of the first channel and the second channel. Further, the transmitter may also transmit the sensing signal generated by the controller through the second channel.

The controller of the AP may correspond to, for example, transmission apparatuses X101, X201, and X301 illustrated in FIGS. 1 to 3. The transmitter may correspond to, for example, transmission apparatuses X101. X201, and X301 illustrated in FIGS. 1 to 3.

The beacon signal, the sensing signal (reference symbol for sensing), and the data signal (data symbol) are mapped, for example, as in the frame configuration examples described in the embodiments (indicated in the drawings). The first channel may be a primary channel and the second channel may be a secondary channel.

With the above configuration, the terminal can perform sensing of an object. Further, the communication system allows coexistence of a sensing signal and a data signal.

In the embodiments described above, the notation “ . . . processor”, “-er”, “-or”, and “-ar” used for each component may be replaced with another notation such as “ . . . circuitry”, “ . . . device”, “ . . . unit” or “ . . . module”.

Although the embodiments have been described thus far with reference to the accompanying drawings, the present disclosure is not limited to the given examples. It is apparent that the person skilled in the art could arrive at various changes or modifications within the scope described in the claims. It should be understood that such changes or modifications also belong to the technical scope of the present disclosure. Further, the components in the embodiments may be arbitrarily combined without departing from the spirit of the present disclosure.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a field programmable gate array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include a radio frequency (RF) module including amplifiers, RF modulators/demodulators and the like, and one or more antennas. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described herein. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

### SUMMARY OF THE PRESENT DISCLOSURE

A communication apparatus according to the present disclosure includes: a receiver that receives a beacon signal through a first channel, a controller that generates a sensing signal based on information included in an extended area of the beacon signal; and a transmitter that transmits the sensing signal through a second channel.

In the communication apparatus according to the present disclosure, the transmitter may transmit the sensing signal by using channel aggregation.

In the communication apparatus according to the present disclosure, the transmitter may transmit the sensing signal by using channel bonding.

In the communication apparatus according to the present disclosure, the transmitter may transmit a data signal though both or one of the first channel and the second channel.

In the communication apparatus according to the present disclosure, the transmitter may transmit the data signal by using channel aggregation.

In the communication apparatus according to the present disclosure, the transmitter may transmit the data signal by using channel bonding.

In the communication apparatus according to the present disclosure, the first channel may be a primary channel, and the second channel may be a secondary channel.

A communication apparatus according to the present disclosure includes: a controller that configures information on sensing in an extended area of a beacon signal, where the sensing uses a first channel; and a transmitter that transmits the beacon signal through a second channel.

A communication method according to the present disclosure includes: receiving, by a communication apparatus, a beacon signal through a first channel; generating, by the communication apparatus, a sensing signal based on information included in an extended area of the beacon signal; and transmitting, by the communication apparatus, the sensing signal through a second channel.

A communication method according to the present disclosure includes: configuring, by a communication apparatus, information on sensing in an extended area of a beacon signal, where the sensing uses a first channel; and transmitting, by the communication apparatus, the beacon signal through a second channel.

The disclosure of Japanese Patent Application No. 2019-197463, filed on Oct. 30, 2019, including the specification, drawings and abstract, is incorporated herein by reference in its entirety.

### INDUSTRIAL APPLICABILITY

The present disclosure is useful for sensing of an object in a communication system.

### REFERENCE SIGNS LIST

X100, X200, X300 Apparatus
X101, X201, X301 Transmission apparatus
X103_1 to X103_M, X104_1 to X104_M Antenna
X106, X206, X306 Reception apparatus
X108, X208, X308 Estimator
151 Terminal
152 Base station

1. A communication apparatus, comprising:
a receiver that receives a beacon signal through a first channel;
a controller that generates a sensing signal based on information included in an extended area of the beacon signal; and
a transmitter that transmits the sensing signal through a second channel.

2. The communication apparatus according to claim 1, wherein the transmitter transmits the sensing signal by using channel aggregation.

3. The communication apparatus according to claim 1, wherein the transmitter transmits the sensing signal by using channel bonding.

4. The communication apparatus according to claim 1, wherein the transmitter transmits a data signal though both or one of the first channel and the second channel.

5. The communication apparatus according to claim 4, wherein the transmitter transmits the data signal by using channel aggregation.

6. The communication apparatus according to claim 4, wherein the transmitter transmits the data signal by using channel bonding.

7. The communication apparatus according to claim 1, wherein:
the first channel is a primary channel, and
the second channel is a secondary channel.

8. A communication apparatus, comprising:
a controller that configures information on sensing in an extended area of a beacon signal, the sensing using a first channel; and
a transmitter that transmits the beacon signal through a second channel.

9. A communication method, comprising:
receiving, by a communication apparatus, a beacon signal through a first channel;
generating, by the communication apparatus, a sensing signal based on information included in an extended area of the beacon signal; and
transmitting, by the communication apparatus, the sensing signal through a second channel.

10. A communication method, comprising:
configuring, by a communication apparatus, information on sensing in an extended area of a beacon signal, the sensing using a first channel; and
transmitting, by the communication apparatus, the beacon signal through a second channel.
